(19) United States
(12) Patent Application Publication
(10) Pub. No.: US 2024/0070040 A1
(43) Pub. Date: Feb. 29, 2024

(54) SYSTEM TESTING TECHNIQUE

(71) Applicant: NVIDIA Corporation, Santa Clara, CA (US)

(72) Inventors: Nivedita Viswanath, San Jose, CA (US); Li Ge, San Jose, CA (US); Sanjay Chatterjee, San Ramon, CA (US); Saloni Goel, Pune (IN); Namit Dhameja, Fremont, CA (US); Abhijit Prakash Paithankar, San Jose, CA (US); Dileep Ranganathan, San Jose, CA (US); Raghav Hrishikeshan Mukundan, Sunnyvale, CA (US)

(21) Appl. No.: 18/235,154

(22) Filed: Aug. 17, 2023

(30) Foreign Application Priority Data
Aug. 25, 2022 (IN) 202211048493

(51) Int. Cl. G06F 11/26; G06F 11/22

(52) U.S. Cl. CPC G06F 11/26; G06F 11/2273

(57) ABSTRACT

Apparatuses, systems, and techniques to help processing resources used cause one or more systems in a distributed computing environment to be checked by one or more checks. In at least one embodiment, said one or more checks help identify one or more unhealthy nodes based, at least in part, on how many nodes are in a workload.

### CROSS-REFERENCE TO RELATED APPLICATIONS

This application claims the benefit of Indian Provisional Application No. 202211048493, titled “PRE-FLIGHT SYSTEM CHECKS,” filed Aug. 25, 2022, the entire contents of which is incorporated herein by reference.

### FIELD

At least one embodiment pertains to processing resources used to cause one or more systems in a distributed computing environment to be checked.

### BACKGROUND

Scheduling and performing jobs in a distributed computing environment can be complex and may be prone to error or inefficient use of computing resources. Techniques for performing jobs in a distributed computing environment can be improved.

### BRIEF DESCRIPTION OF THE DRAWINGS

FIG. 1 illustrates a block diagram of a system to check a set of nodes and jobs, in accordance with at least one embodiment;

FIG. 2 illustrates a flowchart to perform prolog system checks, in accordance with at least one embodiment;

FIG. 3 illustrates an example of a process that performs a prolog check according to at least one embodiment;

FIG. 4 illustrates an example of a process that performs a prolog check according to at least one embodiment;

FIG. 5 illustrates a distributed system, in accordance with at least one embodiment;

FIG. 6 illustrates an exemplary data center, in accordance with at least one embodiment;

FIG. 7 illustrates a client-server network, in accordance with at least one embodiment;

FIG. 8 illustrates an example of a computer network, in accordance with at least one embodiment;

FIG. 9A illustrates a networked computer system, in accordance with at least one embodiment;

FIG. 9B illustrates a networked computer system, in accordance with at least one embodiment;

FIG. 9C illustrates a networked computer system, in accordance with at least one embodiment;

FIG. 10 illustrates one or more components of a system environment in which services may be offered as third party network services, in accordance with at least one embodiment;

FIG. 11 illustrates a cloud computing environment, in accordance with at least one embodiment;

FIG. 12 illustrates a set of functional abstraction layers provided by a cloud computing environment, in accordance with at least one embodiment;

FIG. 13 illustrates a supercomputer at a chip level, in accordance with at least one embodiment;

FIG. 14 illustrates a supercomputer at a rack module level, in accordance with at least one embodiment;

FIG. 15 illustrates a supercomputer at a rack level, in accordance with at least one embodiment;

FIG. 16 illustrates a supercomputer at a whole system level, in accordance with at least one embodiment;

FIG. 17A illustrates inference and/or training logic, in accordance with at least one embodiment;

FIG. 17B illustrates inference and/or training logic, in accordance with at least one embodiment;

FIG. 18 illustrates training and deployment of a neural network, in accordance with at least one embodiment;

FIG. 19 illustrates an architecture of a system of a network, in accordance with at least one embodiment;

FIG. 20 illustrates an architecture of a system of a network, in accordance with at least one embodiment;

FIG. 21 illustrates a control plane protocol stack, in accordance with at least one embodiment;

FIG. 22 illustrates a user plane protocol stack, in accordance with at least one embodiment;

FIG. 23 illustrates components of a core network, in accordance with at least one embodiment;

FIG. 24 illustrates components of a system to support network function virtualization (NFV), in accordance with at least one embodiment;

FIG. 25 illustrates a processing system, in accordance with at least one embodiment;

FIG. 26 illustrates a computer system, in accordance with at least one embodiment;

FIG. 27 illustrates a system, in accordance with at least one embodiment;

FIG. 28 illustrates an exemplary integrated circuit, in accordance with at least one embodiment;

FIG. 29 illustrates a computing system, according to at least one embodiment;

FIG. 30 illustrates an APU, in accordance with at least one embodiment;

FIG. 31 illustrates a CPU, in accordance with at least one embodiment;

FIG. 32 illustrates an exemplary accelerator integration slice, in accordance with at least one embodiment;

FIGS. 33A-33B illustrate exemplary graphics processors, in accordance with at least one embodiment;

FIG. 34A illustrates a graphics core, in accordance with at least one embodiment;

FIG. 34B illustrates a GPGPU, in accordance with at least one embodiment;

FIG. 35A illustrates a parallel processor, in accordance with at least one embodiment;

FIG. 35B illustrates a processing cluster, in accordance with at least one embodiment;

FIG. 35C illustrates a graphics multiprocessor, in accordance with at least one embodiment;

FIG. 36 illustrates a software stack of a programming platform, in accordance with at least one embodiment;

FIG. 37 illustrates a CUDA implementation of a software stack of FIG. 36, in accordance with at least one embodiment;

FIG. 38 illustrates a ROCm implementation of a software stack of FIG. 36, in accordance with at least one embodiment;

FIG. 39 illustrates an OpenCL implementation of a software stack of FIG. 36, in accordance with at least one embodiment;

FIG. 40 illustrates software that is supported by a programming platform, in accordance with at least one embodiment; and

FIG. 41 illustrates compiling code to execute on programming platforms of FIGS. 36-39, in accordance with at least one embodiment.

### DETAILED DESCRIPTION

In the following description, numerous specific details are set forth to provide a more thorough understanding of at least one embodiment. However, it will be apparent to one skilled in the art that the inventive concepts may be practiced without one or more of these specific details.

At least one embodiment includes a system for automating deployment, scaling, and management of containerized applications. In at least one embodiment, containerized applications are referred to as containerized workloads. In at least one embodiment, a container is a ready-to-run software package that contains everything needed to run an application. In at least one embodiment, said container may comprise code, required runtime, application libraries, system libraries, and any default values for an essential settings. In at least one embodiment, said system automates said container operations. In at least one embodiment, said system groups containers that make up an application into logical units. In at least one embodiment, said system allows for clustering of groups of hosts running container applications and said system helps to manage said clusters. In at least one embodiment, a container is a Docker container. In at least one embodiment, a container is a Kubernetes container. In at least one embodiment, a container is an OpenShift container.

In at least one embodiment, users of a shared cluster expect their jobs to run in a healthy, resilient environment that offers predictable and consistent performance, yet jobs could occasionally be scheduled to be performed on an unhealthy node, or on a node suffering from an outage or defect that could result in job failure. In at least one embodiment, in a shared cluster, it may be advantageous to identify system errors early on, and prevent job failures due to system errors. In at least one embodiment, users may wish to be able to distinguish between a job failure that is due to application error versus a system or hardware error. In at least one embodiment, deficiencies are addressed, such as deficiencies associated with approaches that run health checks as a daemon on nodes in a cluster, or run health check scripts as part of a system application container.

In at least one embodiment, a scheduler selects a computer to run a portion of an application workload, and causes a selected computer to perform a system check immediately before that computer is to perform that portion of said application's workload. In at least one embodiment, a check involves testing various components of a computer, such as if a storage volume is mounted, if a GPU is available, if a program that performs a software containers is operational, etc. In at least one embodiment, a system check is adapted to a workload to be performed, such as by checking if there is sufficient memory, a sufficient amount of GPU resources, etc. In at least one embodiment, if a check shows a workload can be performed, a scheduler then causes a computer to perform that workload. In at least one embodiment, if a check encounters errors, a scheduler selects a different computer to run that portion of that application workload.

In at least one embodiment, a software container is generated with an application to perform a system check. In at least one embodiment, a software container is a set of software programs that includes an application and software libraries to communicate with a virtual operating system. In at least one embodiment, software containers are sent to a computer that is scheduled to perform a portion of an application's workload. In at least one embodiment, a system check contained in a software container is then performed on that computer. In at least one embodiment, if a system check fails, a scheduler does not schedule any portion of an application's workload on that computer. In at least one embodiment, if that particular computer fails a number of such checks, it is marked as unhealthy and taken offline.

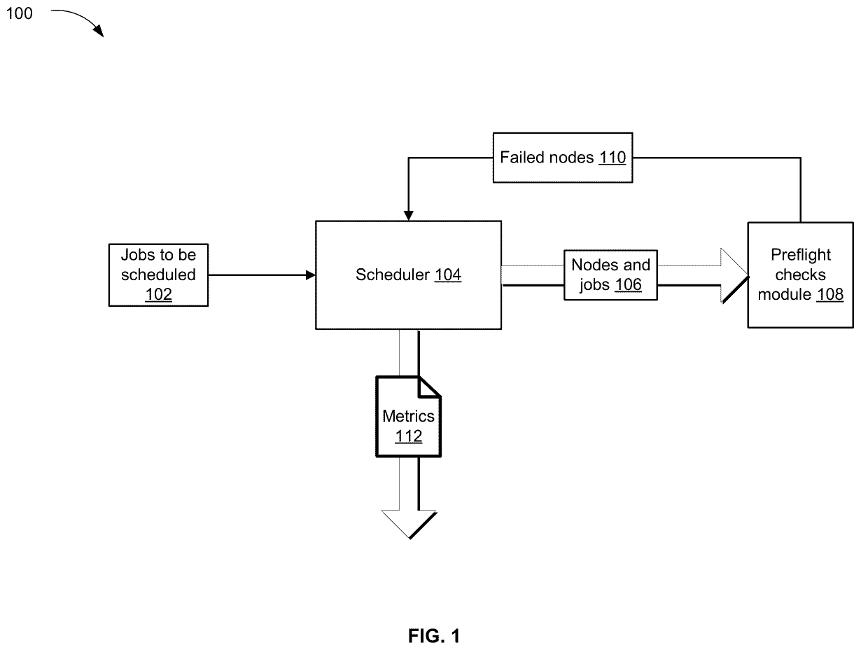

FIG. 1 illustrates a block diagram of a system 100 that causes a set of nodes and jobs to be checked, according to at least one embodiment. In at least one embodiment, system 100 comprises one or more hardware and/or software computing resources. In at least one embodiment, said computing resources comprise instructions that, when performed, cause one or more processes, such as those described herein, to be performed. In at least one embodiment, system 100 comprises a software program to be performed on computer hardware, an application executing on computer hardware, and/or variations thereof. In at least one embodiment, one or more processes of system 100 are performed by any suitable processing system or unit (e.g., graphics processing unit (GPU), general-purpose GPU (GPGPU), parallel processing unit (PPU), central processing unit (CPU)), such as are described below, and in any suitable manner, including sequential, parallel, and/or variations thereof.

In at least one embodiment, a scheduler 104 is used to schedule jobs on nodes within a cluster before those jobs are performed. In at least one embodiment, these assigned nodes and jobs 106 are assigned to a prolog checks module 108 (also referred to as a node aggregator) to cause prolog checks to be performed. In at least one embodiment, prolog refers to operations performed prior to job execution. In at least one embodiment, failed nodes 110 are those on which prolog checks are performed. In at least one embodiment, said failed nodes 110 are passed through scheduler 104 again. In at least one embodiment, metrics 112 are produced by a node monitoring service (not shown) that scans node container records to monitor health. In at least one embodiment, metrics 112 comprise information indicative of performance or operational state of a node. In at least one embodiment, metrics 112 comprise failed node information with time stamps. In at least one embodiment, metrics 112 comprise average bus bandwidth information. In at least one embodiment, a node monitoring service is launched by scheduler 104.

In at least one embodiment, scheduler 104 comprises computing resources to perform one or more software programs to schedule jobs on a node within a cluster.

In at least one embodiment, scheduler 104 produces prolog metrics which are logged and monitored and communicated to an end user by scheduler 104. In at least one embodiment, for example, a node failed its prolog checks and prolog checks module 108 will label that node. In at least one embodiment, an identify of said failed node with its identification will be communicated from prolog checks module 108 to scheduler 104. In at least one embodiment, scheduler 104 will ensure that said node will not be scheduled for a certain configurable period of time. In at least one embodiment, said job assigned to said failed node will be rescheduled to a different node and is run through prolog checks again. In at least one embodiment, said node and assigned job are looped up to N number of attempts. In at least one embodiment, after N times if a job continues to fail then said port is marked as failed. In at least one embodiment, N is configurable to a user. In at least one embodiment, scheduler 104 will not select any nodes which have been marked as failed. In at least one embodiment, a user is alerted of said failed nodes. In at least one embodiment, said failed nodes are labeled and said labels allow system admins to log into said node and run more enhanced test suites to determine a root cause of the problem. In at least one embodiment, said failed node is taken out of scheduling until said problem is fixed.

In at least one embodiment prolog checks module 108 comprises computing resources to perform one or more software programs to perform prolog checks. In at least one embodiment, one or more computing resources comprise a plurality of central processing unit (CPU) processes by a parallel processing unit (PPU), such as a graphics processing unit (GPU). In at least one embodiment, prolog checks performed by the prolog checks module 108 are performed after scheduling because checks are performed as close to the runtime of the job as possible, which ensures accuracy. In at least one embodiment, said prolog checks are built into a pod which combines said tests into their own container. In at least one embodiment, a pod is a group of one or more containers. In at least one embodiment, a pod comprises storage shared by said containers and a specification comprising instructions to run said containers. In at least one embodiment, said prolog checks use resources that have been allocated for its assigned workload specific to an application.

In at least one embodiment, a suite of system checks, which may be referred to as prolog checks, are included in a container and run as a preliminary portion of a user workload. In at least one embodiment, prolog checks are not application dependent, in that prolog checks do not change based on said application running, but rather if it is a single or multi-node workload. In at least one embodiment, these checks are run once a pod is scheduled onto a node, before a user application is run. In at least one embodiment, if a check fails, that node is marked as unhealthy. In at least one embodiment, scheduler 104 acts on an unhealthy node event, and will not schedule new workloads onto the node, until its error is fixed.

In at least one embodiment, on prolog check failure, a user's workload is re-submitted, so it can be scheduled onto a new node, where a suite of system checks are again run. In at least one embodiment, this is done repeatedly until a configurable prolog failure threshold is reached, in which case a user's workload is set to failed state. In at least one embodiment, check failure details are communicated to an end user, and prolog metrics are logged and monitored. In at least one embodiment, many prolog checks are configured. In at least one embodiment, prolog checks comprise a prolog check init container and a test init container. In at least one embodiment, an init container is a container that is run before application containers in a pod. In at least one embodiment, a test init container a Kubernetes container. In at least one embodiment, a test init container is a Docker container. In at least one embodiment, a test init container is an OpenShift container.

In at least one embodiment, there is a prolog check Init container that is performed for all workloads. In at least one embodiment, an Init container refers to containers that run before application containers in a pod. In at least one embodiment, a pod represents a set of running containers in a cluster. In at least one embodiment, one such prolog check is verification of number of GPUs available. In at least one embodiment, such a prolog check is performed by comparing a system management interface output against visible devices environment variable.

In at least one embodiment, another such prolog check is verification that GPU memory usage is at zero percent. In at least one embodiment, zero percent indicates that no other application is running on said GPU. In at least one embodiment, one such prolog check is running a parallel computing platform model sanity program for parallel computing platform model verification. In at least one embodiment, one such prolog check is verifying RAID (Redundant Array of Independent Disks) setup. In at least one embodiment, a RAID setup uses multiple storage drives to create a single workable storage system. In at least one embodiment, said setup can help improve overall storage efficiency as well as protect against drive failure by incorporating backup drives. In at least one embodiment, data is stored according to a Ceph platform.

In at least one embodiment, for multi-node workloads, more prolog checks, in addition to those prolog checks described above, are also incorporated into said workflow. In at least one embodiment, one such prolog check for multi-node workloads is verification of all remote direct memory access (RDMA) interfaces are available within a container. In at least one embodiment, said verification has a failure threshold of up to two interfaces.

In at least one embodiment, one such prolog check for multi-node workloads is a verification that all RDMA interfaces are enabled. In at least one embodiment, an RDMA interface is enabled means they are functional. In at least one embodiment, said verification has a failure threshold of up to two interfaces.

In at least one embodiment, one such prolog check for multi-node workloads is a verification of all RDMA interfaces have an IP address. In at least one embodiment, said verification has a failure threshold of up to N interfaces, where N is a maximum number of interfaces available. In at least one embodiment, this is because an IP address is not required for RDMA.

In at least one embodiment, one such prolog check for multi-node workloads is verification that all RDMA interfaces can ping a gateway. In at least one embodiment, said test is only run on RDMA over Converged Ethernet (RoCE) clusters since InfiniB and (IB) clusters may not have a gateway. In at least one embodiment, said verification has a failure threshold of up to two interfaces. In at least one embodiment, one such prolog check for multi-node workloads is verification that all RDMA device ports are up and active. In at least one embodiment, up and active refers to functionality of said ports. In at least one embodiment, said verification has a failure threshold of up to two interfaces.

In at least one embodiment, all prolog checks for multi-node workloads have a configurable failure threshold because interfaces occasionally go down and become inactive, only to self-heal and become active again. In at least one embodiment, if a check fails on a specific node, said pod is deleted and re-created, to be scheduled onto a difference node. In at least one embodiment, said node on which a check failed is marked as temporarily unhealthy, and will not be selected by scheduler 104 for immediate scheduling. In at least one embodiment, said re-created pod is scheduled onto a different node, where said checks are run again. In at least one embodiment, if checks repeatedly fail N times, said workload is failed. In at least one embodiment, if a workload fails due to multiple check failures, said reason for failure is propagated back to a user.

In at least one embodiment, a Collective Communications Library (CCL) test init container is executed only for multi-node workloads and is run after prolog check init container. multi-node workloads contain different prolog checks than other checks. In at least one embodiment, average bus bandwidth is measured. In at least one embodiment, if said bus bandwidth measured is below a particular threshold then said nodes are labeled and said jobs are rescheduled to a new set of nodes. In at least one embodiment, said particular threshold can be configured. In at least one embodiment, said bandwidth is noted and sent to a system for each multi-node workload. In at least one embodiment, a CCL test for a multi-node workload times out after a duration of five minutes. In at least one embodiment, if an Init container or workload test times out or a test fails, said failure logs are saved, such as metrics 112, on a host for debugging.

In at least one embodiment, an embodiment of FIG. 1 comprises a processor. In at least one embodiment, said processor comprises one or more circuits to cause one or more computer system evaluation programs to be performed based, at least in part, on an application to be performed by the one or more computer systems. In at least one embodiment, said computer system evaluation programs comprise one or more prolog checks, such as prolog checks described in relation to FIG. 1. For example, in at least one embodiment, said computer system evaluation programs comprise a RAID test. For example, in at least one embodiment, said computer system evaluation programs comprise an RDMA test.

In at least one embodiment, said computer system evaluation programs are based, at least in part, on said application to be performed on said computer systems. For example, in at least one embodiment, said computer system evaluation programs comprises one or more tests selected based, at least in part, on one or more functions of the application to be performed by the one or more computer systems. In at least one embodiment, said functions comprise operations to be performed using one or more of a RAID component of said computer system, an RDMA component of said computer system, or another component of said computer system that is used by said application. In at least one embodiment, said computer system evaluation programs are provided to a computer system using containers as described regarding FIG. 1 and elsewhere herein.

In at least one embodiment, said circuits are to indicate a workload as failed based, at least in part, on a count of failures of the computer system evaluation program. In at least one embodiment, system 100 by scheduler 104 causes a job linked to said computer system evaluation program to be rescheduled on another node. In at least one embodiment, when said computer system evaluation programs do not pass, it is indicative of current environmental and/or configuration of said computer system being in a state in which said application is unlikely to be able to successfully complete. In at least one embodiment, running said computer system evaluation programs in a same container as said application causes said current state to be more accurately determined than with some other techniques.

In at least one embodiment, said circuits are to perform a user container in response to the one or more computer system evaluation programs passing. In at least one embodiment, when said computer system evaluation programs pass, it is indicative of current environmental and/or configuration of said computer system being in a state in which said application is likely to be able to successfully complete.

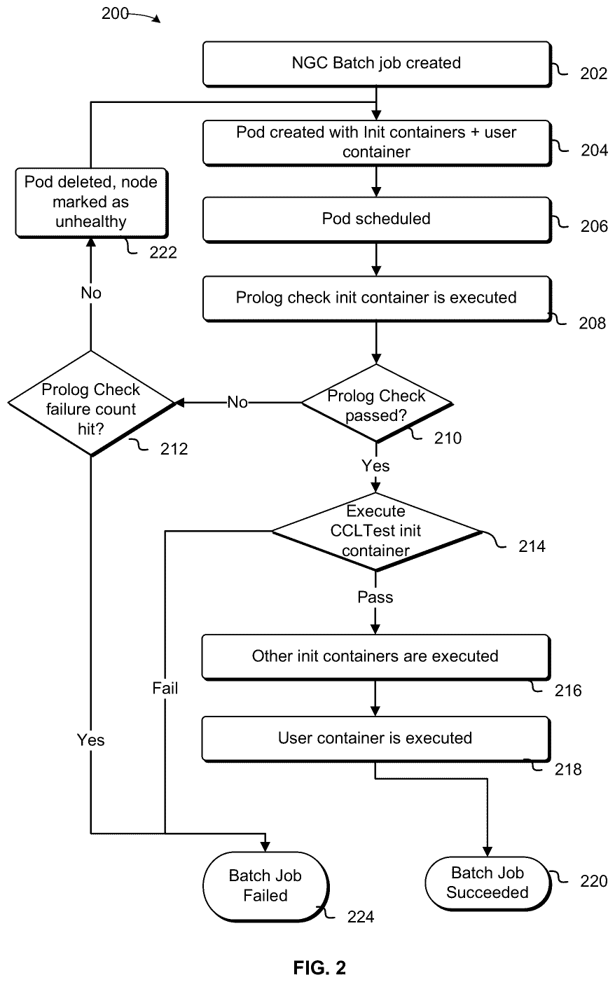

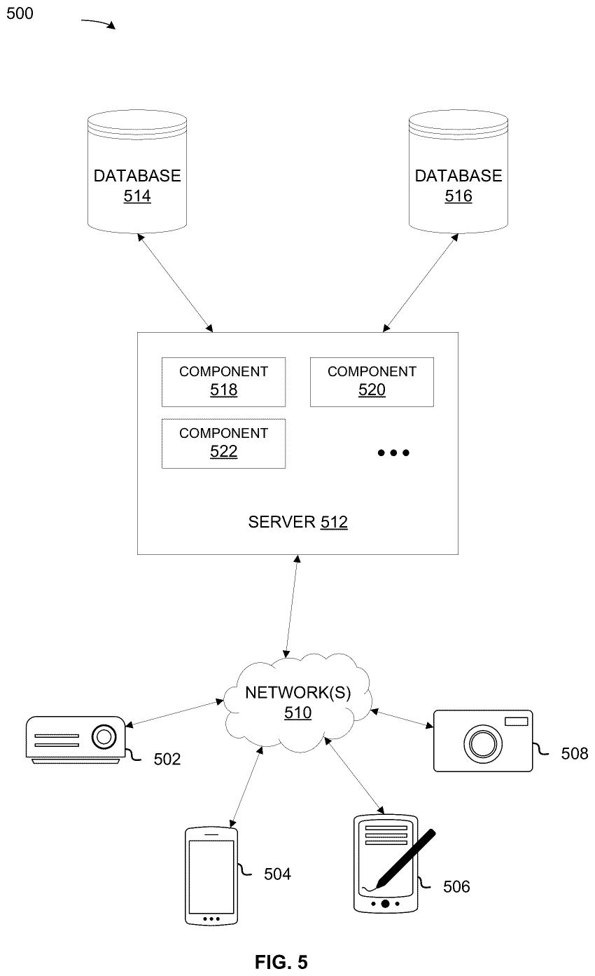

FIG. 2 illustrates an example of a process 200 that performs prolog system checks according to at least one embodiment. In at least one embodiment, some or all of process 200 (or any other processes described herein, or variations and/or combinations thereof) is performed under control of one or more computer systems, such as those described in FIGS. 5-39, configured with computer-executable instructions and is implemented as code (e.g., computer-executable instructions, one or more computer programs, or one or more applications) executing collectively on one or more processors, by hardware, software, or combinations thereof. In at least one embodiment, code is stored on a computer-readable storage medium in form of a computer program comprising a plurality of computer-readable instructions executable by one or more processors. In at least one embodiment, a computer-readable storage medium is a non-transitory computer-readable medium.

In at least one embodiment, said system performing at least a part of process 200 includes executable code to at least create 202 a batch job. In at least one embodiment, said system performing at least a part of process 200 includes executable code to at least create 204 a pod with Init containers and a user container. In at least one embodiment, said system performing at least a part of process 200 includes executable code to at least schedule 206 a pod.

In at least one embodiment, said system performing at least a part of process 200 includes executable code to at least prolog check 208 Init container is performed. In at least one embodiment, prolog check Init container is executed for all workloads. In at least one embodiment, said checks vary depending on whether said workload requires a single node, or multiple nodes. In at least one embodiment, said checks executed comprise: verification of number of GPUs available, verification of GPU memory usage is at zero percent, running a parallel computing platform model sanity program for parallel computing platform model verification, and verification of RAID setup. In at least one embodiment, said checks are similar to checks such as those described in connection with FIG. 1 above.

In at least one embodiment, said system performing at least a part of process 200 includes executable code to at least check 210 said prolog check passed. In at least one embodiment, if said check passed, CCL test Init container is executed 214. In at least one embodiment, said CCL test Init container is executed only for multi-node workloads and is run after prolog check init container. In at least one embodiment, said CCL checks executed comprise: average bus bandwidth measurements and timeout durations. In at least one embodiment, said checks are similar to checks such as those described in connection with FIG. 1 above.

In at least one embodiment, said system performing at least a part of process 200 includes performing a process to at least execute 216 other Init containers. In at least one embodiment, said other Init containers download an image. In at least one embodiment, said other Init containers wait for all pods in a multi-node workload. In at least one embodiment, other Init containers execute other functions and are configured for a particular workflow. In at least one embodiment, user container is executed 218. In at least one embodiment, user container is a default location for new user accounts and groups created in a domain. In at least one embodiment, a user container is used to maintain and manage domain operations.

In at least one embodiment, said system performing at least a part of process 200 includes performing a process to at least determine if said batch job succeeded 220. In at least one embodiment, a batch job is determined to have succeeded if all prolog checks passed, all init checks passed, and all user workload completed.

In at least one embodiment, if said prolog check failed, said system performing at least a part of process 200 includes executable code to at least count 212 if said prolog check failure hit its threshold. In at least one embodiment, if said count is at or above a threshold, said system performing at least a part of process 200 includes performing a process to at least fail 224 said batch job. In at least one embodiment, if said count is below a threshold, said system performing at least a part of process 200 includes performing code to at least delete 222 a pod and mark a node as unhealthy. In at least one embodiment, said system performing at least a part of process 200 includes performing code to at least perform described steps again.

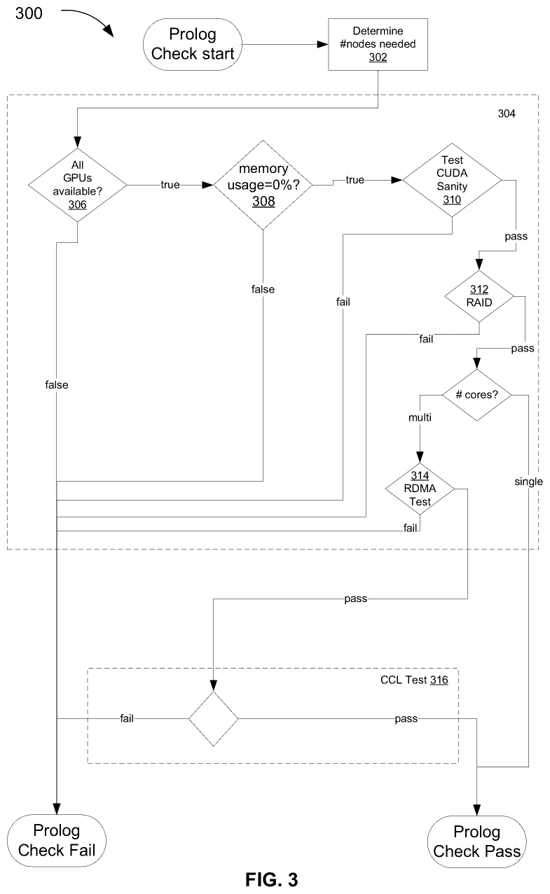

FIG. 3 illustrates an example of a process 300 that performs prolog system checks according to at least one embodiment. In at least one embodiment, some or all of process 300 (or any other processes described herein, or variations and/or combinations thereof) is performed under control of one or more computer systems, such as those described in FIGS. 5-39, configured with computer-executable instructions and is implemented as code (e.g., computer-executable instructions, one or more computer programs, or one or more applications) executing collectively on one or more processors, by hardware, software, or combinations thereof. In at least one embodiment, code is stored on a computer-readable storage medium in form of a computer program comprising a plurality of computer-readable instructions executable by one or more processors. In at least one embodiment, a computer-readable storage medium is a non-transitory computer-readable medium.

In at least one embodiment, a determination is made 302 whether a workload requires a single node or multiple nodes. In at least one embodiment, prolog Init container 304 comprises checks executed for user workloads. In at least one embodiment, additional checks are executed in a separate Init container 316. In at least one embodiment, prolog Init container 304 checks comprise verifying at 306 a number of GPUs available. In at least one embodiment, prolog Init container 304 checks comprise verification 308 that GPU memory usage is at zero percent, or below some other threshold indicating that no application is currently executing. In at least one embodiment, a program is executed, at 310, for parallel computing platform model verification. In at least one embodiment, verification of RAID setup 312 is performed. In at least one embodiment, said program is a program executing CUDA instructions to produce a result that may then be compared to an expected result. In at least one embodiment, an RDMA check from within a prolog Init container is performed, at 314.

In at least one embodiment, a CCL test is run 316 in a separate Init container. In at least one embodiment, a separate Init container 316 is a CCL container, as described in connection with FIG. 1. In at least one embodiment, a CCL 316 container is an Nvidia CCL (NCCL) container.

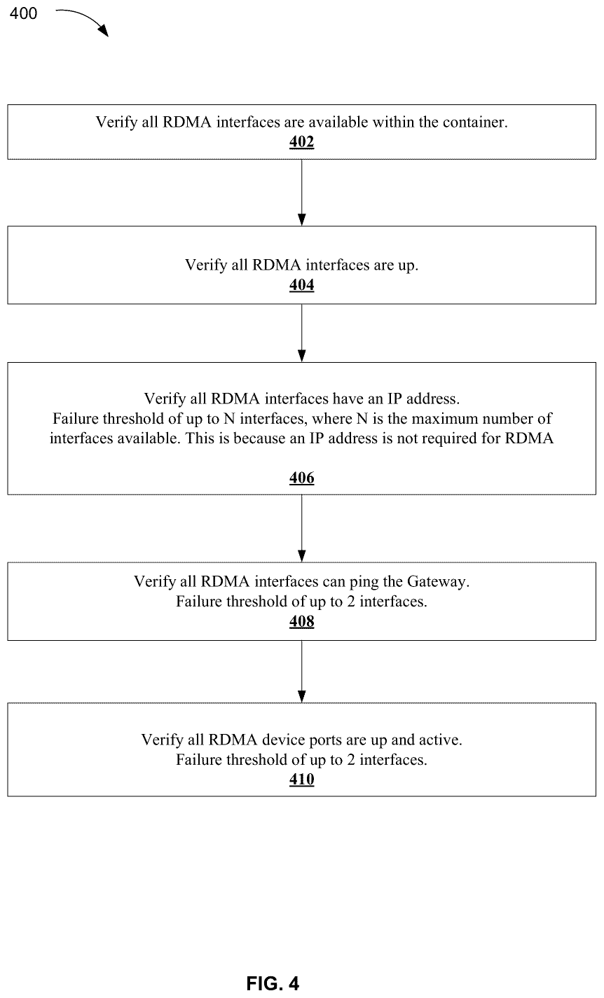

FIG. 4 illustrates an example of a process 400 that an example of a process that performs a prolog check according to at least one embodiment. In at least one embodiment, process 400 is a prolog check conducted for multi-node workloads. In at least one embodiment, process 400 is a verification of all remote direct memory access (RDMA).

In at least one embodiment, at step 402, verification is performed that all RDMA interfaces are available within a container. In at least one embodiment, a failure threshold is exceeded when some number of interfaces are unavailable, or alternatively when less than a minimum number of interfaces are available. In at least one embodiment, said threshold is two interfaces.

In at least one embodiment, at step 404, verification is performed that all RDMA interfaces are enabled. In at least one embodiment, a failure threshold exceeded when some number of interfaces are not enabled, or alternatively, when less than a minimum number of interfaces are available. In at least one embodiment, said threshold is two interfaces.

In at least one embodiment, at step 406, verification is performed that all RDMA interfaces have an IP address. In at least one embodiment, a failure threshold is N interfaces, where N is a maximum number of interfaces available.

In at least one embodiment, at step 408, verification is performed that all RDMA interfaces can ping a gateway. In at least one embodiment, step 408 is run on converged clusters, for example because Infiniband clusters may not have a gateway. In at least one embodiment, a failure threshold is two interfaces.

In at least one embodiment, at step 410, verification is performed that all RDMA device ports are enabled and active. In at least one embodiment, a failure threshold is 2 interfaces.

In at least one embodiment, when a prolog check fails for a node, its node health status is updated and eventually that node should be excluded from scheduler node pool.

In at least one embodiment, when a prolog check fails for a node, that node is immediately excluded for scheduling resubmitted pod.

In at least one embodiment, a mechanism to uncordon nodes from prolog check failures is implemented. In at least one embodiment, a mechanism is asynchronous with respect to updating health status but synchronous with respect to excluding failed nodes. In at least one embodiment, a mechanism is required for a prolog check result reflected in node health reporting. In at least one embodiment, a mechanism is required for auto-resubmission to select a different node, based on previous asynchronous flow analysis. In at least one embodiment, a mechanism is required to recover from a transient outage.

In at least one embodiment, a mechanism uses a background process node monitoring service framework by injecting extra information about prolog check failure in a node object. In at least one embodiment, a failed node is marked by means of an annotation local to that node. Alternatively, in at least one embodiment, an upstream plugin excludes a failed node from scheduling naturally, by keeping a record of failed nodes. In at least one embodiment, prolog check results are reflected in metrics. In at least one embodiment, an annotation is injected into a resubmitted workload container template.

### Servers and Data Centers

The following figures set forth, without limitation, exemplary network server and data center based systems that can be used to implement at least one embodiment.

FIG. 5 illustrates a distributed system 500, in accordance with at least one embodiment. In at least one embodiment, distributed system 500 includes one or more client computing devices 502, 504, 506, and 508, which are configured to execute and operate a client application such as a web browser, proprietary client, and/or variations thereof over one or more network(s) 510. In at least one embodiment, server 512 may be communicatively coupled with remote client computing devices 502, 504, 506, and 508 via network 510.

In at least one embodiment, server 512 may be adapted to run one or more services or software applications such as services and applications that may manage session activity of single sign-on (SSO) access across multiple data centers. In at least one embodiment, server 512 may also provide other services or software applications can include non-virtual and virtual environments. In at least one embodiment, these services may be offered as web-based or cloud services or under a Software as a Service (SaaS) model to users of client computing devices 502, 504, 506, and/or 508. In at least one embodiment, users operating client computing devices 502, 504, 506, and/or 508 may in turn utilize one or more client applications to interact with server 512 to utilize services provided by these components.

In at least one embodiment, software components 518, 520 and 522 of system 500 are implemented on server 512. In at least one embodiment, one or more components of system 500 and/or services provided by these components may also be implemented by one or more of client computing devices 502, 504, 506, and/or 508. In at least one embodiment, users operating client computing devices may then utilize one or more client applications to use services provided by these components. In at least one embodiment, these components may be implemented in hardware, firmware, software, or combinations thereof. It should be appreciated that various different system configurations are possible, which may be different from distributed system 500. The embodiment shown in FIG. 5 is thus one example of a distributed system for implementing an embodiment system and is not intended to be limiting.

In at least one embodiment, client computing devices 502, 504, 506, and/or 508 may include various types of computing systems. In at least one embodiment, a client computing device may include portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 10, Palm OS, and/or variations thereof. In at least one embodiment, devices may support various applications such as various Internet-related apps, e-mail, short message service (SMS) applications, and may use various other communication protocols. In at least one embodiment, client computing devices may also include general purpose personal computers including, by way of example, personal computers and/or laptop computers running various versions of Microsoft Windows®, Apple Macintosh®, and/or Linux operating systems. In at least one embodiment, client computing devices can be workstation computers running any of a variety of commercially-available UNIX® or UNIX-like operating systems, including without limitation a variety of GNU/Linux operating systems, such as Google Chrome OS. In at least one embodiment, client computing devices may also include electronic devices such as a thin-client computer, an Internet-enabled gaming system (e.g., a Microsoft Xbox gaming console with or without a Kinect® gesture input device), and/or a personal messaging device, capable of communicating over network(s) 510. Although distributed system 500 in FIG. 5 is shown with four client computing devices, any number of client computing devices may be supported. Other devices, such as devices with sensors, etc., may interact with server 512.

In at least one embodiment, network(s) 510 in distributed system 500 may be any type of network that can support data communications using any of a variety of available protocols, including without limitation TCP/IP (transmission control protocol/Internet protocol), SNA (systems network architecture), IPX (Internet packet exchange), AppleTalk, and/or variations thereof. In at least one embodiment, network(s) 510 can be a local area network (LAN), networks based on Ethernet, Token-Ring, a wide-area network, Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 802.11 suite of protocols, Bluetooth®, and/or any other wireless protocol), and/or any combination of these and/or other networks.

In at least one embodiment, server 512 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. In at least one embodiment, server 512 can include one or more virtual machines running virtual operating systems, or other computing architectures involving virtualization. In at least one embodiment, one or more flexible pools of logical storage devices can be virtualized to maintain virtual storage devices for a server. In at least one embodiment, virtual networks can be controlled by server 512 using software defined networking. In at least one embodiment, server 512 may be adapted to run one or more services or software applications.

In at least one embodiment, server 512 may run any operating system, as well as any commercially available server operating system. In at least one embodiment, server 512 may also run any of a variety of additional server applications and/or mid-tier applications, including HTTP (hypertext transport protocol) servers, FTP (file transfer protocol) servers, CGI (common gateway interface) servers, JAVA® servers, database servers, and/or variations thereof. In at least one embodiment, exemplary database servers include without limitation those commercially available from Oracle, Microsoft, Sybase, IBM (International Business Machines), and/or variations thereof.

In at least one embodiment, server 512 may include one or more applications to analyze and consolidate data feeds and/or event updates received from users of client computing devices 502, 504, 506, and 508. In at least one embodiment, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and/or variations thereof. In at least one embodiment, server 512 may also include one or more applications to display data feeds and/or real-time events via one or more display devices of client computing devices 502, 504, 506, and 508.

In at least one embodiment, distributed system 500 may also include one or more databases 514 and 516. In at least one embodiment, databases may provide a mechanism for storing information such as user interactions information, usage patterns information, adaptation rules information, and other information. In at least one embodiment, databases 514 and 516 may reside in a variety of locations. In at least one embodiment, one or more of databases 514 and 516 may reside on a non-transitory storage medium local to (and/or resident in) server 512. In at least one embodiment, databases 514 and 516 may be remote from server 512 and in communication with server 512 via a network-based or dedicated connection. In at least one embodiment, databases 514 and 516 may reside in a storage-area network (SAN). In at least one embodiment, any necessary files for performing functions attributed to server 512 may be stored locally on server 512 and/or remotely, as appropriate. In at least one embodiment, databases 514 and 516 may include relational databases, such as databases that are adapted to store, update, and retrieve data in response to SQL-formatted commands.

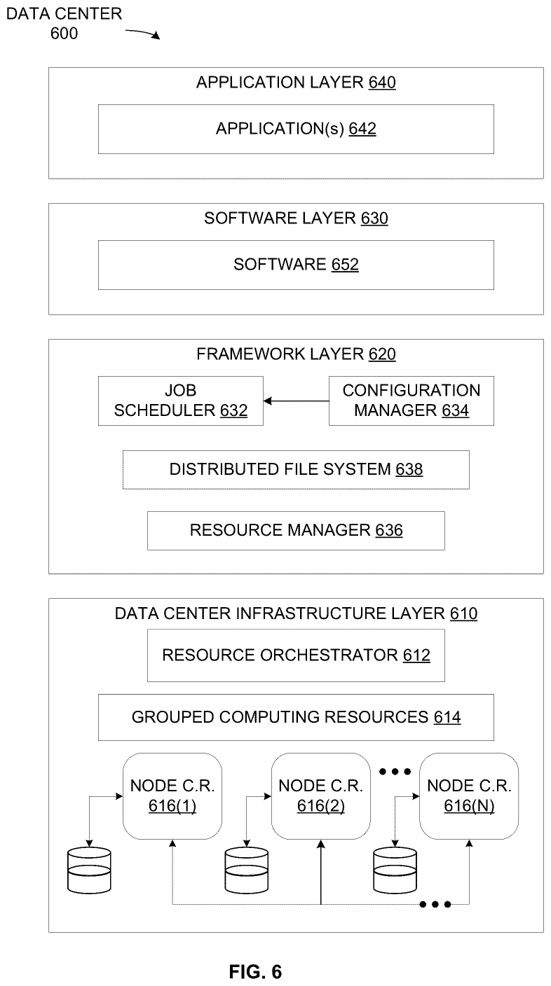

FIG. 6 illustrates an exemplary data center 600, in accordance with at least one embodiment. In at least one embodiment, data center 600 includes, without limitation, a data center infrastructure layer 610, a framework layer 620, a software layer 630 and an application layer 640.

In at least one embodiment, as shown in FIG. 6, data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (“CPUs”) or other processors (including accelerators, field programmable gate arrays (“FPGAs”), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 616(1)-616(N) may be a server having one or more of above-mentioned computing resources.

In at least one embodiment, grouped computing resources 614 may include separate groupings of node C.R.s housed within one or more racks (not shown), or many racks housed in data centers at various geographical locations (also not shown). Separate groupings of node C.R.s within grouped computing resources 614 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 612 may configure or otherwise control one or more node C.R.s 616(1)-616(N) and/or grouped computing resources 614. In at least one embodiment, resource orchestrator 612 may include a software design infrastructure (“SDI”) management entity for data center 600. In at least one embodiment, resource orchestrator 612 may include hardware, software or some combination thereof.

In at least one embodiment, as shown in FIG. 6, framework layer 620 includes, without limitation, a job scheduler 632, a configuration manager 634, a resource manager 636 and a distributed file system 638. In at least one embodiment, framework layer 620 may include a framework to support software 652 of software layer 630 and/or one or more application(s) 642 of application layer 640. In at least one embodiment, software 652 or application(s) 642 may respectively include web-based service software or applications, such as those provided by Amazon Web Services, Google Cloud and Microsoft Azure. In at least one embodiment, framework layer 620 may be, but is not limited to, a type of free and open-source software web application framework such as Apache Spark™ (hereinafter “Spark”) that may utilize distributed file system 638 for large-scale data processing (e.g., “big data”). In at least one embodiment, job scheduler 632 may include a Spark driver to facilitate scheduling of workloads supported by various layers of data center 600. In at least one embodiment, configuration manager 634 may be capable of configuring different layers such as software layer 630 and framework layer 620, including Spark and distributed file system 638 for supporting large-scale data processing. In at least one embodiment, resource manager 636 may be capable of managing clustered or grouped computing resources mapped to or allocated for support of distributed file system 638 and job scheduler 632. In at least one embodiment, clustered or grouped computing resources may include grouped computing resource 614 at data center infrastructure layer 610. In at least one embodiment, resource manager 636 may coordinate with resource orchestrator 612 to manage these mapped or allocated computing resources.

In at least one embodiment, software 652 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. In at least one or more types of applications may include, without limitation, CUDA applications, 5G network applications, artificial intelligence application, data center applications, and/or variations thereof.

In at least one embodiment, any of configuration manager 634, resource manager 636, and resource orchestrator 612 may implement any number and type of self-modifying actions based on any amount and type of data acquired in any technically feasible fashion. In at least one embodiment, self-modifying actions may relieve a data center operator of data center 600 from making possibly bad configuration decisions and possibly avoiding underutilized and/or poor performing portions of a data center.

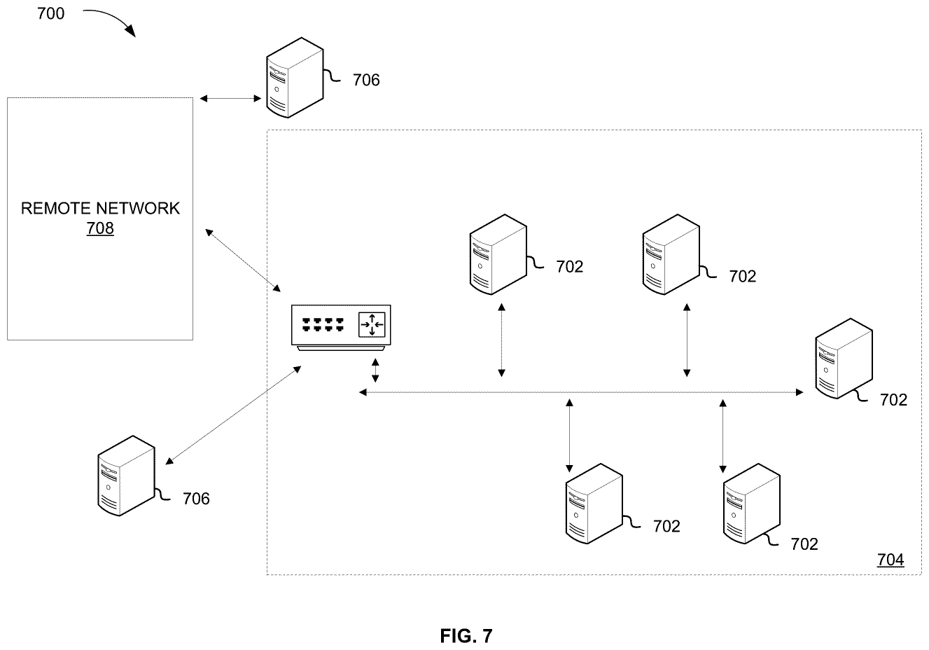

FIG. 7 illustrates a client-server network 704 formed by a plurality of network server computers 702 which are interlinked, in accordance with at least one embodiment. In at least one embodiment, in a system 700, each network server computer 702 stores data accessible to other network server computers 702 and to client computers 706 and networks 708 which link into a wide area network 704. In at least one embodiment, configuration of a client-server network 704 may change over time as client computers 706 and one or more networks 708 connect and disconnect from a network 704, and as one or more trunk line server computers 702 are added or removed from a network 704. In at least one embodiment, when a client computer 706 and a network 708 are connected with network server computers 702, client-server network includes such client computer 706 and network 708. In at least one embodiment, the term computer includes any device or machine capable of accepting data, applying prescribed processes to data, and supplying results of processes.

In at least one embodiment, client-server network 704 stores information which is accessible to network server computers 702, remote networks 708 and client computers 706. In at least one embodiment, network server computers 702 are formed by main frame computers minicomputers, and/or microcomputers having one or more processors each. In at least one embodiment, server computers 702 are linked together by wired and/or wireless transfer media, such as conductive wire, fiber optic cable, and/or microwave transmission media, satellite transmission media or other conductive, optic or electromagnetic wave transmission media. In at least one embodiment, client computers 706 access a network server computer 702 by a similar wired or a wireless transfer medium. In at least one embodiment, a client computer 706 may link into a client-server network 704 using a modem and a standard telephone communication network. In at least one embodiment, alternative carrier systems such as cable and satellite communication systems also may be used to link into client-server network 704. In at least one embodiment, other private or time-shared carrier systems may be used. In at least one embodiment, network 704 is a global information network, such as the Internet. In at least one embodiment, network is a private intranet using similar protocols as the Internet, but with added security measures and restricted access controls. In at least one embodiment, network 704 is a private, or semi-private network using proprietary communication protocols.

In at least one embodiment, client computer 706 is any end user computer, and may also be a mainframe computer, mini-computer or microcomputer having one or more microprocessors. In at least one embodiment, server computer 702 may at times function as a client computer accessing another server computer 702. In at least one embodiment, remote network 708 may be a local area network, a network added into a wide area network through an independent service provider (ISP) for the Internet, or another group of computers interconnected by wired or wireless transfer media having a configuration which is either fixed or changing over time. In at least one embodiment, client computers 706 may link into and access a network 704 independently or through a remote network 708.

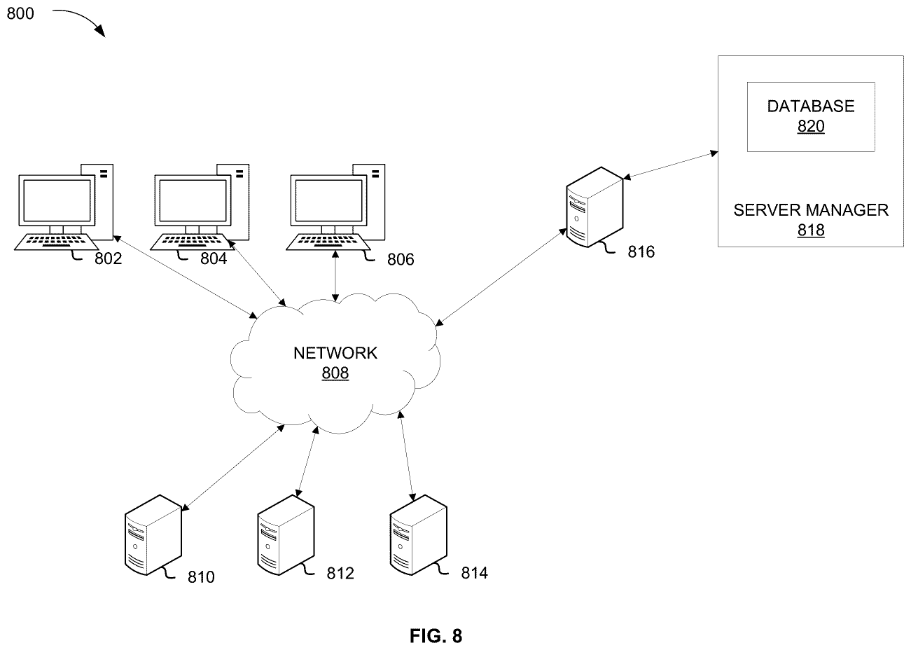

FIG. 8 illustrates an example 800 of a computer network 808 connecting one or more computing machines, in accordance with at least one embodiment. In at least one embodiment, network 808 may be any type of electronically connected group of computers including, for instance, the following networks: Internet, Intranet, Local Area Networks (LAN), Wide Area Networks (WAN) or an interconnected combination of these network types. In at least one embodiment, connectivity within a network 808 may be a remote modem, Ethernet (IEEE 802.3), Token Ring (IEEE 802.5), Fiber Distributed Datalink Interface (FDDI), Asynchronous Transfer Mode (ATM), or any other communication protocol. In at least one embodiment, computing devices linked to a network may be desktop, server, portable, handheld, set-top box, personal digital assistant (PDA), a terminal, or any other desired type or configuration. In at least one embodiment, depending on their functionality, network connected devices may vary widely in processing power, internal memory, and other performance aspects. In at least one embodiment, communications within a network and to or from computing devices connected to a network may be either wired or wireless. In at least one embodiment, network 808 may include, at least in part, the world-wide public Internet which generally connects a plurality of users in accordance with a client-server model in accordance with a transmission control protocol/internet protocol (TCP/IP) specification. In at least one embodiment, client-server network is a dominant model for communicating between two computers. In at least one embodiment, a client computer (“client”) issues one or more commands to a server computer (“server”). In at least one embodiment, server fulfills client commands by accessing available network resources and returning information to a client pursuant to client commands. In at least one embodiment, client computer systems and network resources resident on network servers are assigned a network address for identification during communications between elements of a network. In at least one embodiment, communications from other network connected systems to servers will include a network address of a relevant server/network resource as part of communication so that an appropriate destination of a data/request is identified as a recipient. In at least one embodiment, when a network 808 comprises the global Internet, a network address is an IP address in a TCP/IP format which may, at least in part, route data to an e-mail account, a website, or other Internet tool resident on a server. In at least one embodiment, information and services which are resident on network servers may be available to a web browser of a client computer through a domain name (e.g. www.site.com) which maps to an IP address of a network server.

In at least one embodiment, a plurality of clients 802, 804, and 806 are connected to a network 808 via respective communication links. In at least one embodiment, each of these clients may access a network 808 via any desired form of communication, such as via a dial-up modem connection, cable link, a digital subscriber line (DSL), wireless or satellite link, or any other form of communication. In at least one embodiment, each client may communicate using any machine that is compatible with a network 808, such as a personal computer (PC), work station, dedicated terminal, personal data assistant (PDA), or other similar equipment. In at least one embodiment, clients 802, 804, and 806 may or may not be located in a same geographical area.

In at least one embodiment, a plurality of servers 810, 812, and 814 are connected to a network 808 to serve clients that are in communication with a network 808. In at least one embodiment, each server is typically a powerful computer or device that manages network resources and responds to client commands. In at least one embodiment, servers include computer readable data storage media such as hard disk drives and RAM memory that store program instructions and data. In at least one embodiment, servers 810, 812, 814 run application programs that respond to client commands. In at least one embodiment, server 810 may run a web server application for responding to client requests for HTML, pages and may also run a mail server application for receiving and routing electronic mail. In at least one embodiment, other application programs, such as an FTP server or a media server for streaming audio/video data to clients may also be running on a server 810. In at least one embodiment, different servers may be dedicated to performing different tasks. In at least one embodiment, server 810 may be a dedicated web server that manages resources relating to web sites for various users, whereas a server 812 may be dedicated to provide electronic mail (email) management. In at least one embodiment, other servers may be dedicated for media (audio, video, etc.), file transfer protocol (FTP), or a combination of any two or more services that are typically available or provided over a network. In at least one embodiment, each server may be in a location that is the same as or different from that of other servers. In at least one embodiment, there may be multiple servers that perform mirrored tasks for users, thereby relieving congestion or minimizing traffic directed to and from a single server. In at least one embodiment, servers 810, 812, 814 are under control of a web hosting provider in a business of maintaining and delivering third party content over a network 808.

In at least one embodiment, web hosting providers deliver services to two different types of clients. In at least one embodiment, one type, which may be referred to as a browser, requests content from servers 810, 812, 814 such as web pages, email messages, video clips, etc. In at least one embodiment, a second type, which may be referred to as a user, hires a web hosting provider to maintain a network resource such as a web site, and to make it available to browsers. In at least one embodiment, users contract with a web hosting provider to make memory space, processor capacity, and communication bandwidth available for their desired network resource in accordance with an amount of server resources a user desires to utilize.

In at least one embodiment, in order for a web hosting provider to provide services for both of these clients, application programs which manage a network resources hosted by servers must be properly configured. In at least one embodiment, program configuration process involves defining a set of parameters which control, at least in part, an application program's response to browser requests and which also define, at least in part, a server resources available to a particular user.

In one embodiment, an intranet server 816 is in communication with a network 808 via a communication link. In at least one embodiment, intranet server 816 is in communication with a server manager 818. In at least one embodiment, server manager 818 comprises a database of an application program configuration parameters which are being utilized in servers 810, 812, 814. In at least one embodiment, users modify a database 820 via an intranet 816, and a server manager 818 interacts with servers 810, 812, 814 to modify application program parameters so that they match a content of a database. In at least one embodiment, a user logs onto an intranet server 816 by connecting to an intranet 816 via computer 802 and entering authentication information, such as a username and password.

In at least one embodiment, when a user wishes to sign up for new service or modify an existing service, an intranet server 816 authenticates a user and provides a user with an interactive screen display/control panel that allows a user to access configuration parameters for a particular application program. In at least one embodiment, a user is presented with a number of modifiable text boxes that describe aspects of a configuration of a user's web site or other network resource. In at least one embodiment, if a user desires to increase memory space reserved on a server for its web site, a user is provided with a field in which a user specifies a desired memory space. In at least one embodiment, in response to receiving this information, an intranet server 816 updates a database 820. In at least one embodiment, server manager 818 forwards this information to an appropriate server, and a new parameter is used during application program operation. In at least one embodiment, an intranet server 816 is configured to provide users with access to configuration parameters of hosted network resources (e.g., web pages, email, FTP sites, media sites, etc.), for which a user has contracted with a web hosting service provider.

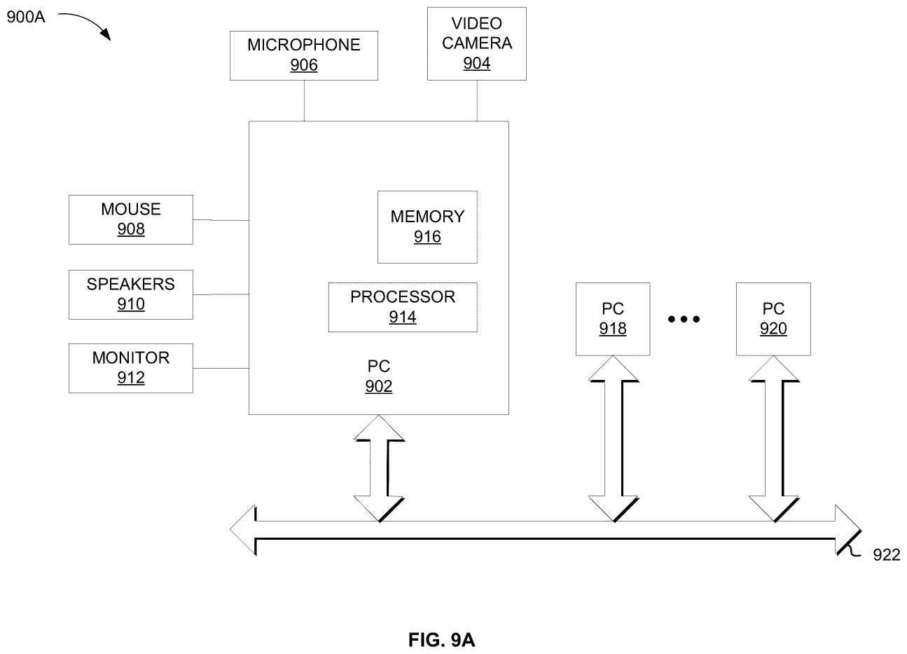

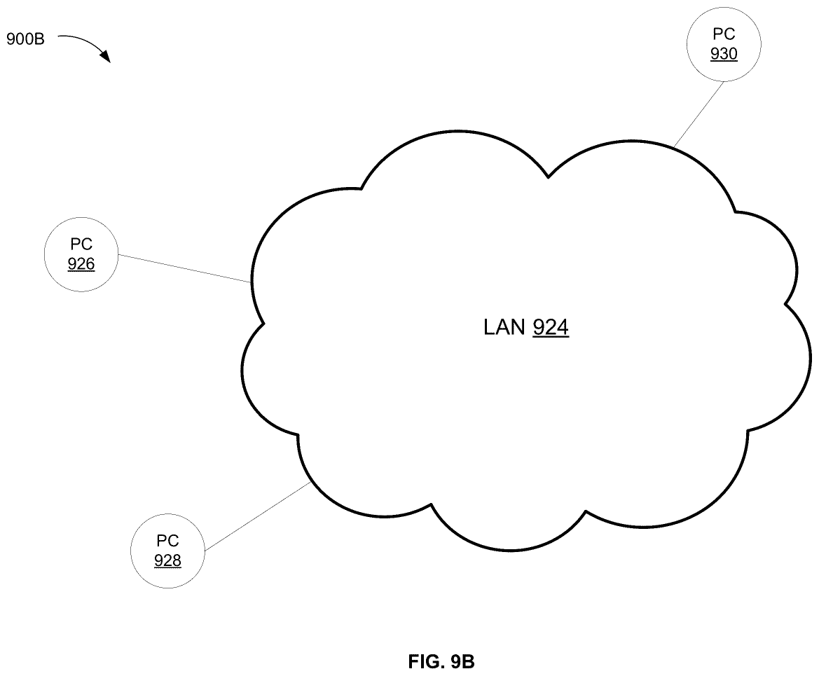

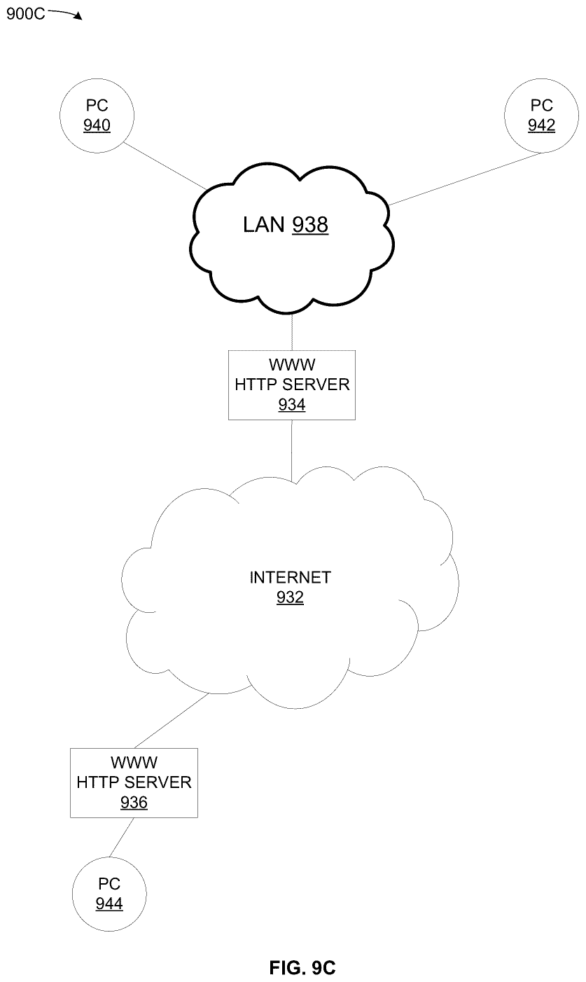

FIG. 9A illustrates a networked computer system 900A, in accordance with at least one embodiment. In at least one embodiment, networked computer system 900A comprises a plurality of nodes or personal computers (“PCs”) 902, 918, 920. In at least one embodiment, personal computer or node 902 comprises a processor 914, memory 916, video camera 904, microphone 906, mouse 908, speakers 910, and monitor 912. In at least one embodiment, PCs 902, 918, 920 may each run one or more desktop servers of an internal network within a given company, for instance, or may be servers of a general network not limited to a specific environment. In at least one embodiment, there is one server per PC node of a network, so that each PC node of a network represents a particular network server, having a particular network URL address. In at least one embodiment, each server defaults to a default web page for that server's user, which may itself contain embedded URLs pointing to further subpages of that user on that server, or to other servers or pages on other servers on a network.

In at least one embodiment, nodes 902, 918, 920 and other nodes of a network are interconnected via medium 922. In at least one embodiment, medium 922 may be, a communication channel such as an Integrated Services Digital Network (“ISDN”). In at least one embodiment, various nodes of a networked computer system may be connected through a variety of communication media, including local area networks (“LANs”), plain-old telephone lines (“POTS”), sometimes referred to as public switched telephone networks (“PSTN”), and/or variations thereof. In at least one embodiment, various nodes of a network may also constitute computer system users inter-connected via a network such as the Internet. In at least one embodiment, each server on a network (running from a particular node of a network at a given instance) has a unique address or identification within a network, which may be specifiable in terms of a URL.

In at least one embodiment, a plurality of multi-point conferencing units (“MCUs”) may thus be utilized to transmit data to and from various nodes or “endpoints” of a conferencing system. In at least one embodiment, nodes and/or MCUs may be interconnected via an ISDN link or through a local area network (“LAN”), in addition to various other communications media such as nodes connected through the Internet. In at least one embodiment, nodes of a conferencing system may, in general, be connected directly to a communications medium such as a LAN or through an MCU, and that a conferencing system may comprise other nodes or elements such as routers, servers, and/or variations thereof.

In at least one embodiment, processor 914 is a general-purpose programmable processor. In at least one embodiment, processors of nodes of networked computer system 900A may also be special-purpose video processors. In at least one embodiment, various peripherals and components of a node such as those of node 902 may vary from those of other nodes. In at least one embodiment, node 918 and node 920 may be configured identically to or differently than node 902. In at least one embodiment, a node may be implemented on any suitable computer system in addition to PC systems.

FIG. 9B illustrates a networked computer system 900B, in accordance with at least one embodiment. In at least one embodiment, system 900B illustrates a network such as LAN 924, which may be used to interconnect a variety of nodes that may communicate with each other. In at least one embodiment, attached to LAN 924 are a plurality of nodes such as PC nodes 926, 928, 930. In at least one embodiment, a node may also be connected to the LAN via a network server or other means. In at least one embodiment, system 900B comprises other types of nodes or elements, for example including routers, servers, and nodes.

FIG. 9C illustrates a networked computer system 900C, in accordance with at least one embodiment. In at least one embodiment, system 900C illustrates a WWW system having communications across a backbone communications network such as Internet 932, which may be used to interconnect a variety of nodes of a network. In at least one embodiment, WWW is a set of protocols operating on top of the Internet, and allows a graphical interface system to operate thereon for accessing information through the Internet. In at least one embodiment, attached to Internet 932 in WWW are a plurality of nodes such as PCs 940, 942, 944. In at least one embodiment, a node is interfaced to other nodes of WWW through a WWW HTTP server such as servers 934, 936. In at least one embodiment, PC 944 may be a PC forming a node of network 932 and itself running its server 936, although PC 944 and server 936 are illustrated separately in FIG. 9C for illustrative purposes.

In at least one embodiment, WWW is a distributed type of application, characterized by WWW HTTP, WWW's protocol, which runs on top of the Internet's transmission control protocol/Internet protocol (“TCP/IP”). In at least one embodiment, WWW may thus be characterized by a set of protocols (i.e., HTTP) running on the Internet as its “backbone.”

In at least one embodiment, a web browser is an application running on a node of a network that, in WWW-compatible type network systems, allows users of a particular server or node to view such information and thus allows a user to search graphical and text-based files that are linked together using hypertext links that are embedded in documents or files available from servers on a network that understand HTTP. In at least one embodiment, when a given web page of a first server associated with a first node is retrieved by a user using another server on a network such as the Internet, a document retrieved may have various hypertext links embedded therein and a local copy of a page is created local to a retrieving user. In at least one embodiment, when a user clicks on a hypertext link, locally-stored information related to a selected hypertext link is typically sufficient to allow a user's machine to open a connection across the Internet to a server indicated by a hypertext link.

In at least one embodiment, more than one user may be coupled to each HTTP server, for example through a LAN such as LAN 938 as illustrated with respect to WWW HTTP server 934. In at least one embodiment, system 900C may also comprise other types of nodes or elements. In at least one embodiment, a WWW HTTP server is an application running on a machine, such as a PC. In at least one embodiment, each user may be considered to have a unique “server,” as illustrated with respect to PC 944. In at least one embodiment, a server may be considered to be a server such as WWW HTTP server 934, which provides access to a network for a LAN or plurality of nodes or plurality of LANs. In at least one embodiment, there are a plurality of users, each having a desktop PC or node of a network, each desktop PC potentially establishing a server for a user thereof. In at least one embodiment, each server is associated with a particular network address or URL, which, when accessed, provides a default web page for that user. In at least one embodiment, a web page may contain further links (embedded URLs) pointing to further subpages of that user on that server, or to other servers on a network or to pages on other servers on a network.

### Cloud Computing and Services

The following figures set forth, without limitation, exemplary cloud-based systems that can be used to implement at least one embodiment.

In at least one embodiment, cloud computing is a style of computing in which dynamically scalable and often virtualized resources are provided as a service over the Internet. In at least one embodiment, users need not have knowledge of, expertise in, or control over technology infrastructure, which can be referred to as “in the cloud,” that supports them. In at least one embodiment, cloud computing incorporates infrastructure as a service, platform as a service, software as a service, and other variations that have a common theme of reliance on the Internet for satisfying computing needs of users. In at least one embodiment, a typical cloud deployment, such as in a private cloud (e.g., enterprise network), or a data center (DC) in a public cloud (e.g., Internet) can consist of thousands of servers (or alternatively, VMs), hundreds of Ethernet, Fiber Channel or Fiber Channel over Ethernet (FCoE) ports, switching and storage infrastructure, etc. In at least one embodiment, cloud can also consist of network services infrastructure like IPsec VPN hubs, firewalls, load balancers, wide area network (WAN) optimizers etc. In at least one embodiment, remote subscribers can access cloud applications and services securely by connecting via a VPN tunnel, such as an IPsec VPN tunnel.

In at least one embodiment, cloud computing is a model for enabling convenient, on-demand network access to a shared pool of configurable computing resources (e.g., networks, servers, storage, applications, and services) that can be rapidly provisioned and released with minimal management effort or service provider interaction.

In at least one embodiment, cloud computing is characterized by on-demand self-service, in which a consumer can unilaterally provision computing capabilities, such as server time and network storage, as needed automatically without requiring human inter-action with each service's provider. In at least one embodiment, cloud computing is characterized by broad network access, in which capabilities are available over a network and accessed through standard mechanisms that promote use by heterogeneous thin or thick client platforms (e.g., mobile phones, laptops, and PDAs). In at least one embodiment, cloud computing is characterized by resource pooling, in which a provider's computing resources are pooled to serve multiple consumers using a multi-tenant model, with different physical and virtual resources dynamically as-signed and reassigned according to consumer demand. In at least one embodiment, there is a sense of location independence in that a customer generally has no control or knowledge over an exact location of provided resources, but may be able to specify location at a higher level of abstraction (e.g., country, state, or datacenter). In at least one embodiment, examples of resources include storage, processing, memory, network bandwidth, and virtual machines. In at least one embodiment, cloud computing is characterized by rapid elasticity, in which capabilities can be rapidly and elastically provisioned, in some cases automatically, to quickly scale out and rapidly released to quickly scale in. In at least one embodiment, to a consumer, capabilities available for provisioning often appear to be unlimited and can be purchased in any quantity at any time. In at least one embodiment, cloud computing is characterized by measured service, in which cloud systems automatically control and optimize resource use by leveraging a metering capability at some level of abstraction appropriate to a type of service (e.g., storage, processing, bandwidth, and active user accounts). In at least one embodiment, resource usage can be monitored, controlled, and reported providing transparency for both a provider and consumer of a utilized service.

In at least one embodiment, cloud computing may be associated with various services. In at least one embodiment, cloud Software as a Service (SaaS) may refer to as service in which a capability provided to a consumer is to use a provider's applications running on a cloud infrastructure. In at least one embodiment, applications are accessible from various client devices through a thin client interface such as a web browser (e.g., web-based email). In at least one embodiment, consumer does not manage or control underlying cloud infrastructure including network, servers, operating systems, storage, or even individual application capabilities, with a possible exception of limited user-specific application configuration settings.

In at least one embodiment, cloud Platform as a Service (PaaS) may refer to a service in which a capability provided to a consumer is to deploy onto cloud infrastructure consumer-created or acquired applications created using programming languages and tools supported by a provider. In at least one embodiment, consumer does not manage or control underlying cloud infrastructure including networks, servers, operating systems, or storage, but has control over deployed applications and possibly application hosting environment configurations.

In at least one embodiment, cloud Infrastructure as a Service (IaaS) may refer to a service in which a capability provided to a consumer is to provision processing, storage, networks, and other fundamental computing resources where a consumer is able to deploy and run arbitrary software, which can include operating systems and applications. In at least one embodiment, consumer does not manage or control underlying cloud infrastructure, but has control over operating systems, storage, deployed applications, and possibly limited control of select networking components (e.g., host firewalls).

In at least one embodiment, cloud computing may be deployed in various ways. In at least one embodiment, a private cloud may refer to a cloud infrastructure that is operated solely for an organization. In at least one embodiment, a private cloud may be managed by an organization or a third party and may exist on-premises or off-premises. In at least one embodiment, a community cloud may refer to a cloud infrastructure that is shared by several organizations and supports a specific community that has shared concerns (e.g., mission, security requirements, policy, and compliance considerations). In at least one embodiment, a community cloud may be managed by organizations or a third party and may exist on-premises or off-premises. In at least one embodiment, a public cloud may refer to a cloud infrastructure that is made available to a general public or a large industry group and is owned by an organization providing cloud services. In at least one embodiment, a hybrid cloud may refer to a cloud infrastructure is a composition of two or more clouds (private, community, or public) that remain unique entities, but are bound together by standardized or proprietary technology that enables data and application portability (e.g., cloud bursting for load-balancing between clouds). In at least one embodiment, a cloud computing environment is service oriented with a focus on statelessness, low coupling, modularity, and semantic interoperability.

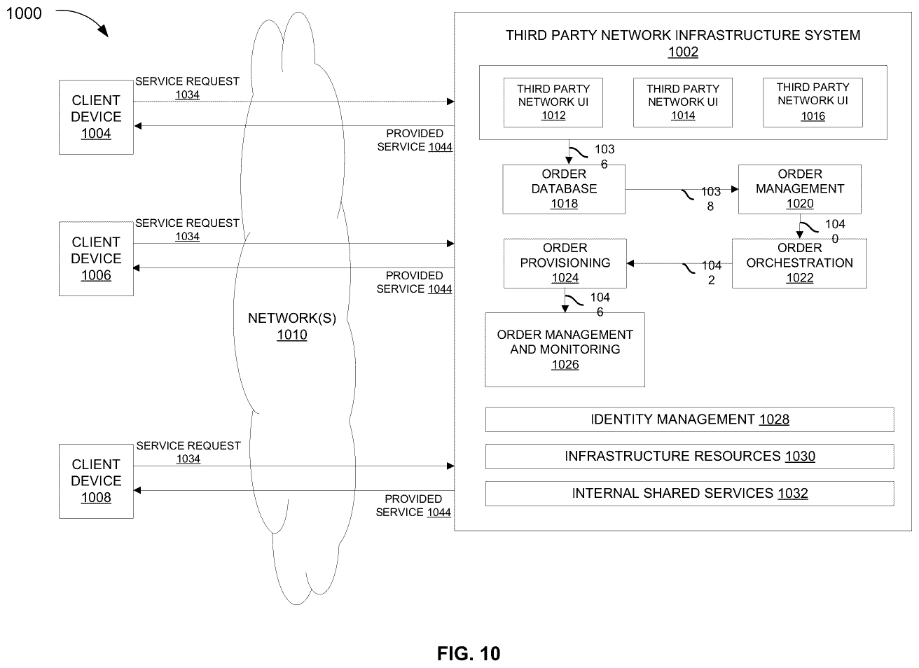

FIG. 10 illustrates one or more components of a system environment 1000 in which services may be offered as third party network services, in accordance with at least one embodiment. In at least one embodiment, a third party network may be referred to as a cloud, cloud network, cloud computing network, and/or variations thereof. In at least one embodiment, system environment 1000 includes one or more client computing devices 1004, 1006, and 1008 that may be used by users to interact with a third party network infrastructure system 1002 that provides third party network services, which may be referred to as cloud computing services. In at least one embodiment, third party network infrastructure system 1002 may comprise one or more computers and/or servers.

It should be appreciated that third party network infrastructure system 1002 depicted in FIG. 10 may have other components than those depicted. Further, FIG. 10 depicts an embodiment of a third party network infrastructure system. In at least one embodiment, third party network infrastructure system 1002 may have more or fewer components than depicted in FIG. 10, may combine two or more components, or may have a different configuration or arrangement of components.

In at least one embodiment, client computing devices 1004, 1006, and 1008 may be configured to operate a client application such as a web browser, a proprietary client application, or some other application, which may be used by a user of a client computing device to interact with third party network infrastructure system 1002 to use services provided by third party network infrastructure system 1002. Although exemplary system environment 1000 is shown with three client computing devices, any number of client computing devices may be supported. In at least one embodiment, other devices such as devices with sensors, etc. may interact with third party network infrastructure system 1002. In at least one embodiment, network(s) 1010 may facilitate communications and exchange of data between client computing devices 1004, 1006, and 1008 and third party network infrastructure system 1002.

In at least one embodiment, services provided by third party network infrastructure system 1002 may include a host of services that are made available to users of a third party network infrastructure system on demand. In at least one embodiment, various services may also be offered including without limitation online data storage and backup solutions, Web-based e-mail services, hosted office suites and document collaboration services, database management and processing, managed technical support services, and/or variations thereof. In at least one embodiment, services provided by a third party network infrastructure system can dynamically scale to meet needs of its users.

In at least one embodiment, a specific instantiation of a service provided by third party network infrastructure system 1002 may be referred to as a “service instance.” In at least one embodiment, in general, any service made available to a user via a communication network, such as the Internet, from a third party network service provider's system is referred to as a “third party network service.” In at least one embodiment, in a public third party network environment, servers and systems that make up a third party network service provider's system are different from a customer's own on-premises servers and systems. In at least one embodiment, a third party network service provider's system may host an application, and a user may, via a communication network such as the Internet, on demand, order and use an application.

In at least one embodiment, a service in a computer network third party network infrastructure may include protected computer network access to storage, a hosted database, a hosted web server, a software application, or other service provided by a third party network vendor to a user. In at least one embodiment, a service can include password-protected access to remote storage on a third party network through the Internet. In at least one embodiment, a service can include a web service-based hosted relational database and a script-language middleware engine for private use by a networked developer. In at least one embodiment, a service can include access to an email software application hosted on a third party network vendor's web site.

In at least one embodiment, third party network infrastructure system 1002 may include a suite of applications, middleware, and database service offerings that are delivered to a customer in a self-service, subscription-based, elastically scalable, reliable, highly available, and secure manner. In at least one embodiment, third party network infrastructure system 1002 may also provide “big data” related computation and analysis services. In at least one embodiment, term “big data” is generally used to refer to extremely large data sets that can be stored and manipulated by analysts and researchers to visualize large amounts of data, detect trends, and/or otherwise interact with data. In at least one embodiment, big data and related applications can be hosted and/or manipulated by an infrastructure system on many levels and at different scales. In at least one embodiment, tens, hundreds, or thousands of processors linked in parallel can act upon such data in order to present it or simulate external forces on data or what it represents. In at least one embodiment, these data sets can involve structured data, such as that organized in a database or otherwise according to a structured model, and/or unstructured data (e.g., emails, images, data blobs (binary large objects), web pages, complex event processing). In at least one embodiment, by leveraging an ability of an embodiment to relatively quickly focus more (or fewer) computing resources upon an objective, a third party network infrastructure system may be better available to carry out tasks on large data sets based on demand from a business, government agency, research organization, private individual, group of like-minded individuals or organizations, or other entity.

In at least one embodiment, third party network infrastructure system 1002 may be adapted to automatically provision, manage and track a customer's subscription to services offered by third party network infrastructure system 1002. In at least one embodiment, third party network infrastructure system 1002 may provide third party network services via different deployment models. In at least one embodiment, services may be provided under a public third party network model in which third party network infrastructure system 1002 is owned by an organization selling third party network services and services are made available to a general public or different industry enterprises. In at least one embodiment, services may be provided under a private third party network model in which third party network infrastructure system 1002 is operated solely for a single organization and may provide services for one or more entities within an organization. In at least one embodiment, third party network services may also be provided under a community third party network model in which third party network infrastructure system 1002 and services provided by third party network infrastructure system 1002 are shared by several organizations in a related community. In at least one embodiment, third party network services may also be provided under a hybrid third party network model, which is a combination of two or more different models.

In at least one embodiment, services provided by third party network infrastructure system 1002 may include one or more services provided under Software as a Service (SaaS) category, Platform as a Service (PaaS) category, Infrastructure as a Service (IaaS) category, or other categories of services including hybrid services. In at least one embodiment, a customer, via a subscription order, may order one or more services provided by third party network infrastructure system 1002. In at least one embodiment, third party network infrastructure system 1002 then performs processing to provide services in a customer's subscription order.

In at least one embodiment, services provided by third party network infrastructure system 1002 may include, without limitation, application services, platform services and infrastructure services. In at least one embodiment, application services may be provided by a third party network infrastructure system via a SaaS platform. In at least one embodiment, SaaS platform may be configured to provide third party network services that fall under a SaaS category. In at least one embodiment, SaaS platform may provide capabilities to build and deliver a suite of on-demand applications on an integrated development and deployment platform. In at least one embodiment, SaaS platform may manage and control underlying software and infrastructure for providing SaaS services. In at least one embodiment, by utilizing services provided by a SaaS platform, customers can utilize applications executing on a third party network infrastructure system. In at least one embodiment, customers can acquire an application services without a need for customers to purchase separate licenses and support. In at least one embodiment, various different SaaS services may be provided. In at least one embodiment, examples include, without limitation, services that provide solutions for sales performance management, enterprise integration, and business flexibility for large organizations.

In at least one embodiment, platform services may be provided by third party network infrastructure system 1002 via a PaaS platform. In at least one embodiment, PaaS platform may be configured to provide third party network services that fall under a PaaS category. In at least one embodiment, examples of platform services may include without limitation services that enable organizations to consolidate existing applications on a shared, common architecture, as well as an ability to build new applications that leverage shared services provided by a platform. In at least one embodiment, PaaS platform may manage and control underlying software and infrastructure for providing PaaS services. In at least one embodiment, customers can acquire PaaS services provided by third party network infrastructure system 1002 without a need for customers to purchase separate licenses and support.

In at least one embodiment, by utilizing services provided by a PaaS platform, customers can employ programming languages and tools supported by a third party network infrastructure system and also control deployed services. In at least one embodiment, platform services provided by a third party network infrastructure system may include database third party network services, middleware third party network services and third party network services. In at least one embodiment, database third party network services may support shared service deployment models that enable organizations to pool database resources and offer customers a Database as a Service in a form of a database third party network. In at least one embodiment, middleware third party network services may provide a platform for customers to develop and deploy various business applications, and third party network services may provide a platform for customers to deploy applications, in a third party network infrastructure system.

In at least one embodiment, various different infrastructure services may be provided by an IaaS platform in a third party network infrastructure system. In at least one embodiment, infrastructure services facilitate management and control of underlying computing resources, such as storage, networks, and other fundamental computing resources for customers utilizing services provided by a SaaS platform and a PaaS platform.

In at least one embodiment, third party network infrastructure system 1002 may also include infrastructure resources 1030 for providing resources used to provide various services to customers of a third party network infrastructure system. In at least one embodiment, infrastructure resources 1030 may include pre-integrated and optimized combinations of hardware, such as servers, storage, and networking resources to execute services provided by a Paas platform and a Saas platform, and other resources.

In at least one embodiment, resources in third party network infrastructure system 1002 may be shared by multiple users and dynamically re-allocated per demand. In at least one embodiment, resources may be allocated to users in different time zones. In at least one embodiment, third party network infrastructure system 1002 may enable a first set of users in a first time zone to utilize resources of a third party network infrastructure system for a specified number of hours and then enable a re-allocation of same resources to another set of users located in a different time zone, thereby maximizing utilization of resources.

In at least one embodiment, a number of internal shared services 1032 may be provided that are shared by different components or modules of third party network infrastructure system 1002 to enable provision of services by third party network infrastructure system 1002. In at least one embodiment, these internal shared services may include, without limitation, a security and identity service, an integration service, an enterprise repository service, an enterprise manager service, a virus scanning and white list service, a high availability, backup and recovery service, service for enabling third party network support, an email service, a notification service, a file transfer service, and/or variations thereof.

In at least one embodiment, third party network infrastructure system 1002 may provide comprehensive management of third party network services (e.g., SaaS, PaaS, and IaaS services) in a third party network infrastructure system. In at least one embodiment, third party network management functionality may include capabilities for provisioning, managing and tracking a customer's subscription received by third party network infrastructure system 1002, and/or variations thereof.

In at least one embodiment, as depicted in FIG. 10, third party network management functionality may be provided by one or more modules, such as an order management module 1020, an order orchestration module 1022, an order provisioning module 1024, an order management and monitoring module 1026, and an identity management module 1028. In at least one embodiment, these modules may include or be provided using one or more computers and/or servers, which may be general purpose computers, specialized server computers, server farms, server clusters, or any other appropriate arrangement and/or combination.

In at least one embodiment, at step 1034, a customer using a client device, such as client computing devices 1004, 1006 or 1008, may interact with third party network infrastructure system 1002 by requesting one or more services provided by third party network infrastructure system 1002 and placing an order for a subscription for one or more services offered by third party network infrastructure system 1002. In at least one embodiment, a customer may access a third party network User Interface (UI) such as third party network UI 1012, third party network UI 1014 and/or third party network UI 1016 and place a subscription order via these UIs. In at least one embodiment, order information received by third party network infrastructure system 1002 in response to a customer placing an order may include information identifying a customer and one or more services offered by a third party network infrastructure system 1002 that a customer intends to subscribe to.

In at least one embodiment, at step 1036, an order information received from a customer may be stored in an order database 1018. In at least one embodiment, if this is a new order, a new record may be created for an order. In at least one embodiment, order database 1018 can be one of several databases operated by third party network infrastructure system 1018 and operated in conjunction with other system elements.

In at least one embodiment, at step 1038, an order information may be forwarded to an order management module 1020 that may be configured to perform billing and accounting functions related to an order, such as verifying an order, and upon verification, booking an order.

In at least one embodiment, at step 1040, information regarding an order may be communicated to an order orchestration module 1022 that is configured to orchestrate provisioning of services and resources for an order placed by a customer. In at least one embodiment, order orchestration module 1022 may use services of order provisioning module 1024 for provisioning. In at least one embodiment, order orchestration module 1022 enables management of business processes associated with each order and applies business logic to determine whether an order should proceed to provisioning.

In at least one embodiment, at step 1042, upon receiving an order for a new subscription, order orchestration module 1022 sends a request to order provisioning module 1024 to allocate resources and configure resources needed to fulfill a subscription order. In at least one embodiment, order provisioning module 1024 enables an allocation of resources for services ordered by a customer. In at least one embodiment, order provisioning module 1024 provides a level of abstraction between third party network services provided by third party network infrastructure system 1000 and a physical implementation layer that is used to provision resources for providing requested services. In at least one embodiment, this enables order orchestration module 1022 to be isolated from implementation details, such as whether or not services and resources are actually provisioned in real-time or pre-provisioned and only allocated/assigned upon request.

In at least one embodiment, at step 1044, once services and resources are provisioned, a notification may be sent to subscribing customers indicating that a requested service is now ready for use. In at least one embodiment, information (e.g. a link) may be sent to a customer that enables a customer to start using requested services.

In at least one embodiment, at step 1046, a customer's subscription order may be managed and tracked by an order management and monitoring module 1026. In at least one embodiment, order management and monitoring module 1026 may be configured to collect usage statistics regarding a customer use of subscribed services. In at least one embodiment, statistics may be collected for an amount of storage used, an amount data transferred, a number of users, and an amount of system up time and system down time, and/or variations thereof.

In at least one embodiment, third party network infrastructure system 1000 may include an identity management module 1028 that is configured to provide identity services, such as access management and authorization services in third party network infrastructure system 1000. In at least one embodiment, identity management module 1028 may control information about customers who wish to utilize services provided by third party network infrastructure system 1002. In at least one embodiment, such information can include information that authenticates identities of such customers and information that describes which actions those customers are authorized to perform relative to various system resources (e.g., files, directories, applications, communication ports, memory segments, etc.). In at least one embodiment, identity management module 1028 may also include management of descriptive information about each customer and about how and by whom that descriptive information can be accessed and modified.

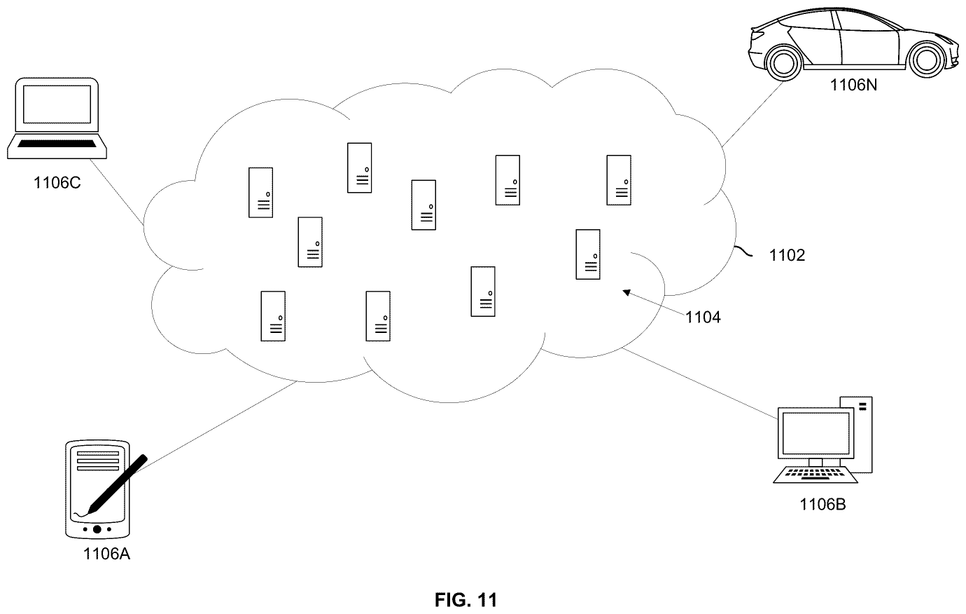

FIG. 11 illustrates a cloud computing environment 1102, in accordance with at least one embodiment. In at least one embodiment, cloud computing environment 1102 comprises one or more computer system/servers 1104 with which computing devices such as, personal digital assistant (PDA) or cellular telephone 1106A, desktop computer 1106B, laptop computer 1106C, and/or automobile computer system 1106N communicate. In at least one embodiment, this allows for infrastructure, platforms and/or software to be offered as services from cloud computing environment 1102, so as to not require each client to separately maintain such resources. It is understood that types of computing devices 1106A-N shown in FIG. 11 are intended to be illustrative only and that cloud computing environment 1102 can communicate with any type of computerized device over any type of network and/or network/addressable connection (e.g., using a web browser).

In at least one embodiment, a computer system/server 1104, which can be denoted as a cloud computing node, is operational with numerous other general purpose or special purpose computing system environments or configurations. In at least one embodiment, examples of computing systems, environments, and/or configurations that may be suitable for use with computer system/server 1104 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and/or variations thereof.

In at least one embodiment, computer system/server 1104 may be described in a general context of computer system-executable instructions, such as program modules, being executed by a computer system. In at least one embodiment, program modules include routines, programs, objects, components, logic, data structures, and so on, that perform particular tasks or implement particular abstract data types. In at least one embodiment, exemplary computer system/server 1104 may be practiced in distributed loud computing environments where tasks are performed by remote processing devices that are linked through a communications network. In at least one embodiment, in a distributed cloud computing environment, program modules may be located in both local and remote computer system storage media including memory storage devices.

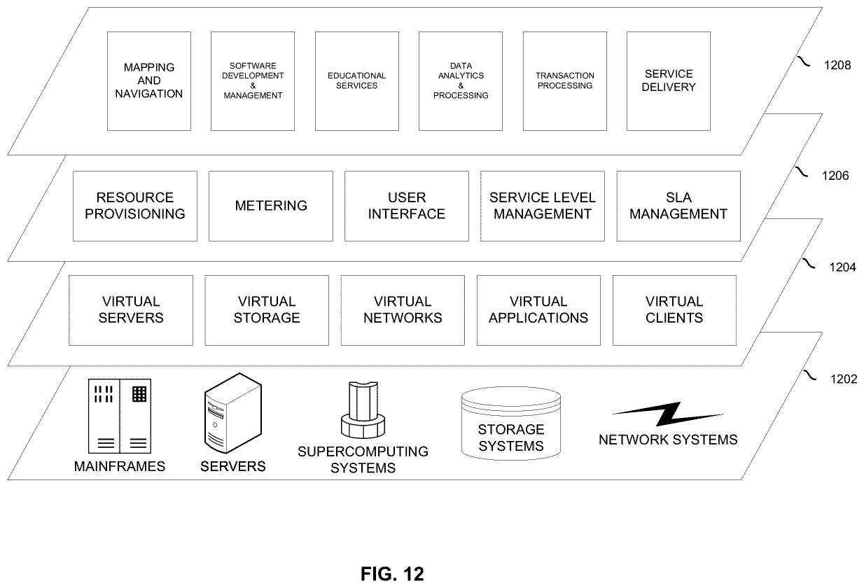

FIG. 12 illustrates a set of functional abstraction layers provided by cloud computing environment 1102 (FIG. 11), in accordance with at least one embodiment. It should be understood in advance that components, layers, and functions shown in FIG. 12 are intended to be illustrative only, and components, layers, and functions may vary.

In at least one embodiment, hardware and software layer 1202 includes hardware and software components. In at least one embodiment, examples of hardware components include mainframes, various RISC (Reduced Instruction Set Computer) architecture based servers, various computing systems, supercomputing systems, storage devices, networks, networking components, and/or variations thereof. In at least one embodiment, examples of software components include network application server software, various application server software, various database software, and/or variations thereof.

In at least one embodiment, virtualization layer 1204 provides an abstraction layer from which following exemplary virtual entities may be provided: virtual servers, virtual storage, virtual networks, including virtual private networks, virtual applications, virtual clients, and/or variations thereof.

In at least one embodiment, management layer 1206 provides various functions. In at least one embodiment, resource provisioning provides dynamic procurement of computing resources and other resources that are utilized to perform tasks within a cloud computing environment. In at least one embodiment, metering provides usage tracking as resources are utilized within a cloud computing environment, and billing or invoicing for consumption of these resources. In at least one embodiment, resources may comprise application software licenses. In at least one embodiment, security provides identity verification for users and tasks, as well as protection for data and other resources. In at least one embodiment, user interface provides access to a cloud computing environment for both users and system administrators. In at least one embodiment, service level management provides cloud computing resource allocation and management such that required service levels are met. In at least one embodiment, Service Level Agreement (SLA) management provides pre-arrangement for, and procurement of, cloud computing resources for which a future requirement is anticipated in accordance with an SLA.

In at least one embodiment, workloads layer 1208 provides functionality for which a cloud computing environment is utilized. In at least one embodiment, examples of workloads and functions which may be provided from this layer include: mapping and navigation, software development and management, educational services, data analytics and processing, transaction processing, and service delivery.

### Supercomputing

The following figures set forth, without limitation, exemplary supercomputer-based systems that can be used to implement at least one embodiment.

In at least one embodiment, a supercomputer may refer to a hardware system exhibiting substantial parallelism and comprising at least one chip, where chips in a system are interconnected by a network and are placed in hierarchically organized enclosures. In at least one embodiment, a large hardware system filling a machine room, with several racks, each containing several boards/rack modules, each containing several chips, all interconnected by a scalable network, is one particular example of a supercomputer. In at least one embodiment, a single rack of such a large hardware system is another example of a supercomputer. In at least one embodiment, a single chip exhibiting substantial parallelism and containing several hardware components can equally be considered to be a supercomputer, since as feature sizes may decrease, an amount of hardware that can be incorporated in a single chip may also increase.

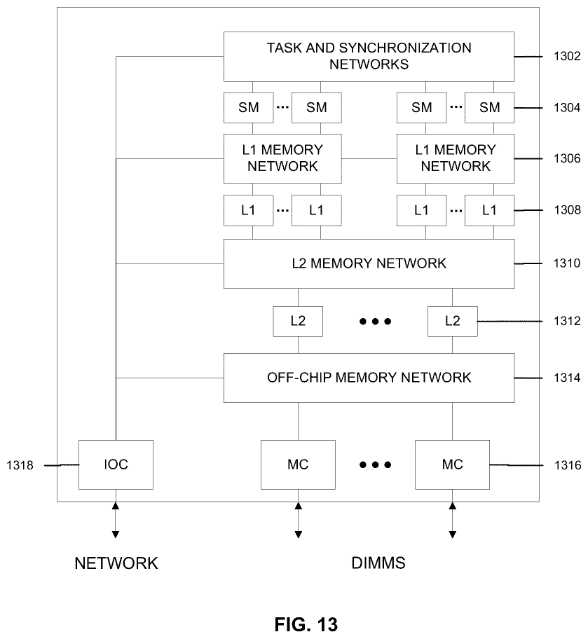

FIG. 13 illustrates a supercomputer at a chip level, in accordance with at least one embodiment. In at least one embodiment, inside an FPGA or ASIC chip, main computation is performed within finite state machines (1304) called thread units. In at least one embodiment, task and synchronization networks (1302) connect finite state machines and are used to dispatch threads and execute operations in correct order. In at least one embodiment, a multi-level partitioned on-chip cache hierarchy (1308, 1312) is accessed using memory networks (1306, 1310). In at least one embodiment, off-chip memory is accessed using memory controllers (1316) and an off-chip memory network (1314). In at least one embodiment, I/O controller (1318) is used for cross-chip communication when a design does not fit in a single logic chip.

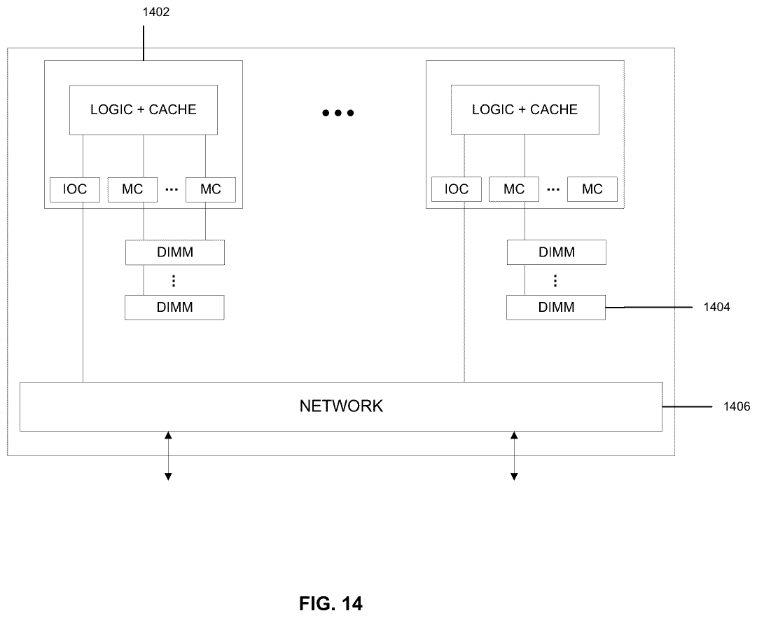

FIG. 14 illustrates a supercomputer at a rock module level, in accordance with at least one embodiment. In at least one embodiment, within a rack module, there are multiple FPGA or ASIC chips (1402) that are connected to one or more DRAM units (1404) which constitute main accelerator memory. In at least one embodiment, each FPGA/ASIC chip is connected to its neighbor FPGA/ASIC chip using wide busses on a board, with differential high speed signaling (1406). In at least one embodiment, each FPGA/ASIC chip is also connected to at least one high-speed serial communication cable.

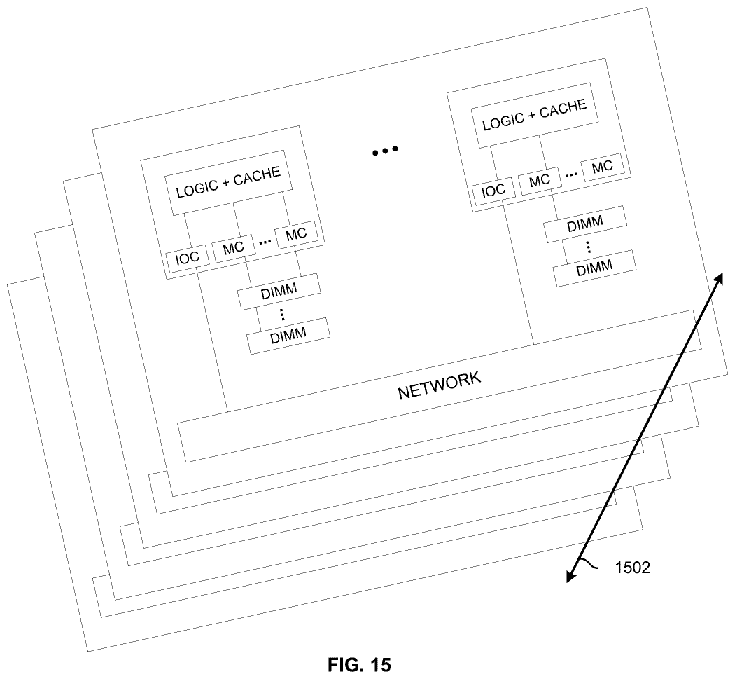

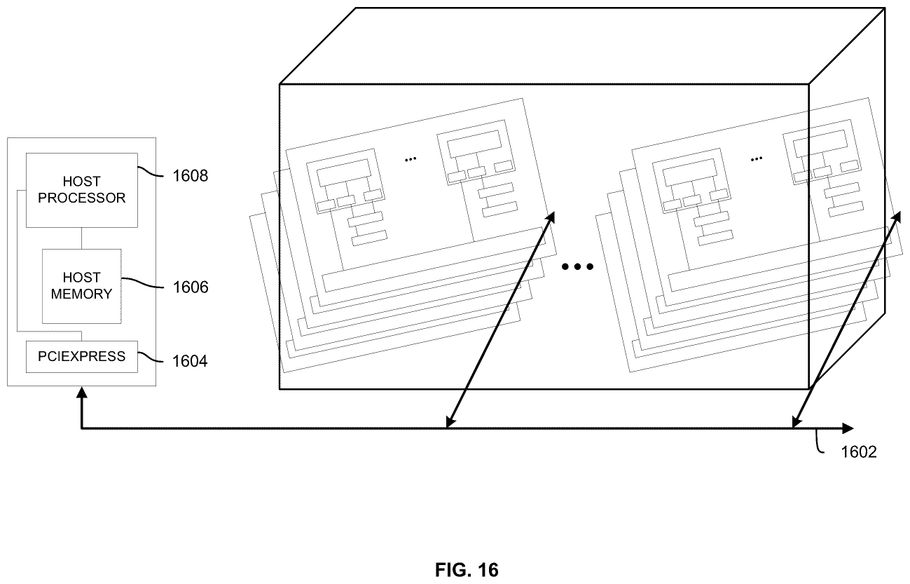

FIG. 15 illustrates a supercomputer at a rack level, in accordance with at least one embodiment. FIG. 16 illustrates a supercomputer at a whole system level, in accordance with at least one embodiment. In at least one embodiment, referring to FIG. 15 and FIG. 16, between rack modules in a rack and across racks throughout an entire system, high-speed serial optical or copper cables (1502, 1602) are used to realize a scalable, possibly incomplete hypercube network. In at least one embodiment, one of FPGA/ASIC chips of an accelerator is connected to a host system through a PCI-Express connection (1604). In at least one embodiment, host system comprises a host microprocessor (1608) that a software part of an application runs on and a memory consisting of one or more host memory DRAM units (1606) that is kept coherent with memory on an accelerator. In at least one embodiment, host system can be a separate module on one of racks, or can be integrated with one of a supercomputer's modules. In at least one embodiment, cube-connected cycles topology provide communication links to create a hypercube network for a large supercomputer. In at least one embodiment, a small group of FPGA/ASIC chips on a rack module can act as a single hypercube node, such that a total number of external links of each group is increased, compared to a single chip. In at least one embodiment, a group contains chips A, B, C and D on a rack module with internal wide differential busses connecting A, B, C and D in a torus organization. In at least one embodiment, there are 12 serial communication cables connecting a rack module to an outside world. In at least one embodiment, chip A on a rack module connects to serial communication cables 0, 1, 2. In at least one embodiment, chip B connects to cables 3, 4, 5. In at least one embodiment, chip C connects to 6, 7, 8. In at least one embodiment, chip D connects to 9, 10, 11. In at least one embodiment, an entire group {A, B, C, D} constituting a rack module can form a hypercube node within a supercomputer system, with up to 212=4096 rack modules (16384 FPGA/ASIC chips). In at least one embodiment, for chip A to send a message out on link 4 of group {A, B, C, D}, a message has to be routed first to chip B with an on-board differential wide bus connection. In at least one embodiment, a message arriving into a group {A, B, C, D} on link 4 (i.e., arriving at B) destined to chip A, also has to be routed first to a correct destination chip (A) internally within a group {A, B, C, D}. In at least one embodiment, parallel supercomputer systems of other sizes may also be implemented.

### Artificial Intelligence

The following figures set forth, without limitation, exemplary artificial intelligence-based systems that can be used to implement at least one embodiment.

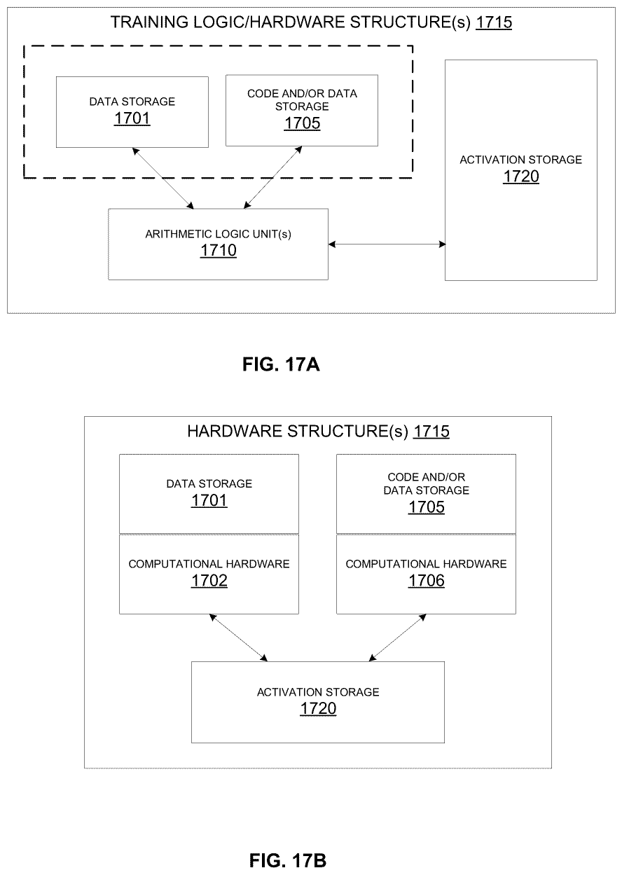

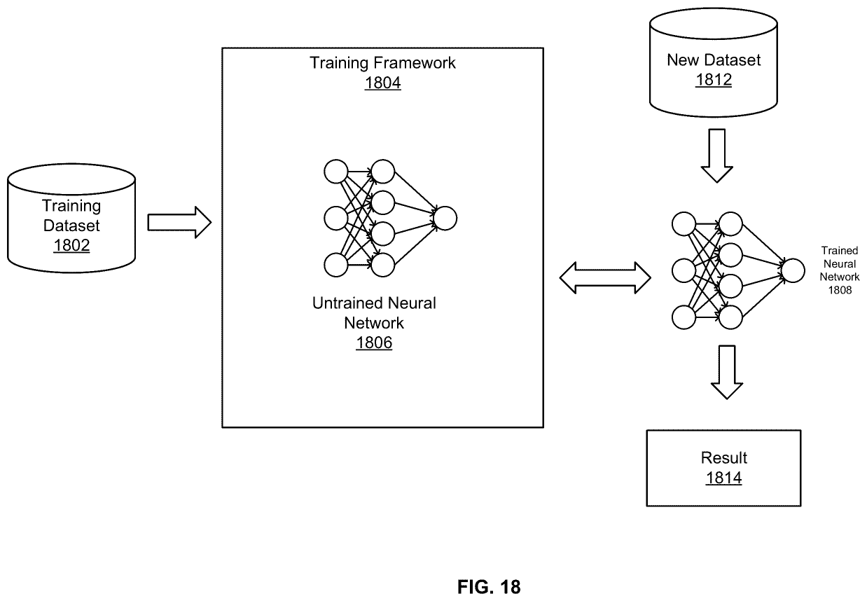

FIG. 17A illustrates inference and/or training logic 1715 used to perform inferencing and/or training operations associated with one or more embodiments. Details regarding inference and/or training logic 1715 are provided below in conjunction with FIGS. 17A and/or 17B.

In at least one embodiment, inference and/or training logic 1715 may include, without limitation, code and/or data storage 1701 to store forward and/or output weight and/or input/output data, and/or other parameters to configure neurons or layers of a neural network trained and/or used for inferencing in aspects of one or more embodiments. In at least one embodiment, training logic 1715 may include, or be coupled to code and/or data storage 1701 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which such code corresponds. In at least one embodiment code and/or data storage 1701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 1701 may be included with other on-chip or off-chip data storage, including a processor's L1, L2, or L3 cache or system memory.

In at least one embodiment, any portion of code and/or data storage 1701 may be internal or external to one or more processors or other hardware logic devices or circuits. In at least one embodiment, code and/or code and/or data storage 1701 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 1701 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 1715 may include, without limitation, a code and/or data storage 1705 to store backward and/or output weight and/or input/output data corresponding to neurons or layers of a neural network trained and/or used for inferencing in aspects of one or more embodiments. In at least one embodiment, code and/or data storage 1705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 1715 may include, or be coupled to code and/or data storage 1705 to store graph code or other software to control timing and/or order, in which weight and/or other parameter information is to be loaded to configure, logic, including integer and/or floating point units (collectively, arithmetic logic units (ALUs).

In at least one embodiment, code, such as graph code, causes loading of weight or other parameter information into processor ALUs based on an architecture of a neural network to which such code corresponds. In at least one embodiment, any portion of code and/or data storage 1705 may be included with other on-chip or off-chip data storage, including a processor's L1, L2, or L3 cache or system memory. In at least one embodiment, any portion of code and/or data storage 1705 may be internal or external to one or more processors or other hardware logic devices or circuits. In at least one embodiment, code and/or data storage 1705 may be cache memory, DRAM, SRAM, non-volatile memory (e.g., flash memory), or other storage. In at least one embodiment, a choice of whether code and/or data storage 1705 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 1701 and code and/or data storage 1705 may be separate storage structures. In at least one embodiment, code and/or data storage 1701 and code and/or data storage 1705 may be a combined storage structure. In at least one embodiment, code and/or data storage 1701 and code and/or data storage 1705 may be partially combined and partially separate. In at least one embodiment, any portion of code and/or data storage 1701 and code and/or data storage 1705 may be included with other on-chip or off-chip data storage, including a processor's L1, L2, or L3 cache or system memory.

In at least one embodiment, inference and/or training logic 1715 may include, without limitation, one or more arithmetic logic unit(s) (“ALU(s)”) 1710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 1720 that are functions of input/output and/or weight parameter data stored in code and/or data storage 1701 and/or code and/or data storage 1705. In at least one embodiment, activations stored in activation storage 1720 are generated according to linear algebraic and or matrix-based mathematics performed by ALU(s) 1710 in response to performing instructions or other code, wherein weight values stored in code and/or data storage 1705 and/or data storage 1701 are used as operands along with other values, such as bias values, gradient information, momentum values, or other parameters or hyperparameters, any or all of which may be stored in code and/or data storage 1705 or code and/or data storage 1701 or another storage on or off-chip.

In at least one embodiment, ALU(s) 1710 are included within one or more processors or other hardware logic devices or circuits, whereas in another embodiment, ALU(s) 1710 may be external to a processor or other hardware logic device or circuit that uses them (e.g., a co-processor). In at least one embodiment, ALUs 1710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 1701, code and/or data storage 1705, and activation storage 1720 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 1720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 1720 may be cache memory, DRAM, SRAM, non-volatile memory (e.g., flash memory), or other storage. In at least one embodiment, activation storage 1720 may be completely or partially within or external to one or more processors or other logical circuits. In at least one embodiment, a choice of whether activation storage 1720 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 1715 illustrated in FIG. 17A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 1715 illustrated in FIG. 17A may be used in conjunction with central processing unit (“CPU”) hardware, graphics processing unit (“GPU”) hardware or other hardware, such as field programmable gate arrays (“FPGAs”).

FIG. 17B illustrates inference and/or training logic 1715, according to at least one embodiment. In at least one embodiment, inference and/or training logic 1715 may include, without limitation, hardware logic in which computational resources are dedicated or otherwise exclusively used in conjunction with weight values or other information corresponding to one or more layers of neurons within a neural network. In at least one embodiment, inference and/or training logic 1715 illustrated in FIG. 17B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 1715 illustrated in FIG. 17B may be used in conjunction with central processing unit (CPU) hardware, graphics processing unit (GPU) hardware or other hardware, such as field programmable gate arrays (FPGAs). In at least one embodiment, inference and/or training logic 1715 includes, without limitation, code and/or data storage 1701 and code and/or data storage 1705, which may be used to store code (e.g., graph code), weight values and/or other information, including bias values, gradient information, momentum values, and/or other parameter or hyperparameter information. In at least one embodiment illustrated in FIG. 17B, each of code and/or data storage 1701 and code and/or data storage 1705 is associated with a dedicated computational resource, such as computational hardware 1702 and computational hardware 1706, respectively. In at least one embodiment, each of computational hardware 1702 and computational hardware 1706 comprises one or more ALUs that perform mathematical functions, such as linear algebraic functions, only on information stored in code and/or data storage 1701 and code and/or data storage 1705, respectively, result of which is stored in activation storage 1720.

In at least one embodiment, each of code and/or data storage 1701 and 1705 and corresponding computational hardware 1702 and 1706, respectively, correspond to different layers of a neural network, such that resulting activation from one storage/computational pair 1701/1702 of code and/or data storage 1701 and computational hardware 1702 is provided as an input to a next storage/computational pair 1705/1706 of code and/or data storage 1705 and computational hardware 1706, in order to mirror a conceptual organization of a neural network. In at least one embodiment, each of storage/computational pairs 1701/1702 and 1705/1706 may correspond to more than one neural network layer. In at least one embodiment, additional storage/computation pairs (not shown) subsequent to or in parallel with storage/computation pairs 1701/1702 and 1705/1706 may be included in inference and/or training logic 1715.

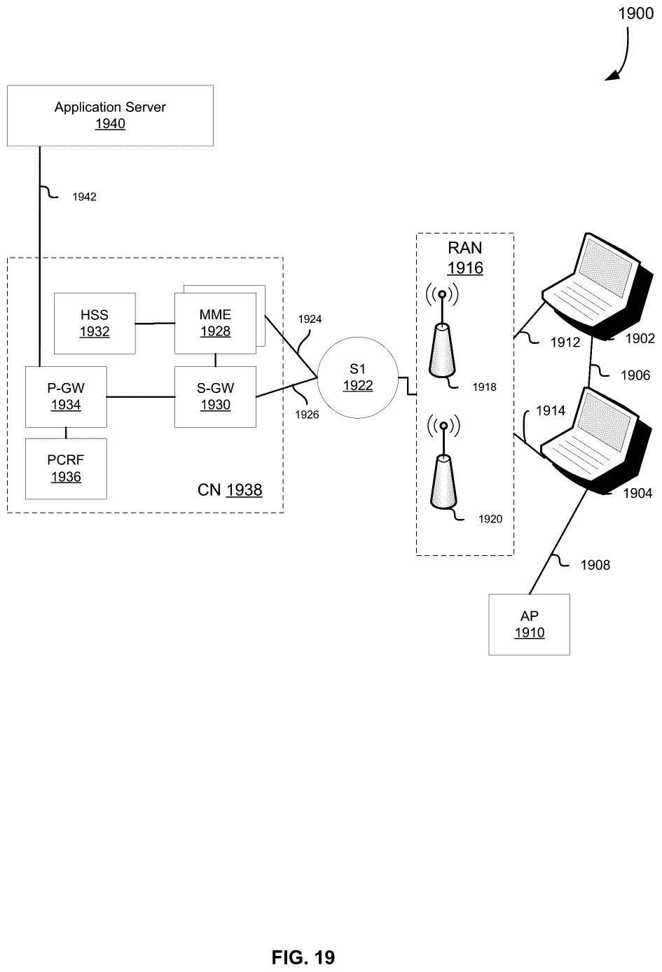

FIG. 18 illustrates training and deployment of a deep neural network, according to at least one embodiment. In at least one embodiment, untrained neural network 1806 is trained using a training dataset 1802. In at least one embodiment, training framework 1804 is a PyTorch framework, whereas in other embodiments, training framework 1804 is a TensorFlow, Boost, Caffe, Microsoft Cognitive Toolkit/CNTK, MXNet, Chainer, Keras, Deeplearning4j, or other training framework. In at least one embodiment, training framework 1804 trains an untrained neural network 1806 and enables it to be trained using processing resources described herein to generate a trained neural network 1808. In at least one embodiment, weights may be chosen randomly or by pre-training using a deep belief network. In at least one embodiment, training may be performed in either a supervised, partially supervised, or unsupervised manner.

In at least one embodiment, untrained neural network 1806 is trained using supervised learning, wherein training dataset 1802 includes an input paired with a desired output for an input, or where training dataset 1802 includes input having a known output and an output of neural network 1806 is manually graded. In at least one embodiment, untrained neural network 1806 is trained in a supervised manner and processes inputs from training dataset 1802 and compares resulting outputs against a set of expected or desired outputs. In at least one embodiment, errors are then propagated back through untrained neural network 1806. In at least one embodiment, training framework 1804 adjusts weights that control untrained neural network 1806. In at least one embodiment, training framework 1804 includes tools to monitor how well untrained neural network 1806 is converging towards a model, such as trained neural network 1808, suitable to generating correct answers, such as in result 1814, based on input data such as a new dataset 1812. In at least one embodiment, training framework 1804 trains untrained neural network 1806 repeatedly while adjust weights to refine an output of untrained neural network 1806 using a loss function and adjustment algorithm, such as stochastic gradient descent. In at least one embodiment, training framework 1804 trains untrained neural network 1806 until untrained neural network 1806 achieves a desired accuracy. In at least one embodiment, trained neural network 1808 can then be deployed to implement any number of machine learning operations.

In at least one embodiment, untrained neural network 1806 is trained using unsupervised learning, wherein untrained neural network 1806 attempts to train itself using unlabeled data. In at least one embodiment, unsupervised learning training dataset 1802 will include input data without any associated output data or “ground truth” data. In at least one embodiment, untrained neural network 1806 can learn groupings within training dataset 1802 and can determine how individual inputs are related to untrained dataset 1802. In at least one embodiment, unsupervised training can be used to generate a self-organizing map in trained neural network 1808 capable of performing operations useful in reducing dimensionality of new dataset 1812. In at least one embodiment, unsupervised training can also be used to perform anomaly detection, which allows identification of data points in new dataset 1812 that deviate from normal patterns of new dataset 1812.

In at least one embodiment, semi-supervised learning may be used, which is a technique in which in training dataset 1802 includes a mix of labeled and unlabeled data. In at least one embodiment, training framework 1804 may be used to perform incremental learning, such as through transferred learning techniques. In at least one embodiment, incremental learning enables trained neural network 1808 to adapt to new dataset 1812 without forgetting knowledge instilled within trained neural network 1808 during initial training.

### 5G Networks

The following figures set forth, without limitation, exemplary 5G network-based systems that can be used to implement at least one embodiment.

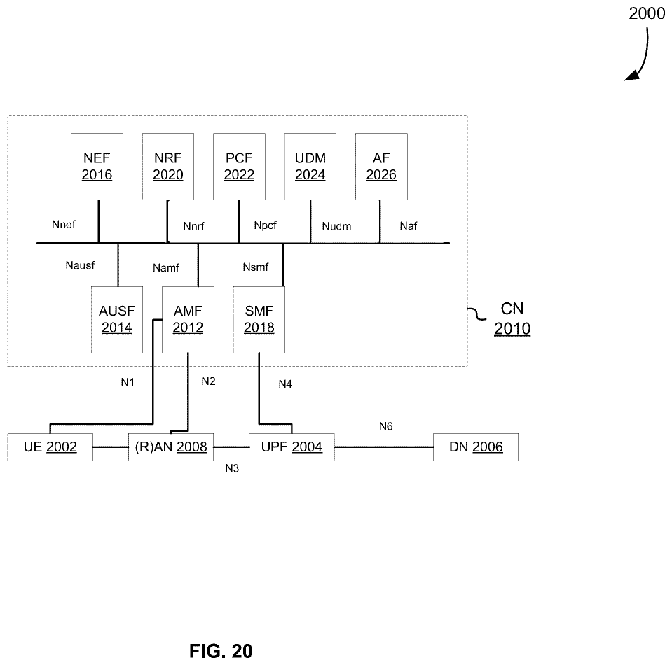

FIG. 19 illustrates an architecture of a system 1900 of a network, in accordance with at least one embodiment. In at least one embodiment, system 1900 is shown to include a user equipment (UE) 1902 and a UE 1904. In at least one embodiment, UEs 1902 and 1904 are illustrated as smartphones (e.g., handheld touchscreen mobile computing devices connectable to one or more cellular networks) but may also comprise any mobile or non-mobile computing device, such as Personal Data Assistants (PDAs), pagers, laptop computers, desktop computers, wireless handsets, or any computing device including a wireless communications interface.

In at least one embodiment, any of UEs 1902 and 1904 can comprise an Internet of Things (IoT) UE, which can comprise a network access layer designed for low-power IoT applications utilizing short-lived UE connections. In at least one embodiment, an IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. In at least one embodiment, a M2M or MTC exchange of data may be a machine-initiated exchange of data. In at least one embodiment, an IoT network describes interconnecting IoT UEs, which may include uniquely identifiable embedded computing devices (within Internet infrastructure), with short-lived connections. In at least one embodiment, an IoT UEs may execute background applications (e.g., keep alive messages, status updates, etc.) to facilitate connections of an IoT network.

In at least one embodiment, UEs 1902 and 1904 may be configured to connect, e.g., communicatively couple, with a radio access network (RAN) 1916. In at least one embodiment, RAN 1916 may be, for example, an Evolved Universal Mobile Telecommunications System (UMTS) Terrestrial Radio Access Network (E-UTRAN), a NextGen RAN (NG RAN), or some other type of RAN. In at least one embodiment, UEs 1902 and 1904 utilize connections 1912 and 1914, respectively, each of which comprises a physical communications interface or layer. In at least one embodiment, connections 1912 and 1914 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and variations thereof.

In at least one embodiment, UEs 1902 and 1904 may further directly exchange communication data via a ProSe interface 1906. In at least one embodiment, ProSe interface 1906 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

In at least one embodiment, UE 1904 is shown to be configured to access an access point (AP) 1910 via connection 1908. In at least one embodiment, connection 1908 can comprise a local wireless connection, such as a connection consistent with any IEEE 802.11 protocol, wherein AP 1910 would comprise a wireless fidelity (WiFi®) router. In at least one embodiment, AP 1910 is shown to be connected to an Internet without connecting to a core network of a wireless system.

In at least one embodiment, RAN 1916 can include one or more access nodes that enable connections 1912 and 1914. In at least one embodiment, these access nodes (ANs) can be referred to as base stations (BSs), NodeBs, evolved NodeBs (eNBs), next Generation NodeBs (gNB), RAN nodes, and so forth, and can comprise ground stations (e.g., terrestrial access points) or satellite stations providing coverage within a geographic area (e.g., a cell). In at least one embodiment, RAN 1916 may include one or more RAN nodes for providing macrocells, e.g., macro RAN node 1918, and one or more RAN nodes for providing femtocells or picocells (e.g., cells having smaller coverage areas, smaller user capacity, or higher bandwidth compared to macrocells), e.g., low power (LP) RAN node 1920.

In at least one embodiment, any of RAN nodes 1918 and 1920 can terminate an air interface protocol and can be a first point of contact for UEs 1902 and 1904. In at least one embodiment, any of RAN nodes 1918 and 1920 can fulfill various logical functions for RAN 1916 including, but not limited to, radio network controller (RNC) functions such as radio bearer management, uplink and downlink dynamic radio resource management and data packet scheduling, and mobility management.

In at least one embodiment, UEs 1902 and 1904 can be configured to communicate using Orthogonal Frequency-Division Multiplexing (OFDM) communication signals with each other or with any of RAN nodes 1918 and 1920 over a multi-carrier communication channel in accordance various communication techniques, such as, but not limited to, an Orthogonal Frequency Division Multiple Access (OFDMA) communication technique (e.g., for downlink communications) or a Single Carrier Frequency Division Multiple Access (SC-FDMA) communication technique (e.g., for uplink and ProSe or sidelink communications), and/or variations thereof. In at least one embodiment, OFDM signals can comprise a plurality of orthogonal sub-carriers.

In at least one embodiment, a downlink resource grid can be used for downlink transmissions from any of RAN nodes 1918 and 1920 to UEs 1902 and 1904, while uplink transmissions can utilize similar techniques. In at least one embodiment, a grid can be a time frequency grid, called a resource grid or time-frequency resource grid, which is a physical resource in a downlink in each slot. In at least one embodiment, such a time frequency plane representation is a common practice for OFDM systems, which makes it intuitive for radio resource allocation. In at least one embodiment, each column and each row of a resource grid corresponds to one OFDM symbol and one OFDM subcarrier, respectively. In at least one embodiment, a duration of a resource grid in a time domain corresponds to one slot in a radio frame. In at least one embodiment, a smallest time-frequency unit in a resource grid is denoted as a resource element. In at least one embodiment, each resource grid comprises a number of resource blocks, which describe a mapping of certain physical channels to resource elements. In at least one embodiment, each resource block comprises a collection of resource elements. In at least one embodiment, in a frequency domain, this may represent a smallest quantity of resources that currently can be allocated. In at least one embodiment, there are several different physical downlink channels that are conveyed using such resource blocks.

In at least one embodiment, a physical downlink shared channel (PDSCH) may carry user data and higher-layer signaling to UEs 1902 and 1904. In at least one embodiment, a physical downlink control channel (PDCCH) may carry information about a transport format and resource allocations related to PDSCH channel, among other things. In at least one embodiment, it may also inform UEs 1902 and 1904 about a transport format, resource allocation, and HARQ (Hybrid Automatic Repeat Request) information related to an uplink shared channel. In at least one embodiment, typically, downlink scheduling (assigning control and shared channel resource blocks to UE 1902 within a cell) may be performed at any of RAN nodes 1918 and 1920 based on channel quality information fed back from any of UEs 1902 and 1904. In at least one embodiment, downlink resource assignment information may be sent on a PDCCH used for (e.g., assigned to) each of UEs 1902 and 1904.

In at least one embodiment, a PDCCH may use control channel elements (CCEs) to convey control information. In at least one embodiment, before being mapped to resource elements, PDCCH complex valued symbols may first be organized into quadruplets, which may then be permuted using a sub-block interleaver for rate matching. In at least one embodiment, each PDCCH may be transmitted using one or more of these CCEs, where each CCE may correspond to nine sets of four physical resource elements known as resource element groups (REGs). In at least one embodiment, four Quadrature Phase Shift Keying (QPSK) symbols may be mapped to each REG. In at least one embodiment, PDCCH can be transmitted using one or more CCEs, depending on a size of a downlink control information (DCI) and a channel condition. In at least one embodiment, there can be four or more different PDCCH formats defined in LTE with different numbers of CCEs (e.g., aggregation level, L=1, 2, 4, or 8).

In at least one embodiment, an enhanced physical downlink control channel (EPDCCH) that uses PDSCH resources may be utilized for control information transmission. In at least one embodiment, EPDCCH may be transmitted using one or more enhanced control channel elements (ECCEs). In at least one embodiment, each ECCE may correspond to nine sets of four physical resource elements known as an enhanced resource element groups (EREGs). In at least one embodiment, an ECCE may have other numbers of EREGs in some situations.

In at least one embodiment, RAN 1916 is shown to be communicatively coupled to a core network (CN) 1938 via an S1 interface 1922. In at least one embodiment, CN 1938 may be an evolved packet core (EPC) network, a NextGen Packet Core (NPC) network, or some other type of CN. In at least one embodiment, S1 interface 1922 is split into two parts: S1-U interface 1926, which carries traffic data between RAN nodes 1918 and 1920 and serving gateway (S-GW) 1930, and a S1-mobility management entity (MME) interface 1924, which is a signaling interface between RAN nodes 1918 and 1920 and MMEs 1928.

In at least one embodiment, CN 1938 comprises MMEs 1928, S-GW 1930, Packet Data Network (PDN) Gateway (P-GW) 1934, and a home subscriber server (HSS) 1932. In at least one embodiment, MMEs 1928 may be similar in function to a control plane of legacy Serving General Packet Radio Service (GPRS) Support Nodes (SGSN). In at least one embodiment, MMEs 1928 may manage mobility aspects in access such as gateway selection and tracking area list management. In at least one embodiment, HSS 1932 may comprise a database for network users, including subscription related information to support a network entities' handling of communication sessions. In at least one embodiment, CN 1938 may comprise one or several HSSs 1932, depending on a number of mobile subscribers, on a capacity of an equipment, on an organization of a network, etc. In at least one embodiment, HSS 1932 can provide support for routing/roaming, authentication, authorization, naming/addressing resolution, location dependencies, etc.

In at least one embodiment, S-GW 1930 may terminate a S1 interface 1922 towards RAN 1916, and routes data packets between RAN 1916 and CN 1938. In at least one embodiment, S-GW 1930 may be a local mobility anchor point for inter-RAN node handovers and also may provide an anchor for inter-3GPP mobility. In at least one embodiment, other responsibilities may include lawful intercept, charging, and some policy enforcement.

In at least one embodiment, P-GW 1934 may terminate an SGi interface toward a PDN. In at least one embodiment, P-GW 1934 may route data packets between an EPC network 1938 and external networks such as a network including application server 1940 (alternatively referred to as application function (AF)) via an Internet Protocol (IP) interface 1942. In at least one embodiment, application server 1940 may be an element offering applications that use IP bearer resources with a core network (e.g., UMTS Packet Services (PS) domain, LTE PS data services, etc.). In at least one embodiment, P-GW 1934 is shown to be communicatively coupled to an application server 1940 via an IP communications interface 1942. In at least one embodiment, application server 1940 can also be configured to support one or more communication services (e.g., Voice-over-Internet Protocol (VoIP) sessions, PTT sessions, group communication sessions, social networking services, etc.) for UEs 1902 and 1904 via CN 1938.

In at least one embodiment, P-GW 1934 may further be a node for policy enforcement and charging data collection. In at least one embodiment, policy and Charging Enforcement Function (PCRF) 1936 is a policy and charging control element of CN 1938. In at least one embodiment, in a non-roaming scenario, there may be a single PCRF in a Home Public Land Mobile Network (HPLMN) associated with a UE's Internet Protocol Connectivity Access Network (IP-CAN) session. In at least one embodiment, in a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). In at least one embodiment, PCRF 1936 may be communicatively coupled to application server 1940 via P-GW 1934. In at least one embodiment, application server 1940 may signal PCRF 1936 to indicate a new service flow and select an appropriate Quality of Service (QoS) and charging parameters. In at least one embodiment, PCRF 1936 may provision this rule into a Policy and Charging Enforcement Function (PCEF) (not shown) with an appropriate traffic flow template (TFT) and QoS class of identifier (QCI), which commences a QoS and charging as specified by application server 1940.

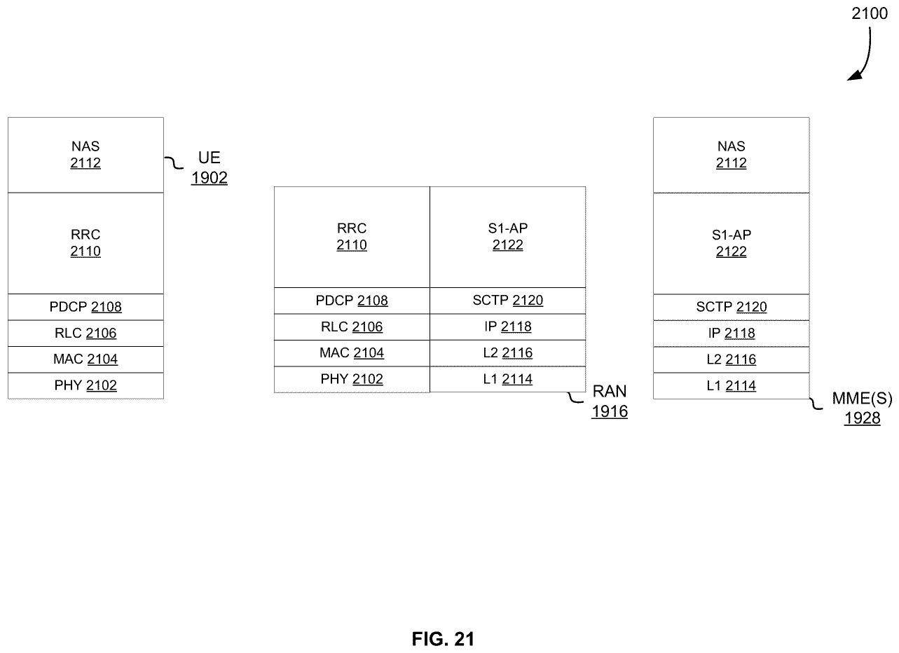

FIG. 20 illustrates an architecture of a system 2000 of a network in accordance with some embodiments. In at least one embodiment, system 2000 is shown to include a UE 2002, a 5G access node or RAN node (shown as (R)AN node 2008), a User Plane Function (shown as UPF 2004), a Data Network (DN 2006), which may be, for example, operator services, Internet access or 3rd party services, and a 5G Core Network (5GC) (shown as CN 2010).

In at least one embodiment, CN 2010 includes an Authentication Server Function (AUSF 2014); a Core Access and Mobility Management Function (AMF 2012); a Session Management Function (SMF 2018); a Network Exposure Function (NEF 2016); a Policy Control Function (PCF 2022); a Network Function (NF) Repository Function (NRF 2020); a Unified Data Management (UDM 2024); and an Application Function (AF 2026). In at least one embodiment, CN 2010 may also include other elements that are not shown, such as a Structured Data Storage network function (SDSF), an Unstructured Data Storage network function (UDSF), and variations thereof.

In at least one embodiment, UPF 2004 may act as an anchor point for intra-RAT and inter-RAT mobility, an external PDU session point of interconnect to DN 2006, and a branching point to support multi-homed PDU session. In at least one embodiment, UPF 2004 may also perform packet routing and forwarding, packet inspection, enforce user plane part of policy rules, lawfully intercept packets (UP collection); traffic usage reporting, perform QoS handling for user plane (e.g. packet filtering, gating, UL/DL rate enforcement), perform Uplink Traffic verification (e.g., SDF to QoS flow mapping), transport level packet marking in uplink and downlink, and downlink packet buffering and downlink data notification triggering. In at least one embodiment, UPF 2004 may include an uplink classifier to support routing traffic flows to a data network. In at least one embodiment, DN 2006 may represent various network operator services, Internet access, or third party services.

In at least one embodiment, AUSF 2014 may store data for authentication of UE 2002 and handle authentication related functionality. In at least one embodiment, AUSF 2014 may facilitate a common authentication framework for various access types.

In at least one embodiment, AMF 2012 may be responsible for registration management (e.g., for registering UE 2002, etc.), connection management, reachability management, mobility management, and lawful interception of AMF-related events, and access authentication and authorization. In at least one embodiment, AMF 2012 may provide transport for SM messages for SMF 2018, and act as a transparent proxy for routing SM messages. In at least one embodiment, AMF 2012 may also provide transport for short message service (SMS) messages between UE 2002 and an SMS function (SMSF) (not shown by FIG. 20). In at least one embodiment, AMF 2012 may act as Security Anchor Function (SEA), which may include interaction with AUSF 2014 and UE 2002 and receipt of an intermediate key that was established as a result of UE 2002 authentication process. In at least one embodiment, where USIM based authentication is used, AMF 2012 may retrieve security material from AUSF 2014. In at least one embodiment, AMF 2012 may also include a Security Context Management (SCM) function, which receives a key from SEA that it uses to derive access-network specific keys. In at least one embodiment, furthermore, AMF 2012 may be a termination point of RAN CP interface (N2 reference point), a termination point of NAS (NI) signaling, and perform NAS ciphering and integrity protection.

In at least one embodiment, AMF 2012 may also support NAS signaling with a UE 2002 over an N3 interworking-function (IWF) interface. In at least one embodiment, N3IWF may be used to provide access to untrusted entities. In at least one embodiment, N3IWF may be a termination point for N2 and N3 interfaces for control plane and user plane, respectively, and as such, may handle N2 signaling from SMF and AMF for PDU sessions and QoS, encapsulate/de-encapsulate packets for IPSec and N3 tunneling, mark N3 user-plane packets in uplink, and enforce QoS corresponding to N3 packet marking taking into account QoS requirements associated to such marking received over N2. In at least one embodiment, N3IWF may also relay uplink and downlink control-plane NAS (NI) signaling between UE 2002 and AMF 2012, and relay uplink and downlink user-plane packets between UE 2002 and UPF 2004. In at least one embodiment, N3IWF also provides mechanisms for IPsec tunnel establishment with UE 2002.

In at least one embodiment, SMF 2018 may be responsible for session management (e.g., session establishment, modify and release, including tunnel maintain between UPF and AN node); UE IP address allocation & management (including optional Authorization); Selection and control of UP function; Configures traffic steering at UPF to route traffic to proper destination; termination of interfaces towards Policy control functions; control part of policy enforcement and QoS; lawful intercept (for SM events and interface to LI System); termination of SM parts of NAS messages; downlink Data Notification; initiator of AN specific SM information, sent via AMF over N2 to AN; determine SSC mode of a session. In at least one embodiment, SMF 2018 may include following roaming functionality: handle local enforcement to apply QoS SLAB (VPLMN); charging data collection and charging interface (VPLMN); lawful intercept (in VPLMN for SM events and interface to LI System); support for interaction with external DN for transport of signaling for PDU session authorization/authentication by external DN.

In at least one embodiment, NEF 2016 may provide means for securely exposing services and capabilities provided by 3GPP network functions for third party, internal exposure/re-exposure, Application Functions (e.g., AF 2026), edge computing or fog computing systems, etc. In at least one embodiment, NEF 2016 may authenticate, authorize, and/or throttle AFs. In at least one embodiment, NEF 2016 may also translate information exchanged with AF 2026 and information exchanged with internal network functions. In at least one embodiment, NEF 2016 may translate between an AF-Service-Identifier and an internal 5GC information. In at least one embodiment, NEF 2016 may also receive information from other network functions (NFs) based on exposed capabilities of other network functions. In at least one embodiment, this information may be stored at NEF 2016 as structured data, or at a data storage NF using a standardized interfaces. In at least one embodiment, stored information can then be re-exposed by NEF 2016 to other NFs and AFs, and/or used for other purposes such as analytics.

In at least one embodiment, NRF 2020 may support service discovery functions, receive NF Discovery Requests from NF instances, and provide information of discovered NF instances to NF instances. In at least one embodiment, NRF 2020 also maintains information of available NF instances and their supported services.

In at least one embodiment, PCF 2022 may provide policy rules to control plane function(s) to enforce them, and may also support unified policy framework to govern network behavior. In at least one embodiment, PCF 2022 may also implement a front end (FE) to access subscription information relevant for policy decisions in a UDR of UDM 2024.

In at least one embodiment, UDM 2024 may handle subscription-related information to support a network entities' handling of communication sessions, and may store subscription data of UE 2002. In at least one embodiment, UDM 2024 may include two parts, an application FE and a User Data Repository (UDR). In at least one embodiment, UDM may include a UDM FE, which is in charge of processing of credentials, location management, subscription management and so on. In at least one embodiment, several different front ends may serve a same user in different transactions. In at least one embodiment, UDM-FE accesses subscription information stored in an UDR and performs authentication credential processing; user identification handling; access authorization; registration/mobility management; and subscription management. In at least one embodiment, UDR may interact with PCF 2022. In at least one embodiment, UDM 2024 may also support SMS management, wherein an SMS-FE implements a similar application logic as discussed previously.

In at least one embodiment, AF 2026 may provide application influence on traffic routing, access to a Network Capability Exposure (NCE), and interact with a policy framework for policy control. In at least one embodiment, NCE may be a mechanism that allows a 5GC and AF 2026 to provide information to each other via NEF 2016, which may be used for edge computing implementations. In at least one embodiment, network operator and third party services may be hosted close to UE 2002 access point of attachment to achieve an efficient service delivery through a reduced end-to-end latency and load on a transport network. In at least one embodiment, for edge computing implementations, 5GC may select a UPF 2004 close to UE 2002 and execute traffic steering from UPF 2004 to DN 2006 via N6 interface. In at least one embodiment, this may be based on UE subscription data, UE location, and information provided by AF 2026. In at least one embodiment, AF 2026 may influence UPF (re)selection and traffic routing. In at least one embodiment, based on operator deployment, when AF 2026 is considered to be a trusted entity, a network operator may permit AF 2026 to interact directly with relevant NFs.

In at least one embodiment, CN 2010 may include an SMSF, which may be responsible for SMS subscription checking and verification, and relaying SM messages to/from UE 2002 to/from other entities, such as an SMS-GMSC/IWMSC/SMS-router. In at least one embodiment, SMS may also interact with AMF 2012 and UDM 2024 for notification procedure that UE 2002 is available for SMS transfer (e.g., set a UE not reachable flag, and notifying UDM 2024 when UE 2002 is available for SMS).

In at least one embodiment, system 2000 may include following service-based interfaces: Namf: Service-based interface exhibited by AMF; Nsmf: Service-based interface exhibited by SMF; Nnef: Service-based interface exhibited by NEF; Npcf: Service-based interface exhibited by PCF; Nudm: Service-based interface exhibited by UDM; Naf: Service-based interface exhibited by AF; Nnrf: Service-based interface exhibited by NRF; and Nausf: Service-based interface exhibited by AUSF.

In at least one embodiment, system 2000 may include following reference points: N1: Reference point between UE and AMF; N2: Reference point between (R)AN and AMF; N3: Reference point between (R)AN and UPF; N4: Reference point between SMF and UPF; and N6: Reference point between UPF and a Data Network. In at least one embodiment, there may be many more reference points and/or service-based interfaces between a NF services in NFs, however, these interfaces and reference points have been omitted for clarity. In at least one embodiment, an NS reference point may be between a PCF and AF; an N7 reference point may be between PCF and SMF; an N11 reference point between AMF and SMF; etc. In at least one embodiment, CN 2010 may include an Nx interface, which is an inter-CN interface between MME and AMF 2012 in order to enable interworking between CN 2010 and CN 7220.

In at least one embodiment, system 2000 may include multiple RAN nodes (such as (R)AN node 2008) wherein an Xn interface is defined between two or more (R)AN node 2008 (e.g., gNBs) that connecting to 5GC 410, between a (R)AN node 2008 (e.g., gNB) connecting to CN 2010 and an eNB (e.g., a macro RAN node), and/or between two eNBs connecting to CN 2010.

In at least one embodiment, Xn interface may include an Xn user plane (Xn-U) interface and an Xn control plane (Xn-C) interface. In at least one embodiment, Xn-U may provide non-guaranteed delivery of user plane PDUs and support/provide data forwarding and flow control functionality. In at least one embodiment, Xn-C may provide management and error handling functionality, functionality to manage a Xn-C interface; mobility support for UE 2002 in a connected mode (e.g., CM-CONNECTED) including functionality to manage UE mobility for connected mode between one or more (R)AN node 2008. In at least one embodiment, mobility support may include context transfer from an old (source) serving (R)AN node 2008 to new (target) serving (R)AN node 2008; and control of user plane tunnels between old (source) serving (R)AN node 2008 to new (target) serving (R)AN node 2008.

In at least one embodiment, a protocol stack of a Xn-U may include a transport network layer built on Internet Protocol (IP) transport layer, and a GTP-U layer on top of a UDP and/or IP layer(s) to carry user plane PDUs. In at least one embodiment, Xn-C protocol stack may include an application layer signaling protocol (referred to as Xn Application Protocol (Xn-AP)) and a transport network layer that is built on an SCTP layer. In at least one embodiment, SCTP layer may be on top of an IP layer. In at least one embodiment, SCTP layer provides a guaranteed delivery of application layer messages. In at least one embodiment, in a transport IP layer point-to-point transmission is used to deliver signaling PDUs. In at least one embodiment, Xn-U protocol stack and/or a Xn-C protocol stack may be same or similar to a user plane and/or control plane protocol stack(s) shown and described herein.

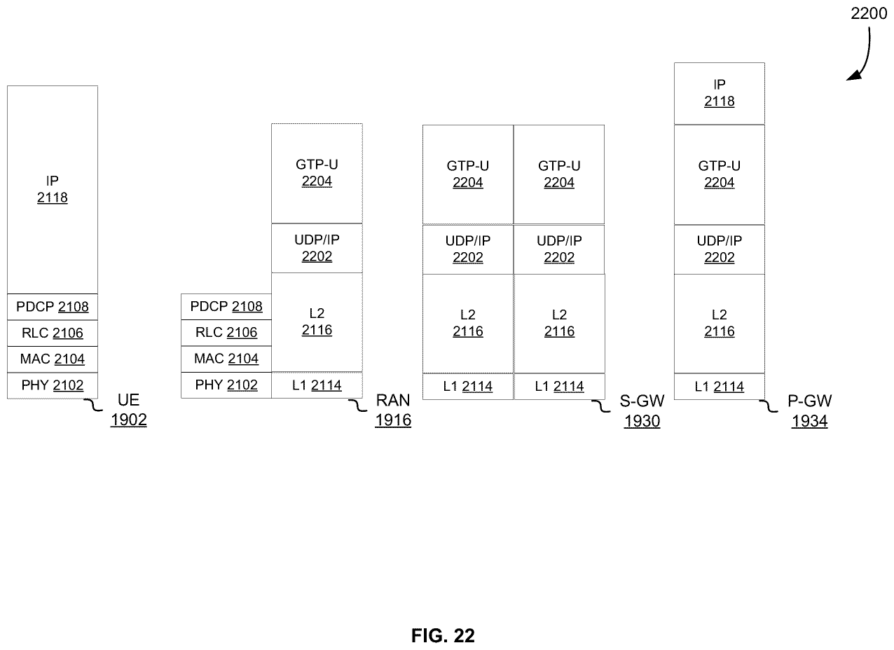

FIG. 21 is an illustration of a control plane protocol stack in accordance with some embodiments. In at least one embodiment, a control plane 2100 is shown as a communications protocol stack between UE 1902 (or alternatively, UE 1904), RAN 1916, and MME(s) 1928.

In at least one embodiment, PHY layer 2102 may transmit or receive information used by MAC layer 2104 over one or more air interfaces. In at least one embodiment, PHY layer 2102 may further perform link adaptation or adaptive modulation and coding (AMC), power control, cell search (e.g., for initial synchronization and handover purposes), and other measurements used by higher layers, such as an RRC layer 2110. In at least one embodiment, PHY layer 2102 may still further perform error detection on transport channels, forward error correction (FEC) coding/de-coding of transport channels, modulation/demodulation of physical channels, interleaving, rate matching, mapping onto physical channels, and Multiple Input Multiple Output (MIMO) antenna processing.

In at least one embodiment, MAC layer 2104 may perform mapping between logical channels and transport channels, multiplexing of MAC service data units (SDUs) from one or more logical channels onto transport blocks (TB) to be delivered to PHY via transport channels, de-multiplexing MAC SDUs to one or more logical channels from transport blocks (TB) delivered from PHY via transport channels, multiplexing MAC SDUs onto TBs, scheduling information reporting, error correction through hybrid automatic repeat request (HARD), and logical channel prioritization.

In at least one embodiment, RLC layer 2106 may operate in a plurality of modes of operation, including: Transparent Mode (TM), Unacknowledged Mode (UM), and Acknowledged Mode (AM). In at least one embodiment, RLC layer 2106 may execute transfer of upper layer protocol data units (PDUs), error correction through automatic repeat request (ARQ) for AM data transfers, and concatenation, segmentation and reassembly of RLC SDUs for UM and AM data transfers. In at least one embodiment, RLC layer 2106 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

In at least one embodiment, PDCP layer 2108 may execute header compression and decompression of IP data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

In at least one embodiment, main services and functions of a RRC layer 2110 may include broadcast of system information (e.g., included in Master Information Blocks (MIBs) or System Information Blocks (SIBs) related to a non-access stratum (NAS)), broadcast of system information related to an access stratum (AS), paging, establishment, maintenance and release of an RRC connection between an UE and E-UTRAN (e.g., RRC connection paging, RRC connection establishment, RRC connection modification, and RRC connection release), establishment, configuration, maintenance and release of point-to-point radio bearers, security functions including key management, inter radio access technology (RAT) mobility, and measurement configuration for UE measurement reporting. In at least one embodiment, said MIBs and SIBs may comprise one or more information elements (IEs), which may each comprise individual data fields or data structures.

In at least one embodiment, UE 1902 and RAN 1916 may utilize a Uu interface (e.g., an LTE-Uu interface) to exchange control plane data via a protocol stack comprising PHY layer 2102, MAC layer 2104, RLC layer 2106, PDCP layer 2108, and RRC layer 2110.

In at least one embodiment, non-access stratum (NAS) protocols (NAS protocols 2112) form a highest stratum of a control plane between UE 1902 and MME(s) 1928. In at least one embodiment, NAS protocols 2112 support mobility of UE 1902 and session management procedures to establish and maintain IP connectivity between UE 1902 and P-GW 1934.

In at least one embodiment, Si Application Protocol (S1-AP) layer (Si-AP layer 2122) may support functions of a Si interface and comprise Elementary Procedures (EPs). In at least one embodiment, an EP is a unit of interaction between RAN 1916 and CN 1928. In at least one embodiment, S1-AP layer services may comprise two groups: UE-associated services and non UE-associated services. In at least one embodiment, these services perform functions including, but not limited to: E-UTRAN Radio Access Bearer (E-RAB) management, UE capability indication, mobility, NAS signaling transport, RAN Information Management (RIM), and configuration transfer.

In at least one embodiment, Stream Control Transmission Protocol (SCTP) layer (alternatively referred to as a stream control transmission protocol/internet protocol (SCTP/IP) layer) (SCTP layer 2120) may ensure reliable delivery of signaling messages between RAN 1916 and MME(s) 1928 based, in part, on an IP protocol, supported by an IP layer 2118. In at least one embodiment, L2 layer 2116 and an L1 layer 2114 may refer to communication links (e.g., wired or wireless) used by a RAN node and MME to exchange information.

In at least one embodiment, RAN 1916 and MME(s) 1928 may utilize an S1-MME interface to exchange control plane data via a protocol stack comprising a L1 layer 2114, L2 layer 2116, IP layer 2118, SCTP layer 2120, and Si-AP layer 2122.

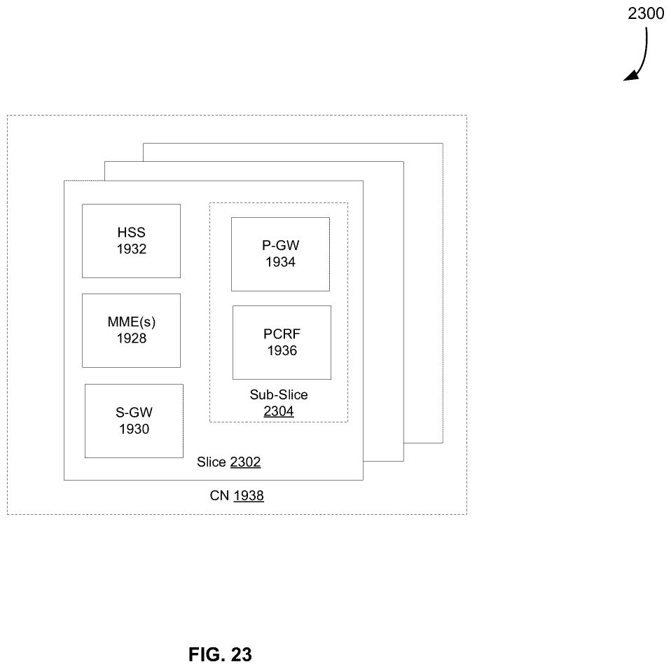

FIG. 22 is an illustration of a user plane protocol stack in accordance with at least one embodiment. In at least one embodiment, a user plane 2200 is shown as a communications protocol stack between a UE 1902, RAN 1916, S-GW 1930, and P-GW 1934. In at least one embodiment, user plane 2200 may utilize a same protocol layers as control plane 2100. In at least one embodiment, for example, UE 1902 and RAN 1916 may utilize a Uu interface (e.g., an LTE-Uu interface) to exchange user plane data via a protocol stack comprising PHY layer 2102, MAC layer 2104, RLC layer 2106, PDCP layer 2108.

In at least one embodiment, General Packet Radio Service (GPRS) Tunneling Protocol for a user plane (GTP-U) layer (GTP-U layer 2204) may be used for carrying user data within a GPRS core network and between a radio access network and a core network. In at least one embodiment, user data transported can be packets in any of IPv4, IPv6, or PPP formats, for example. In at least one embodiment, UDP and IP security (UDP/IP) layer (UDP/IP layer 2202) may provide checksums for data integrity, port numbers for addressing different functions at a source and destination, and encryption and authentication on selected data flows. In at least one embodiment, RAN 1916 and S-GW 1930 may utilize an S1-U interface to exchange user plane data via a protocol stack comprising L1 layer 2114, L2 layer 2116, UDP/IP layer 2202, and GTP-U layer 2204. In at least one embodiment, S-GW 1930 and P-GW 1934 may utilize an S5/S8a interface to exchange user plane data via a protocol stack comprising L1 layer 2114, L2 layer 2116, UDP/IP layer 2202, and GTP-U layer 2204. In at least one embodiment, as discussed above with respect to FIG. 21, NAS protocols support a mobility of UE 1902 and session management procedures to establish and maintain IP connectivity between UE 1902 and P-GW 1934.

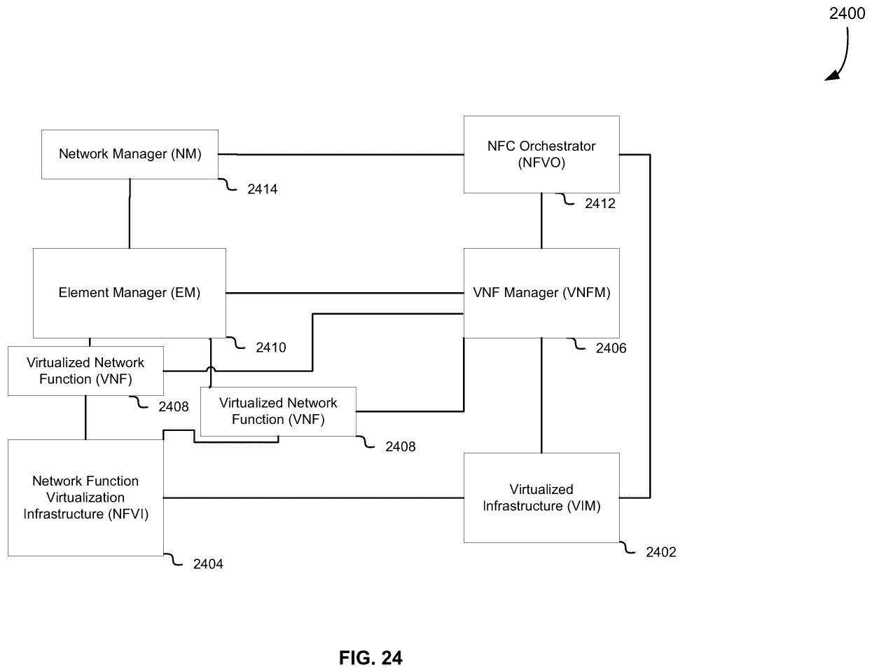

FIG. 23 illustrates components 2300 of a core network in accordance with at least one embodiment. In at least one embodiment, components of CN 1938 may be implemented in one physical node or separate physical nodes including components to read and execute instructions from a machine-readable or computer-readable medium (e.g., a non-transitory machine-readable storage medium). In at least one embodiment, Network Functions Virtualization (NFV) is utilized to virtualize any or all of above described network node functions via executable instructions stored in one or more computer readable storage mediums (described in further detail below). In at least one embodiment, a logical instantiation of CN 1938 may be referred to as a network slice 2302 (e.g., network slice 2302 is shown to include HSS 1932, MME(s) 1928, and S-GW 1930). In at least one embodiment, a logical instantiation of a portion of CN 1938 may be referred to as a network sub-slice 2304 (e.g., network sub-slice 2304 is shown to include P-GW 1934 and PCRF 1936).

In at least one embodiment, NFV architectures and infrastructures may be used to virtualize one or more network functions, alternatively performed by proprietary hardware, onto physical resources comprising a combination of industry-standard server hardware, storage hardware, or switches. In at least one embodiment, NFV systems can be used to execute virtual or reconfigurable implementations of one or more EPC components/functions.

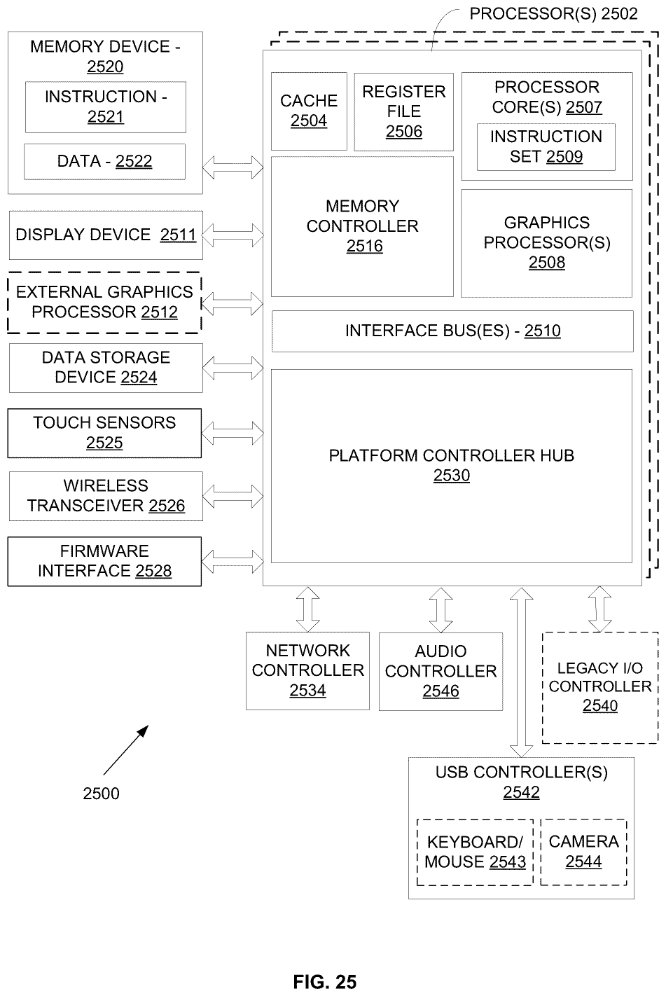

FIG. 24 is a block diagram illustrating components, according to at least one embodiment, of a system 2400 to support network function virtualization (NFV). In at least one embodiment, system 2400 is illustrated as including a virtualized infrastructure manager (shown as VIM 2402), a network function virtualization infrastructure (shown as NFVI 2404), a VNF manager (shown as VNFM 2406), virtualized network functions (shown as VNF 2408), an element manager (shown as EM 2410), an NFV Orchestrator (shown as NFVO 2412), and a network manager (shown as NM 2414).

In at least one embodiment, VIM 2402 manages resources of NFVI 2404. In at least one embodiment, NFVI 2404 can include physical or virtual resources and applications (including hypervisors) used to execute system 2400. In at least one embodiment, VIM 2402 may manage a life cycle of virtual resources with NFVI 2404 (e.g., creation, maintenance, and tear down of virtual machines (VMs) associated with one or more physical resources), track VM instances, track performance, fault and security of VM instances and associated physical resources, and expose VM instances and associated physical resources to other management systems.

In at least one embodiment, VNFM 2406 may manage VNF 2408. In at least one embodiment, VNF 2408 may be used to execute EPC components/functions. In at least one embodiment, VNFM 2406 may manage a life cycle of VNF 2408 and track performance, fault and security of virtual aspects of VNF 2408. In at least one embodiment, EM 2410 may track performance, fault and security of functional aspects of VNF 2408. In at least one embodiment, tracking data from VNFM 2406 and EM 2410 may comprise, for example, performance measurement (PM) data used by VIM 2402 or NFVI 2404. In at least one embodiment, both VNFM 2406 and EM 2410 can scale up/down a quantity of VNFs of system 2400.

In at least one embodiment, NFVO 2412 may coordinate, authorize, release and engage resources of NFVI 2404 in order to provide a requested service (e.g., to execute an EPC function, component, or slice). In at least one embodiment, NM 2414 may provide a package of end-user functions with responsibility for a management of a network, which may include network elements with VNFs, non-virtualized network functions, or both (management of VNFs may occur via an EM 2410).

### Computer-Based Systems

The following figures set forth, without limitation, exemplary computer-based systems that can be used to implement at least one embodiment.

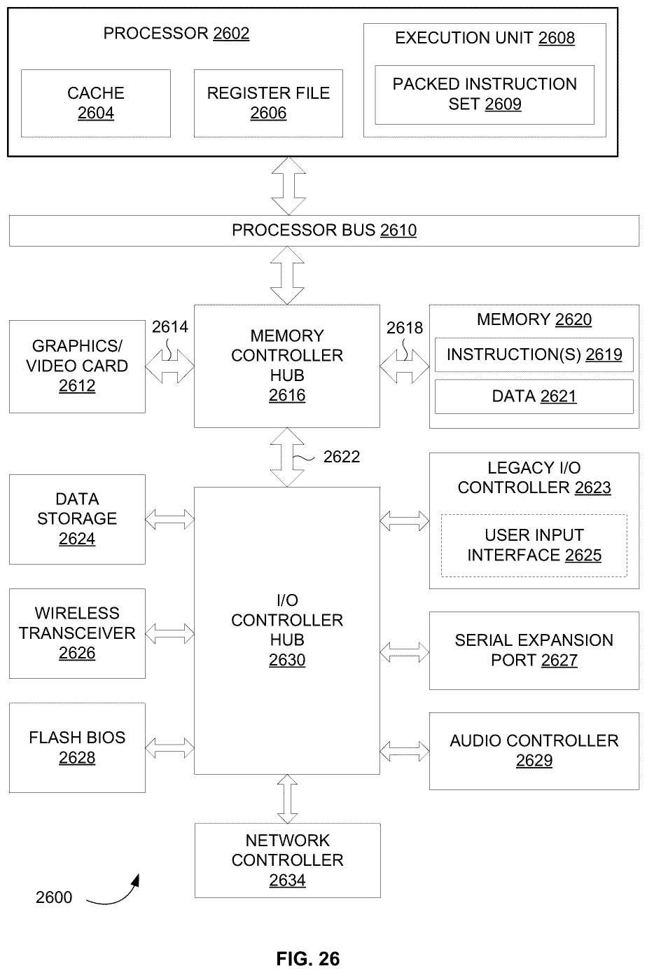

FIG. 25 illustrates a processing system 2500, in accordance with at least one embodiment. In at least one embodiment, processing system 2500 includes one or more processors 2502 and one or more graphics processors 2508, and may be a single processor desktop system, a multiprocessor workstation system, or a server system having a large number of processors 2502 or processor cores 2507. In at least one embodiment, processing system 2500 is a processing platform incorporated within a system-on-a-chip (“SoC”) integrated circuit for use in mobile, handheld, or embedded devices.

In at least one embodiment, processing system 2500 can include, or be incorporated within a server-based gaming platform, a game console, a media console, a mobile gaming console, a handheld game console, or an online game console. In at least one embodiment, processing system 2500 is a mobile phone, smart phone, tablet computing device or mobile Internet device. In at least one embodiment, processing system 2500 can also include, couple with, or be integrated within a wearable device, such as a smart watch wearable device, smart eyewear device, augmented reality device, or virtual reality device. In at least one embodiment, processing system 2500 is a television or set top box device having one or more processors 2502 and a graphical interface generated by one or more graphics processors 2508.

In at least one embodiment, one or more processors 2502 each include one or more processor cores 2507 to process instructions which, when executed, perform operations for system and user software. In at least one embodiment, each of one or more processor cores 2507 is configured to process a specific instruction set 2509. In at least one embodiment, instruction set 2509 may facilitate Complex Instruction Set Computing (“CISC”), Reduced Instruction Set Computing (“RISC”), or computing via a Very Long Instruction Word (“VLIW”). In at least one embodiment, processor cores 2507 may each process a different instruction set 2509, which may include instructions to facilitate emulation of other instruction sets. In at least one embodiment, processor core 2507 may also include other processing devices, such as a digital signal processor (“DSP”).

In at least one embodiment, processor 2502 includes cache memory (‘cache”) 2504. In at least one embodiment, processor 2502 can have a single internal cache or multiple levels of internal cache. In at least one embodiment, cache memory is shared among various components of processor 2502. In at least one embodiment, processor 2502 also uses an external cache (e.g., a Level 3 (“L3”) cache or Last Level Cache (“LLC”)) (not shown), which may be shared among processor cores 2507 using known cache coherency techniques. In at least one embodiment, register file 2506 is additionally included in processor 2502 which may include different types of registers for storing different types of data (e.g., integer registers, floating point registers, status registers, and an instruction pointer register). In at least one embodiment, register file 2506 may include general-purpose registers or other registers.

In at least one embodiment, one or more processor(s) 2502 are coupled with one or more interface bus(es) 2510 to transmit communication signals such as address, data, or control signals between processor 2502 and other components in processing system 2500. In at least one embodiment interface bus 2510, in one embodiment, can be a processor bus, such as a version of a Direct Media Interface (“DMI”) bus. In at least one embodiment, interface bus 2510 is not limited to a DMI bus, and may include one or more Peripheral Component Interconnect buses (e.g., “PCI,” PCI Express (“PCIe”)), memory buses, or other types of interface buses. In at least one embodiment processor(s) 2502 include an integrated memory controller 2516 and a platform controller hub 2530. In at least one embodiment, memory controller 2516 facilitates communication between a memory device and other components of processing system 2500, while platform controller hub (“PCH”) 2530 provides connections to Input/Output (“I/O”) devices via a local I/O bus.

In at least one embodiment, memory device 2520 can be a dynamic random access memory (“DRAM”) device, a static random access memory (“SRAM”) device, flash memory device, phase-change memory device, or some other memory device having suitable performance to serve as processor memory. In at least one embodiment memory device 2520 can operate as system memory for processing system 2500, to store data 2522 and instructions 2521 for use when one or more processors 2502 executes an application or process. In at least one embodiment, memory controller 2516 also couples with an optional external graphics processor 2512, which may communicate with one or more graphics processors 2508 in processors 2502 to perform graphics and media operations. In at least one embodiment, a display device 2511 can connect to processor(s) 2502. In at least one embodiment display device 2511 can include one or more of an internal display device, as in a mobile electronic device or a laptop device or an external display device attached via a display interface (e.g., DisplayPort, etc.). In at least one embodiment, display device 2511 can include a head mounted display (“HMD”) such as a stereoscopic display device for use in virtual reality (“VR”) applications or augmented reality (“AR”) applications.

In at least one embodiment, platform controller hub 2530 enables peripherals to connect to memory device 2520 and processor 2502 via a high-speed I/O bus. In at least one embodiment, I/O peripherals include, but are not limited to, an audio controller 2546, a network controller 2534, a firmware interface 2528, a wireless transceiver 2526, touch sensors 2525, a data storage device 2524 (e.g., hard disk drive, flash memory, etc.). In at least one embodiment, data storage device 2524 can connect via a storage interface (e.g., SATA) or via a peripheral bus, such as PCI, or PCIe. In at least one embodiment, touch sensors 2525 can include touch screen sensors, pressure sensors, or fingerprint sensors. In at least one embodiment, wireless transceiver 2526 can be a Wi-Fi transceiver, a Bluetooth transceiver, or a mobile network transceiver such as a 3G, 4G, or Long Term Evolution (“LTE”) transceiver. In at least one embodiment, firmware interface 2528 enables communication with system firmware, and can be, for example, a unified extensible firmware interface (“UEFI”). In at least one embodiment, network controller 2534 can enable a network connection to a wired network. In at least one embodiment, a high-performance network controller (not shown) couples with interface bus 2510. In at least one embodiment, audio controller 2546 is a multi-channel high definition audio controller. In at least one embodiment, processing system 2500 includes an optional legacy I/O controller 2540 for coupling legacy (e.g., Personal System 2 (“PS/2”)) devices to processing system 2500. In at least one embodiment, platform controller hub 2530 can also connect to one or more Universal Serial Bus (“USB”) controllers 2542 connect input devices, such as keyboard and mouse 2543 combinations, a camera 2544, or other USB input devices.

In at least one embodiment, an instance of memory controller 2516 and platform controller hub 2530 may be integrated into a discreet external graphics processor, such as external graphics processor 2512. In at least one embodiment, platform controller hub 2530 and/or memory controller 2516 may be external to one or more processor(s) 2502. For example, in at least one embodiment, processing system 2500 can include an external memory controller 2516 and platform controller hub 2530, which may be configured as a memory controller hub and peripheral controller hub within a system chipset that is in communication with processor(s) 2502.

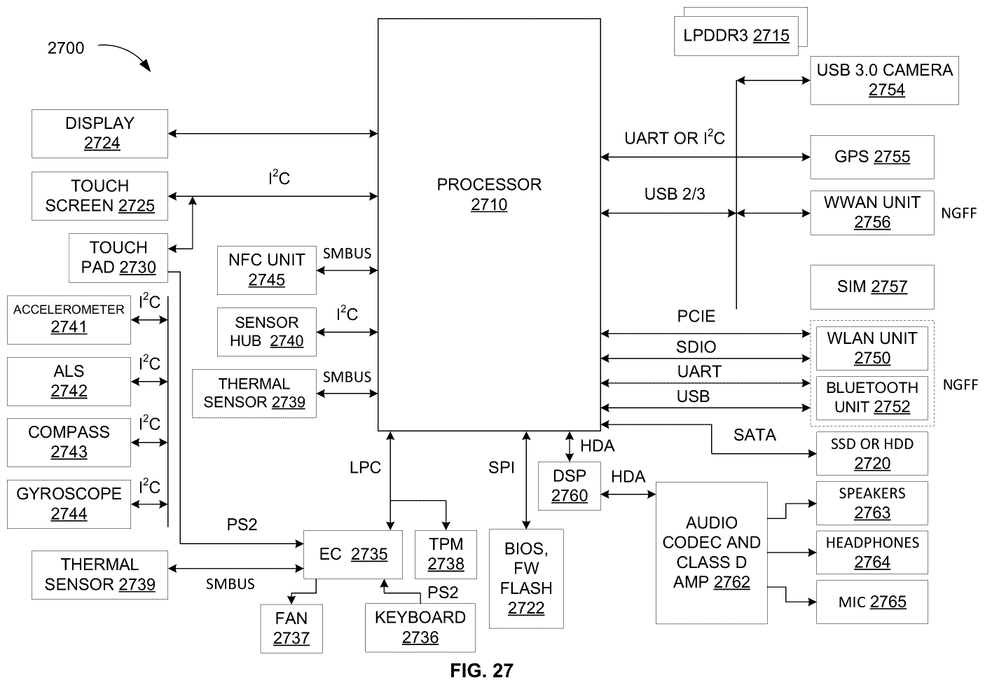

FIG. 26 illustrates a computer system 2600, in accordance with at least one embodiment. In at least one embodiment, computer system 2600 may be a system with interconnected devices and components, an SOC, or some combination. In at least on embodiment, computer system 2600 is formed with a processor 2602 that may include execution units to execute an instruction. In at least one embodiment, computer system 2600 may include, without limitation, a component, such as processor 2602 to employ execution units including logic to perform algorithms for processing data. In at least one embodiment, computer system 2600 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 2600 may execute a version of WINDOWS' operating system available from Microsoft Corporation of Redmond, Wash., although other operating systems (UNIX and Linux for example), embedded software, and/or graphical user interfaces, may also be used.

In at least one embodiment, computer system 2600 may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (DSP), an SoC, network computers (“NetPCs”), set-top boxes, network hubs, wide area network (“WAN”) switches, or any other system that may perform one or more instructions.

In at least one embodiment, computer system 2600 may include, without limitation, processor 2602 that may include, without limitation, one or more execution units 2608 that may be configured to execute a Compute Unified Device Architecture (“CUDA”) (CUDA® is developed by NVIDIA Corporation of Santa Clara, CA) program. In at least one embodiment, a CUDA program is at least a portion of a software application written in a CUDA programming language. In at least one embodiment, computer system 2600 is a single processor desktop or server system. In at least one embodiment, computer system 2600 may be a multiprocessor system. In at least one embodiment, processor 2602 may include, without limitation, a CISC microprocessor, a RISC microprocessor, a VLIW microprocessor, a processor implementing a combination of instruction sets, or any other processor device, such as a digital signal processor, for example. In at least one embodiment, processor 2602 may be coupled to a processor bus 2610 that may transmit data signals between processor 2602 and other components in computer system 2600.

In at least one embodiment, processor 2602 may include, without limitation, a Level 1 (“L1”) internal cache memory (“cache”) 2604. In at least one embodiment, processor 2602 may have a single internal cache or multiple levels of internal cache. In at least one embodiment, cache memory may reside external to processor 2602. In at least one embodiment, processor 2602 may also include a combination of both internal and external caches. In at least one embodiment, a register file 2606 may store different types of data in various registers including, without limitation, integer registers, floating point registers, status registers, and instruction pointer register.

In at least one embodiment, execution unit 2608, including, without limitation, logic to perform integer and floating point operations, also resides in processor 2602. Processor 2602 may also include a microcode (“ucode”) read only memory (“ROM”) that stores microcode for certain macro instructions. In at least one embodiment, execution unit 2608 may include logic to handle a packed instruction set 2609. In at least one embodiment, by including packed instruction set 2609 in an instruction set of a general-purpose processor 2602, along with associated circuitry to execute instructions, operations used by many multimedia applications may be performed using packed data in a general-purpose processor 2602. In at least one embodiment, many multimedia applications may be accelerated and executed more efficiently by using full width of a processor's data bus for performing operations on packed data, which may eliminate a need to transfer smaller units of data across a processor's data bus to perform one or more operations one data element at a time.

In at least one embodiment, execution unit 2608 may also be used in microcontrollers, embedded processors, graphics devices, DSPs, and other types of logic circuits. In at least one embodiment, computer system 2600 may include, without limitation, a memory 2620. In at least one embodiment, memory 2620 may be implemented as a DRAM device, an SRAM device, flash memory device, or other memory device. Memory 2620 may store instruction(s) 2619 and/or data 2621 represented by data signals that may be executed by processor 2602.

In at least one embodiment, a system logic chip may be coupled to processor bus 2610 and memory 2620. In at least one embodiment, a system logic chip may include, without limitation, a memory controller hub (“MCH”) 2616, and processor 2602 may communicate with MCH 2616 via processor bus 2610. In at least one embodiment, MCH 2616 may provide a high bandwidth memory path 2618 to memory 2620 for instruction and data storage and for storage of graphics commands, data and textures. In at least one embodiment, MCH 2616 may direct data signals between processor 2602, memory 2620, and other components in computer system 2600 and to bridge data signals between processor bus 2610, memory 2620, and a system I/O 2622. In at least one embodiment, system logic chip may provide a graphics port for coupling to a graphics controller. In at least one embodiment, MCH 2616 may be coupled to memory 2620 through high bandwidth memory path 2618 and graphics/video card 2612 may be coupled to MCH 2616 through an Accelerated Graphics Port (“AGP”) interconnect 2614.

In at least one embodiment, computer system 2600 may use system I/O 2622 that is a proprietary hub interface bus to couple MCH 2616 to I/O controller hub (“ICH”) 2630. In at least one embodiment, ICH 2630 may provide direct connections to some I/O devices via a local I/O bus. In at least one embodiment, local I/O bus may include, without limitation, a high-speed I/O bus for connecting peripherals to memory 2620, a chipset, and processor 2602. Examples may include, without limitation, an audio controller 2629, a firmware hub (“flash BIOS”) 2628, a wireless transceiver 2626, a data storage 2624, a legacy I/O controller 2623 containing a user input interface 2625 and a keyboard interface, a serial expansion port 2627, such as a USB, and a network controller 2634. Data storage 2624 may comprise a hard disk drive, a floppy disk drive, a CD-ROM device, a flash memory device, or other mass storage device.

In at least one embodiment, FIG. 26 illustrates a system, which includes interconnected hardware devices or “chips.” In at least one embodiment, FIG. 26 may illustrate an exemplary SoC. In at least one embodiment, devices illustrated in FIG. 26 may be interconnected with proprietary interconnects, standardized interconnects (e.g., PCIe), or some combination thereof. In at least one embodiment, one or more components of system 2600 are interconnected using compute express link (“CXL”) interconnects.

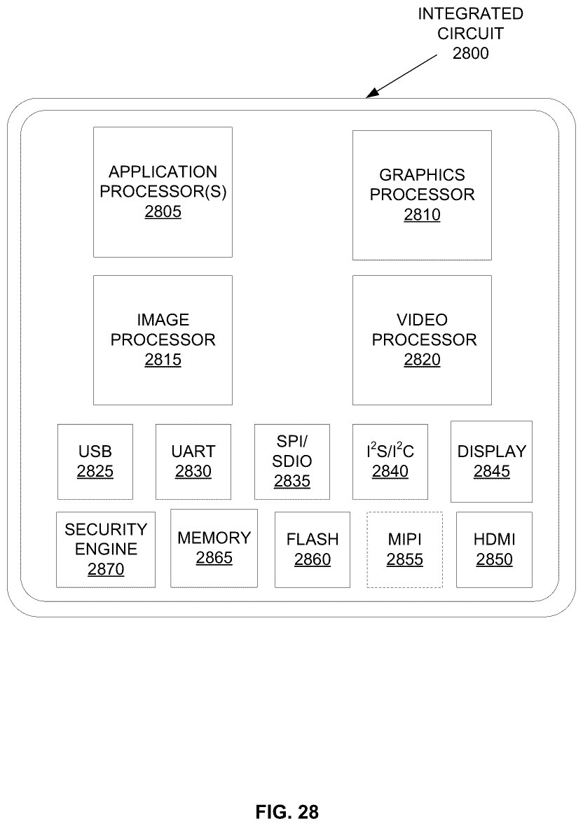

FIG. 27 illustrates a system 2700, in accordance with at least one embodiment. In at least one embodiment, system 2700 is an electronic device that utilizes a processor 2710. In at least one embodiment, system 2700 may be, for example and without limitation, a notebook, a tower server, a rack server, a blade server, a laptop, a desktop, a tablet, a mobile device, a phone, an embedded computer, or any other suitable electronic device.

In at least one embodiment, system 2700 may include, without limitation, processor 2710 communicatively coupled to any suitable number or kind of components, peripherals, modules, or devices. In at least one embodiment, processor 2710 is coupled using a bus or interface, such as an I2C bus, a System Management Bus (“SMBus”), a Low Pin Count (“LPC”) bus, a Serial Peripheral Interface (“SPI”), a High Definition Audio (“HDA”) bus, a Serial Advance Technology Attachment (“SATA”) bus, a USB (versions 1, 2, 3), or a Universal Asynchronous Receiver/Transmitter (“UART”) bus. In at least one embodiment, FIG. 27 illustrates a system which includes interconnected hardware devices or “chips.” In at least one embodiment, FIG. 27 may illustrate an exemplary SoC. In at least one embodiment, devices illustrated in FIG. 27 may be interconnected with proprietary interconnects, standardized interconnects (e.g., PCIe) or some combination thereof. In at least one embodiment, one or more components of FIG. 27 are interconnected using CXL interconnects.

In at least one embodiment, FIG. 27 may include a display 2724, a touch screen 2725, a touch pad 2730, a Near Field Communications unit (“NFC”) 2745, a sensor hub 2740, a thermal sensor 2746, an Express Chipset (“EC”) 2735, a Trusted Platform Module (“TPM”) 2738, BIOS/firmware/flash memory (“BIOS, FW Flash”) 2722, a DSP 2760, a Solid State Disk (“SSD”) or Hard Disk Drive (“HDD”) 2720, a wireless local area network unit (“WLAN”) 2750, a Bluetooth unit 2752, a Wireless Wide Area Network unit (“WWAN”) 2756, a Global Positioning System (“GPS”) 2755, a camera (“USB 3.0 camera”) 2754 such as a USB 3.0 camera, or a Low Power Double Data Rate (“LPDDR”) memory unit (“LPDDR3”) 2715 implemented in, for example, LPDDR3 standard. These components may each be implemented in any suitable manner.

In at least one embodiment, other components may be communicatively coupled to processor 2710 through components discussed above. In at least one embodiment, an accelerometer 2741, an Ambient Light Sensor (“ALS”) 2742, a compass 2743, and a gyroscope 2744 may be communicatively coupled to sensor hub 2740. In at least one embodiment, a thermal sensor 2739, a fan 2737, a keyboard 2746, and a touch pad 2730 may be communicatively coupled to EC 2735. In at least one embodiment, a speaker 2763, a headphones 2764, and a microphone (“mic”) 2765 may be communicatively coupled to an audio unit (“audio codec and class d amp”) 2764, which may in turn be communicatively coupled to DSP 2760. In at least one embodiment, audio unit 2764 may include, for example and without limitation, an audio coder/decoder (“codec”) and a class D amplifier. In at least one embodiment, a SIM card (“SIM”) 2757 may be communicatively coupled to WWAN unit 2756. In at least one embodiment, components such as WLAN unit 2750 and Bluetooth unit 2752, as well as WWAN unit 2756 may be implemented in a Next Generation Form Factor (“NGFF”).

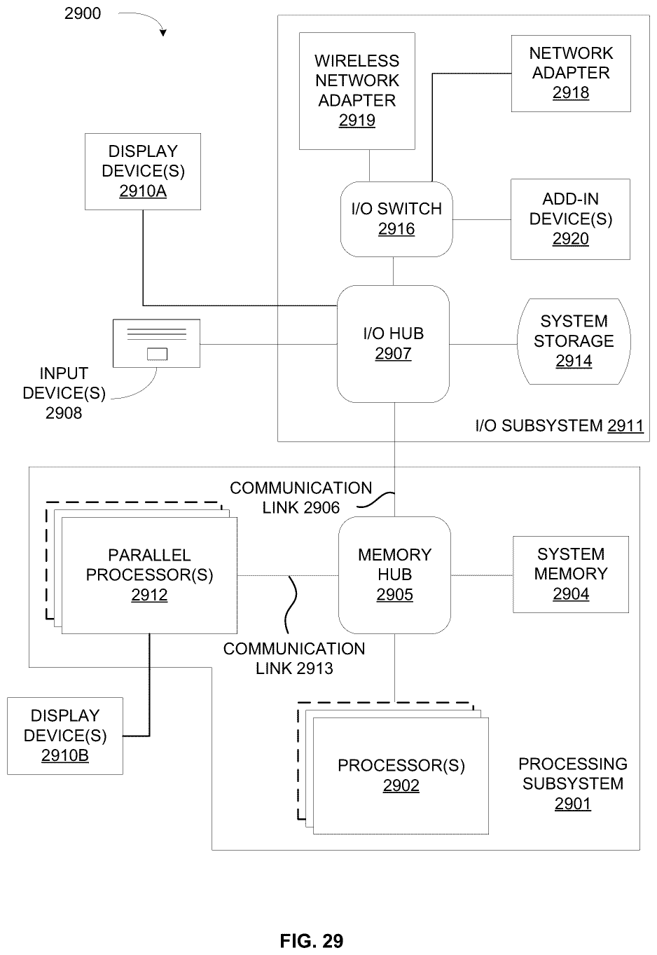

FIG. 28 illustrates an exemplary integrated circuit 2800, in accordance with at least one embodiment. In at least one embodiment, exemplary integrated circuit 2800 is an SoC that may be fabricated using one or more IP cores. In at least one embodiment, integrated circuit 2800 includes one or more application processor(s) 2805 (e.g., CPUs), at least one graphics processor 2810, and may additionally include an image processor 2815 and/or a video processor 2820, any of which may be a modular IP core. In at least one embodiment, integrated circuit 2800 includes peripheral or bus logic including a USB controller 2825, a UART controller 2830, an SPI/SDIO controller 2835, and an I2 S/I2C controller 2840. In at least one embodiment, integrated circuit 2800 can include a display device 2845 coupled to one or more of a high-definition multimedia interface (“HDMI”) controller 2850 and a mobile industry processor interface (“MIPI”) display interface 2855. In at least one embodiment, storage may be provided by a flash memory subsystem 2860 including flash memory and a flash memory controller. In at least one embodiment, a memory interface may be provided via a memory controller 2865 for access to SDRAM or SRAM memory devices. In at least one embodiment, some integrated circuits additionally include an embedded security engine 2870.

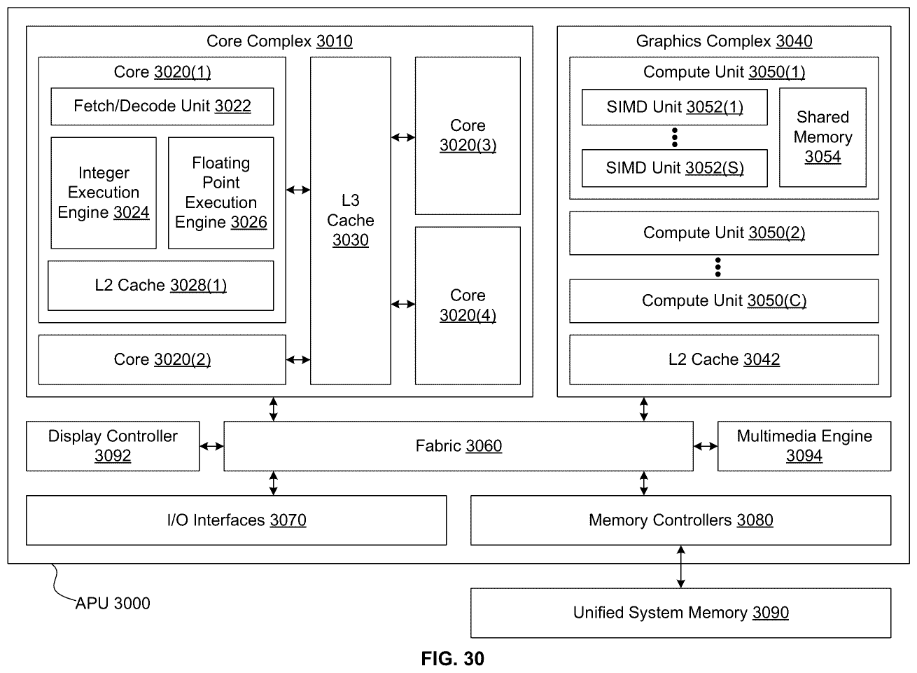

FIG. 29 illustrates a computing system 2900, according to at least one embodiment; In at least one embodiment, computing system 2900 includes a processing subsystem 2901 having one or more processor(s) 2902 and a system memory 2904 communicating via an interconnection path that may include a memory hub 2905. In at least one embodiment, memory hub 2905 may be a separate component within a chipset component or may be integrated within one or more processor(s) 2902. In at least one embodiment, memory hub 2905 couples with an I/O subsystem 2911 via a communication link 2906. In at least one embodiment, I/O subsystem 2911 includes an I/O hub 2907 that can enable computing system 2900 to receive input from one or more input device(s) 2908. In at least one embodiment, I/O hub 2907 can enable a display controller, which may be included in one or more processor(s) 2902, to provide outputs to one or more display device(s) 2910A. In at least one embodiment, one or more display device(s) 2910A coupled with I/O hub 2907 can include a local, internal, or embedded display device.

In at least one embodiment, processing subsystem 2901 includes one or more parallel processor(s) 2912 coupled to memory hub 2905 via a bus or other communication link 2913. In at least one embodiment, communication link 2913 may be one of any number of standards based communication link technologies or protocols, such as, but not limited to PCIe, or may be a vendor specific communications interface or communications fabric. In at least one embodiment, one or more parallel processor(s) 2912 form a computationally focused parallel or vector processing system that can include a large number of processing cores and/or processing clusters, such as a many integrated core processor. In at least one embodiment, one or more parallel processor(s) 2912 form a graphics processing subsystem that can output pixels to one of one or more display device(s) 2910A coupled via I/O Hub 2907. In at least one embodiment, one or more parallel processor(s) 2912 can also include a display controller and display interface (not shown) to enable a direct connection to one or more display device(s) 2910B.

In at least one embodiment, a system storage unit 2914 can connect to I/O hub 2907 to provide a storage mechanism for computing system 2900. In at least one embodiment, an I/O switch 2916 can be used to provide an interface mechanism to enable connections between I/O hub 2907 and other components, such as a network adapter 2918 and/or wireless network adapter 2919 that may be integrated into a platform, and various other devices that can be added via one or more add-in device(s) 2920. In at least one embodiment, network adapter 2918 can be an Ethernet adapter or another wired network adapter. In at least one embodiment, wireless network adapter 2919 can include one or more of a Wi-Fi, Bluetooth, NFC, or other network device that includes one or more wireless radios.

In at least one embodiment, computing system 2900 can include other components not explicitly shown, including USB or other port connections, optical storage drives, video capture devices, and/or variations thereof, that may also be connected to I/O hub 2907. In at least one embodiment, communication paths interconnecting various components in FIG. 29 may be implemented using any suitable protocols, such as PCI based protocols (e.g., PCIe), or other bus or point-to-point communication interfaces and/or protocol(s), such as NVLink high-speed interconnect, or interconnect protocols.

In at least one embodiment, one or more parallel processor(s) 2912 incorporate circuitry optimized for graphics and video processing, including, for example, video output circuitry, and constitutes a graphics processing unit (“GPU”). In at least one embodiment, one or more parallel processor(s) 2912 incorporate circuitry optimized for general purpose processing. In at least embodiment, components of computing system 2900 may be integrated with one or more other system elements on a single integrated circuit. For example, in at least one embodiment, one or more parallel processor(s) 2912, memory hub 2905, processor(s) 2902, and I/O hub 2907 can be integrated into a SoC integrated circuit. In at least one embodiment, components of computing system 2900 can be integrated into a single package to form a system in package (“SIP”) configuration. In at least one embodiment, at least a portion of components of computing system 2900 can be integrated into a multi-chip module (“MCM”), which can be interconnected with other multi-chip modules into a modular computing system. In at least one embodiment, I/O subsystem 2911 and display devices 2910B are omitted from computing system 2900.

### Processing Systems

The following figures set forth, without limitation, exemplary processing systems that can be used to implement at least one embodiment.

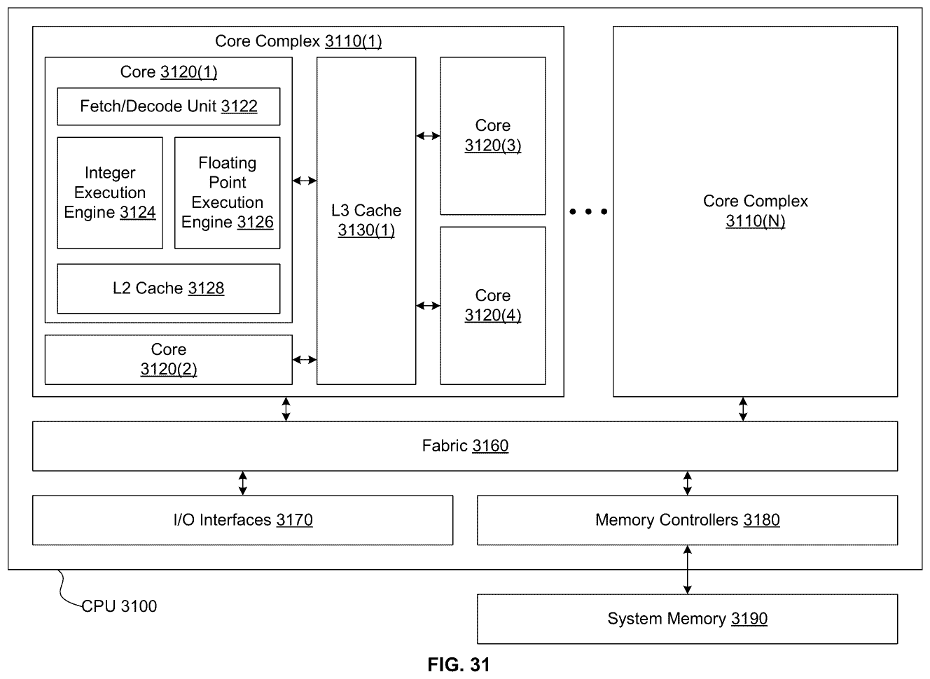

FIG. 30 illustrates an accelerated processing unit (“APU”) 3000, in accordance with at least one embodiment. In at least one embodiment, APU 3000 is developed by AMD Corporation of Santa Clara, CA. In at least one embodiment, APU 3000 can be configured to execute an application program, such as a CUDA program. In at least one embodiment, APU 3000 includes, without limitation, a core complex 3010, a graphics complex 3040, fabric 3060, I/O interfaces 3070, memory controllers 3080, a display controller 3092, and a multimedia engine 3094. In at least one embodiment, APU 3000 may include, without limitation, any number of core complexes 3010, any number of graphics complexes 3040, any number of display controllers 3092, and any number of multimedia engines 3094 in any combination. For explanatory purposes, multiple instances of like objects are denoted herein with reference numbers identifying an object and parenthetical numbers identifying an instance where needed.

In at least one embodiment, core complex 3010 is a CPU, graphics complex 3040 is a GPU, and APU 3000 is a processing unit that integrates, without limitation, 3010 and 3040 onto a single chip. In at least one embodiment, some tasks may be assigned to core complex 3010 and other tasks may be assigned to graphics complex 3040. In at least one embodiment, core complex 3010 is configured to execute main control software associated with APU 3000, such as an operating system. In at least one embodiment, core complex 3010 is a master processor of APU 3000, controlling and coordinating operations of other processors. In at least one embodiment, core complex 3010 issues commands that control an operation of graphics complex 3040. In at least one embodiment, core complex 3010 can be configured to execute host executable code derived from CUDA source code, and graphics complex 3040 can be configured to execute device executable code derived from CUDA source code.

In at least one embodiment, core complex 3010 includes, without limitation, cores 3020(1)-3020(4) and an L3 cache 3030. In at least one embodiment, core complex 3010 may include, without limitation, any number of cores 3020 and any number and type of caches in any combination. In at least one embodiment, cores 3020 are configured to execute instructions of a particular instruction set architecture (“ISA”). In at least one embodiment, each core 3020 is a CPU core.

In at least one embodiment, each core 3020 includes, without limitation, a fetch/decode unit 3022, an integer execution engine 3024, a floating point execution engine 3026, and an L2 cache 3028. In at least one embodiment, fetch/decode unit 3022 fetches instructions, decodes such instructions, generates micro-operations, and dispatches separate micro-instructions to integer execution engine 3024 and floating point execution engine 3026. In at least one embodiment, fetch/decode unit 3022 can concurrently dispatch one micro-instruction to integer execution engine 3024 and another micro-instruction to floating point execution engine 3026. In at least one embodiment, integer execution engine 3024 executes, without limitation, integer and memory operations. In at least one embodiment, floating point engine 3026 executes, without limitation, floating point and vector operations. In at least one embodiment, fetch-decode unit 3022 dispatches micro-instructions to a single execution engine that replaces both integer execution engine 3024 and floating point execution engine 3026.

In at least one embodiment, each core 3020(i), where i is an integer representing a particular instance of core 3020, may access L2 cache 3028(i) included in core 3020(i). In at least one embodiment, each core 3020 included in core complex 3010(j), where j is an integer representing a particular instance of core complex 3010, is connected to other cores 3020 included in core complex 3010(j) via L3 cache 3030(j) included in core complex 3010(j). In at least one embodiment, cores 3020 included in core complex 3010(j), where j is an integer representing a particular instance of core complex 3010, can access all of L3 cache 3030(j) included in core complex 3010(j). In at least one embodiment, L3 cache 3030 may include, without limitation, any number of slices.

In at least one embodiment, graphics complex 3040 can be configured to perform compute operations in a highly-parallel fashion. In at least one embodiment, graphics complex 3040 is configured to execute graphics pipeline operations such as draw commands, pixel operations, geometric computations, and other operations associated with rendering an image to a display. In at least one embodiment, graphics complex 3040 is configured to execute operations unrelated to graphics. In at least one embodiment, graphics complex 3040 is configured to execute both operations related to graphics and operations unrelated to graphics.

In at least one embodiment, graphics complex 3040 includes, without limitation, any number of compute units 3050 and an L2 cache 3042. In at least one embodiment, compute units 3050 share L2 cache 3042. In at least one embodiment, L2 cache 3042 is partitioned. In at least one embodiment, graphics complex 3040 includes, without limitation, any number of compute units 3050 and any number (including zero) and type of caches. In at least one embodiment, graphics complex 3040 includes, without limitation, any amount of dedicated graphics hardware.

In at least one embodiment, each compute unit 3050 includes, without limitation, any number of SIMD units 3052 and a shared memory 3054. In at least one embodiment, each SIMD unit 3052 implements a SIMD architecture and is configured to perform operations in parallel. In at least one embodiment, each compute unit 3050 may execute any number of thread blocks, but each thread block executes on a single compute unit 3050. In at least one embodiment, a thread block includes, without limitation, any number of threads of execution. In at least one embodiment, a workgroup is a thread block. In at least one embodiment, each SIMD unit 3052 executes a different warp. In at least one embodiment, a warp is a group of threads (e.g., 16 threads), where each thread in a warp belongs to a single thread block and is configured to process a different set of data based on a single set of instructions. In at least one embodiment, predication can be used to disable one or more threads in a warp. In at least one embodiment, a lane is a thread. In at least one embodiment, a work item is a thread. In at least one embodiment, a wavefront is a warp. In at least one embodiment, different wavefronts in a thread block may synchronize together and communicate via shared memory 3054.

In at least one embodiment, fabric 3060 is a system interconnect that facilitates data and control transmissions across core complex 3010, graphics complex 3040, I/O interfaces 3070, memory controllers 3080, display controller 3092, and multimedia engine 3094. In at least one embodiment, APU 3000 may include, without limitation, any amount and type of system interconnect in addition to or instead of fabric 3060 that facilitates data and control transmissions across any number and type of directly or indirectly linked components that may be internal or external to APU 3000. In at least one embodiment, I/O interfaces 3070 are representative of any number and type of I/O interfaces (e.g., PCI, PCI-Extended (“PCI-X”), PCIe, gigabit Ethernet (“GBE”), USB, etc.). In at least one embodiment, various types of peripheral devices are coupled to I/O interfaces 3070 In at least one embodiment, peripheral devices that are coupled to I/O interfaces 3070 may include, without limitation, keyboards, mice, printers, scanners, joysticks or other types of game controllers, media recording devices, external storage devices, network interface cards, and so forth.

In at least one embodiment, display controller AMD92 displays images on one or more display device(s), such as a liquid crystal display (“LCD”) device. In at least one embodiment, multimedia engine 3094 includes, without limitation, any amount and type of circuitry that is related to multimedia, such as a video decoder, a video encoder, an image signal processor, etc. In at least one embodiment, memory controllers 3080 facilitate data transfers between APU 3000 and a unified system memory 3090. In at least one embodiment, core complex 3010 and graphics complex 3040 share unified system memory 3090.

In at least one embodiment, APU 3000 implements a memory subsystem that includes, without limitation, any amount and type of memory controllers 3080 and memory devices (e.g., shared memory 3054) that may be dedicated to one component or shared among multiple components. In at least one embodiment, APU 3000 implements a cache subsystem that includes, without limitation, one or more cache memories (e.g., L2 caches 3128, L3 cache 3030, and L2 cache 3042) that may each be private to or shared between any number of components (e.g., cores 3020, core complex 3010, SIMD units 3052, compute units 3050, and graphics complex 3040).

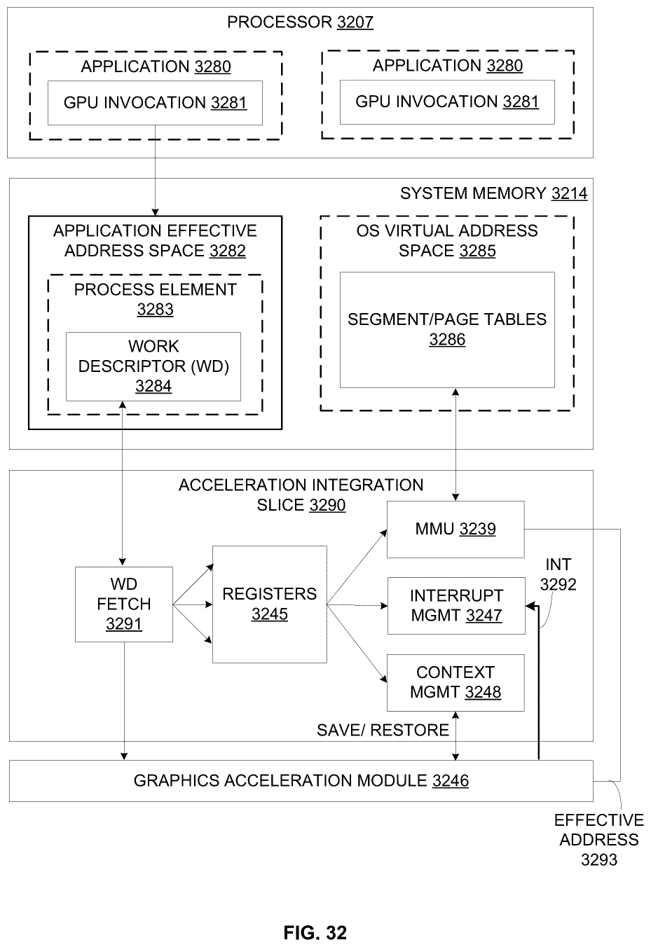

FIG. 31 illustrates a CPU 3100, in accordance with at least one embodiment. In at least one embodiment, CPU 3100 is developed by AMD Corporation of Santa Clara, CA. In at least one embodiment, CPU 3100 can be configured to execute an application program. In at least one embodiment, CPU 3100 is configured to execute main control software, such as an operating system. In at least one embodiment, CPU 3100 issues commands that control an operation of an external GPU (not shown). In at least one embodiment, CPU 3100 can be configured to execute host executable code derived from CUDA source code, and an external GPU can be configured to execute device executable code derived from such CUDA source code. In at least one embodiment, CPU 3100 includes, without limitation, any number of core complexes 3110, fabric 3160, I/O interfaces 3170, and memory controllers 3180.

In at least one embodiment, core complex 3110 includes, without limitation, cores 3120(1)-3120(4) and an L3 cache 3130. In at least one embodiment, core complex 3110 may include, without limitation, any number of cores 3120 and any number and type of caches in any combination. In at least one embodiment, cores 3120 are configured to execute instructions of a particular ISA. In at least one embodiment, each core 3120 is a CPU core.

In at least one embodiment, each core 3120 includes, without limitation, a fetch/decode unit 3122, an integer execution engine 3124, a floating point execution engine 3126, and an L2 cache 3128. In at least one embodiment, fetch/decode unit 3122 fetches instructions, decodes such instructions, generates micro-operations, and dispatches separate micro-instructions to integer execution engine 3124 and floating point execution engine 3126. In at least one embodiment, fetch/decode unit 3122 can concurrently dispatch one micro-instruction to integer execution engine 3124 and another micro-instruction to floating point execution engine 3126. In at least one embodiment, integer execution engine 3124 executes, without limitation, integer and memory operations. In at least one embodiment, floating point engine 3126 executes, without limitation, floating point and vector operations. In at least one embodiment, fetch-decode unit 3122 dispatches micro-instructions to a single execution engine that replaces both integer execution engine 3124 and floating point execution engine 3126.

In at least one embodiment, each core 3120(i), where i is an integer representing a particular instance of core 3120, may access L2 cache 3128(i) included in core 3120(i). In at least one embodiment, each core 3120 included in core complex 3110(j), where j is an integer representing a particular instance of core complex 3110, is connected to other cores 3120 in core complex 3110(j) via L3 cache 3130(j) included in core complex 3110(j). In at least one embodiment, cores 3120 included in core complex 3110(j), where j is an integer representing a particular instance of core complex 3110, can access all of L3 cache 3130(j) included in core complex 3110(j). In at least one embodiment, L3 cache 3130 may include, without limitation, any number of slices.

In at least one embodiment, fabric 3160 is a system interconnect that facilitates data and control transmissions across core complexes 3110(1)-3110(N) (where N is an integer greater than zero), I/O interfaces 3170, and memory controllers 3180. In at least one embodiment, CPU 3100 may include, without limitation, any amount and type of system interconnect in addition to or instead of fabric 3160 that facilitates data and control transmissions across any number and type of directly or indirectly linked components that may be internal or external to CPU 3100. In at least one embodiment, I/O interfaces 3170 are representative of any number and type of I/O interfaces (e.g., PCI, PCI-X, PCIe, GBE, USB, etc.). In at least one embodiment, various types of peripheral devices are coupled to I/O interfaces 3170 In at least one embodiment, peripheral devices that are coupled to I/O interfaces 3170 may include, without limitation, displays, keyboards, mice, printers, scanners, joysticks or other types of game controllers, media recording devices, external storage devices, network interface cards, and so forth.

In at least one embodiment, memory controllers 3180 facilitate data transfers between CPU 3100 and a system memory 3190. In at least one embodiment, core complex 3110 and graphics complex 3140 share system memory 3190. In at least one embodiment, CPU 3100 implements a memory subsystem that includes, without limitation, any amount and type of memory controllers 3180 and memory devices that may be dedicated to one component or shared among multiple components. In at least one embodiment, CPU 3100 implements a cache subsystem that includes, without limitation, one or more cache memories (e.g., L2 caches 3128 and L3 caches 3130) that may each be private to or shared between any number of components (e.g., cores 3120 and core complexes 3110).

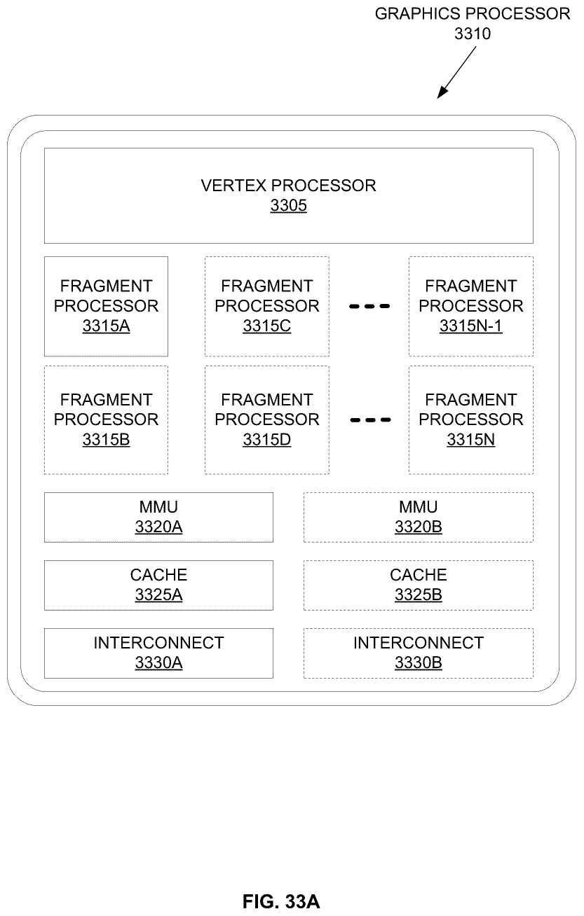

FIG. 32 illustrates an exemplary accelerator integration slice 3290, in accordance with at least one embodiment. As used herein, a “slice” comprises a specified portion of processing resources of an accelerator integration circuit. In at least one embodiment, an accelerator integration circuit provides cache management, memory access, context management, and interrupt management services on behalf of multiple graphics processing engines included in a graphics acceleration module. Graphics processing engines may each comprise a separate GPU. Alternatively, graphics processing engines may comprise different types of graphics processing engines within a GPU such as graphics execution units, media processing engines (e.g., video encoders/decoders), samplers, and blit engines. In at least one embodiment, a graphics acceleration module may be a GPU with multiple graphics processing engines. In at least one embodiment, graphics processing engines may be individual GPUs integrated on a common package, line card, or chip.

An application effective address space 3282 within system memory 3214 stores process elements 3283. In one embodiment, process elements 3283 are stored in response to GPU invocations 3281 from applications 3280 executed on processor 3207. A process element 3283 contains process state for corresponding application 3280. A work descriptor (“WD”) 3284 contained in process element 3283 can be a single job requested by an application or may contain a pointer to a queue of jobs. In at least one embodiment, WD 3284 is a pointer to a job request queue in application effective address space 3282.

Graphics acceleration module 3246 and/or individual graphics processing engines can be shared by all or a subset of processes in a system. In at least one embodiment, an infrastructure for setting up process state and sending WD 3284 to graphics acceleration module 3246 to start a job in a virtualized environment may be included.

In at least one embodiment, a dedicated-process programming model is implementation-specific. In this model, a single process owns graphics acceleration module 3246 or an individual graphics processing engine. Because graphics acceleration module 3246 is owned by a single process, a hypervisor initializes an accelerator integration circuit for an owning partition and an operating system initializes accelerator integration circuit for an owning process when graphics acceleration module 3246 is assigned.

In operation, a WD fetch unit 3291 in accelerator integration slice 3290 fetches next WD 3284 which includes an indication of work to be done by one or more graphics processing engines of graphics acceleration module 3246. Data from WD 3284 may be stored in registers 3245 and used by a memory management unit (“MMU”) 3239, interrupt management circuit 3247 and/or context management circuit 3248 as illustrated. For example, one embodiment of MMU 3239 includes segment/page walk circuitry for accessing segment/page tables 3286 within OS virtual address space 3285. Interrupt management circuit 3247 may process interrupt events (“INT”) 3292 received from graphics acceleration module 3246. When performing graphics operations, an effective address 3293 generated by a graphics processing engine is translated to a real address by MMU 3239.

In one embodiment, a same set of registers 3245 are duplicated for each graphics processing engine and/or graphics acceleration module 3246 and may be initialized by a hypervisor or operating system. Each of these duplicated registers may be included in accelerator integration slice 3290. Exemplary registers that may be initialized by a hypervisor are shown in Table 1.

TABLE 1
Hypervisor Initialized Registers

| | |
|---|---|
| 1 | Slice Control Register |
| 2 | Real Address (RA) Scheduled Processes Area Pointer |
| 3 | Authority Mask Override Register |
| 4 | Interrupt Vector Table Entry Offset |
| 5 | Interrupt Vector Table Entry Limit |
| 6 | State Register |
| 7 | Logical Partition ID |
| 8 | Real address (RA) Hypervisor Accelerator Utilization Record Pointer |
| 9 | Storage Description Register |

Exemplary registers that may be initialized by an operating system are shown in Table 2.

TABLE 2
Operating System Initialized Registers

| | |
|---|---|
| 1 | Process and Thread Identification |
| 2 | Effective Address (EA) Context Save/Restore Pointer |
| 3 | Virtual Address (VA) Accelerator Utilization Record Pointer |
| 4 | Virtual Address (VA) Storage Segment Table Pointer |
| 5 | Authority Mask |
| 6 | Work descriptor |

In one embodiment, each WD 3284 is specific to a particular graphics acceleration module 3246 and/or a particular graphics processing engine. It contains all information required by a graphics processing engine to do work or it can be a pointer to a memory location where an application has set up a command queue of work to be completed.

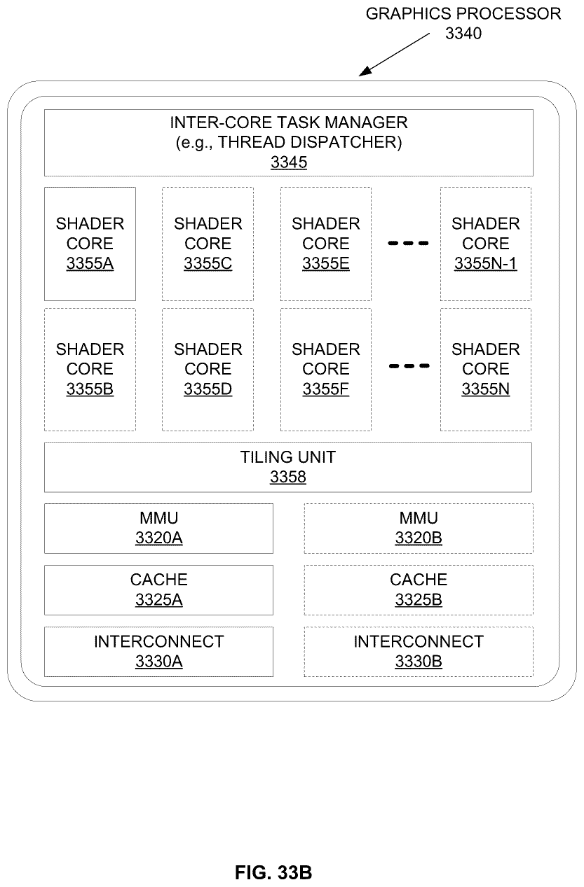

FIGS. 33A-33B illustrate exemplary graphics processors, in accordance with at least one embodiment. In at least one embodiment, any of the exemplary graphics processors may be fabricated using one or more IP cores. In addition to what is illustrated, other logic and circuits may be included in at least one embodiment, including additional graphics processors/cores, peripheral interface controllers, or general-purpose processor cores. In at least one embodiment, the exemplary graphics processors are for use within an SoC.

FIG. 33A illustrates an exemplary graphics processor 3310 of an SoC integrated circuit that may be fabricated using one or more IP cores, in accordance with at least one embodiment. FIG. 33B illustrates an additional exemplary graphics processor 3340 of an SoC integrated circuit that may be fabricated using one or more IP cores, in accordance with at least one embodiment. In at least one embodiment, graphics processor 3310 of FIG. 33A is a low power graphics processor core. In at least one embodiment, graphics processor 3340 of FIG. 33B is a higher performance graphics processor core. In at least one embodiment, each of graphics processors 3310, 3340 can be variants of graphics processor 910 of FIG. 9.

In at least one embodiment, graphics processor 3310 includes a vertex processor 3305 and one or more fragment processor(s) 3315A-3315N (e.g., 3315A, 3315B, 3315C, 3315D, through 3315N−1, and 3315N). In at least one embodiment, graphics processor 3310 can execute different shader programs via separate logic, such that vertex processor 3305 is optimized to execute operations for vertex shader programs, while one or more fragment processor(s) 3315A-3315N execute fragment (e.g., pixel) shading operations for fragment or pixel shader programs. In at least one embodiment, vertex processor 3305 performs a vertex processing stage of a 3D graphics pipeline and generates primitives and vertex data. In at least one embodiment, fragment processor(s) 3315A-3315N use primitive and vertex data generated by vertex processor 3305 to produce a framebuffer that is displayed on a display device. In at least one embodiment, fragment processor(s) 3315A-3315N are optimized to execute fragment shader programs as provided for in an OpenGL API, which may be used to perform similar operations as a pixel shader program as provided for in a Direct 3D API.

In at least one embodiment, graphics processor 3310 additionally includes one or more MMU(s) 3320A-3320B, cache(s) 3325A-3325B, and circuit interconnect(s) 3330A-3330B. In at least one embodiment, one or more MMU(s) 3320A-3320B provide for virtual to physical address mapping for graphics processor 3310, including for vertex processor 3305 and/or fragment processor(s) 3315A-3315N, which may reference vertex or image/texture data stored in memory, in addition to vertex or image/texture data stored in one or more cache(s) 3325A-3325B. In at least one embodiment, one or more MMU(s) 3320A-3320B may be synchronized with other MMUs within a system, including one or more MMUs associated with one or more application processor(s) 905, image processors 915, and/or video processors 920 of FIG. 9, such that each processor 905-920 can participate in a shared or unified virtual memory system. In at least one embodiment, one or more circuit interconnect(s) 3330A-3330B enable graphics processor 3310 to interface with other IP cores within an SoC, either via an internal bus of an SoC or via a direct connection.

In at least one embodiment, graphics processor 3340 includes one or more MMU(s) 3320A-3320B, caches 3325A-3325B, and circuit interconnects 3330A-3330B of graphics processor 3310 of FIG. 33A. In at least one embodiment, graphics processor 3340 includes one or more shader core(s) 3355A-3355N (e.g., 3355A, 3355B, 3355C, 3355D, 3355E, 3355F, through 3355N−1, and 3355N), which provides for a unified shader core architecture in which a single core or type or core can execute all types of programmable shader code, including shader program code to implement vertex shaders, fragment shaders, and/or compute shaders. In at least one embodiment, a number of shader cores can vary. In at least one embodiment, graphics processor 3340 includes an inter-core task manager 3345, which acts as a thread dispatcher to dispatch execution threads to one or more shader cores 3355A-3355N and a tiling unit 3358 to accelerate tiling operations for tile-based rendering, in which rendering operations for a scene are subdivided in image space, for example to exploit local spatial coherence within a scene or to optimize use of internal caches.

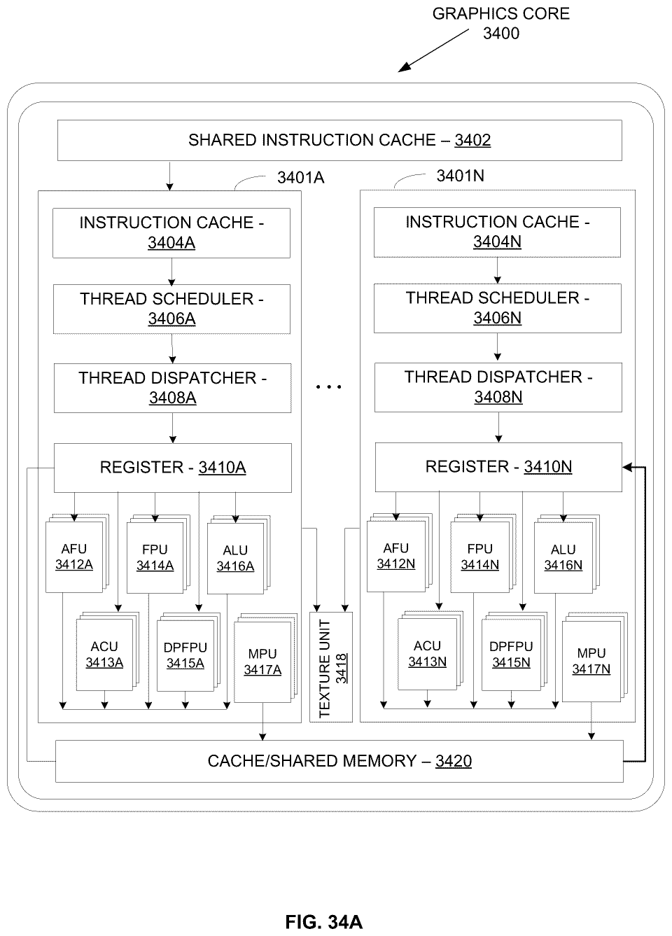

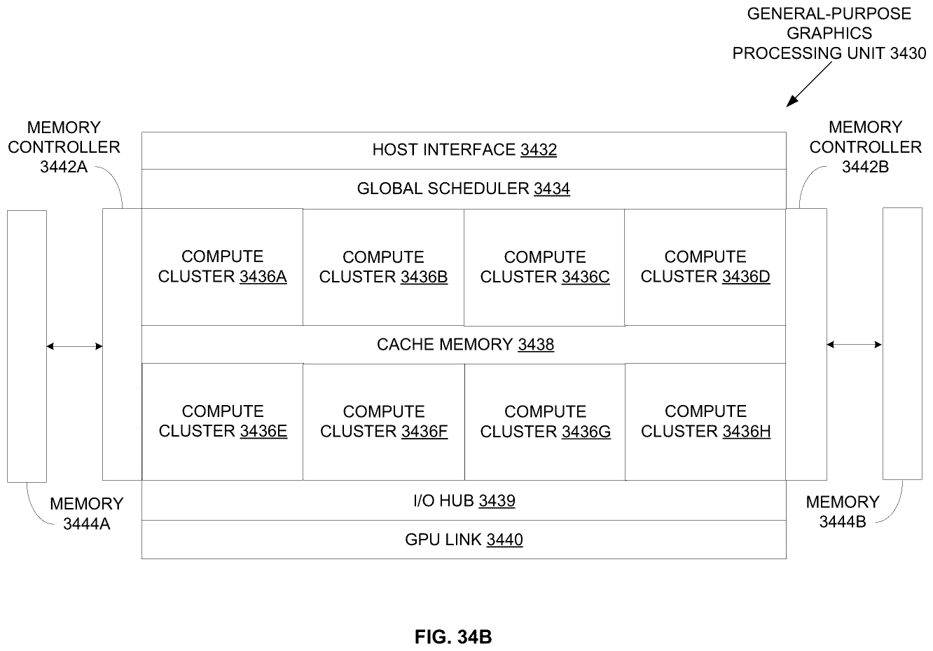

FIG. 34A illustrates a graphics core 3400, in accordance with at least one embodiment. In at least one embodiment, graphics core 3400 may be included within graphics processor 2810 of FIG. 28. In at least one embodiment, graphics core 3400 may be a unified shader core 3355A-3355N as in FIG. 33B. In at least one embodiment, graphics core 3400 includes a shared instruction cache 3402, a texture unit 3418, and a cache/shared memory 3420 that are common to execution resources within graphics core 3400. In at least one embodiment, graphics core 3400 can include multiple slices 3401A-3401N or partition for each core, and a graphics processor can include multiple instances of graphics core 3400. Slices 3401A-3401N can include support logic including a local instruction cache 3404A-3404N, a thread scheduler 3406A-3406N, a thread dispatcher 3408A-3408N, and a set of registers 3410A-3410N. In at least one embodiment, slices 3401A-3401N can include a set of additional function units (“AFUs”) 3412A-3412N, floating-point units (“FPUs”) 3414A-3414N, integer arithmetic logic units (“ALUs”) 3416-3416N, address computational units (“ACUs”) 3413A-3413N, double-precision floating-point units (“DPFPUs”) 3415A-3415N, and matrix processing units (“MPUs”) 3417A-3417N.

In at least one embodiment, FPUs 3414A-3414N can perform single-precision (32-bit) and half-precision (16-bit) floating point operations, while DPFPUs 3415A-3415N perform double precision (64-bit) floating point operations. In at least one embodiment, ALUs 3416A-3416N can perform variable precision integer operations at 8-bit, 16-bit, and 32-bit precision, and can be configured for mixed precision operations. In at least one embodiment, MPUs 3417A-3417N can also be configured for mixed precision matrix operations, including half-precision floating point and 8-bit integer operations. In at least one embodiment, MPUs 3417-3417N can perform a variety of matrix operations to accelerate CUDA programs, including enabling support for accelerated general matrix to matrix multiplication (“GEMM”). In at least one embodiment, AFUs 3412A-3412N can perform additional logic operations not supported by floating-point or integer units, including trigonometric operations (e.g., Sine, Cosine, etc.).

FIG. 34B illustrates a general-purpose graphics processing unit (“GPGPU”) 3430, in accordance with at least one embodiment. In at least one embodiment, GPGPU 3430 is highly-parallel and suitable for deployment on a multi-chip module. In at least one embodiment, GPGPU 3430 can be configured to enable highly-parallel compute operations to be performed by an array of GPUs. In at least one embodiment, GPGPU 3430 can be linked directly to other instances of GPGPU 3430 to create a multi-GPU cluster to improve execution time for CUDA programs. In at least one embodiment, GPGPU 3430 includes a host interface 3432 to enable a connection with a host processor. In at least one embodiment, host interface 3432 is a PCIe interface. In at least one embodiment, host interface 3432 can be a vendor specific communications interface or communications fabric. In at least one embodiment, GPGPU 3430 receives commands from a host processor and uses a global scheduler 3434 to distribute execution threads associated with those commands to a set of compute clusters 3436A-3436H. In at least one embodiment, compute clusters 3436A-3436H share a cache memory 3438. In at least one embodiment, cache memory 3438 can serve as a higher-level cache for cache memories within compute clusters 3436A-3436H.

In at least one embodiment, GPGPU 3430 includes memory 3444A-3444B coupled with compute clusters 3436A-3436H via a set of memory controllers 3442A-3442B. In at least one embodiment, memory 3444A-3444B can include various types of memory devices including DRAM or graphics random access memory, such as synchronous graphics random access memory (“SGRAM”), including graphics double data rate (“GDDR”) memory.

In at least one embodiment, compute clusters 3436A-3436H each include a set of graphics cores, such as graphics core 3400 of FIG. 34A, which can include multiple types of integer and floating point logic units that can perform computational operations at a range of precisions including suited for computations associated with CUDA programs. For example, in at least one embodiment, at least a subset of floating point units in each of compute clusters 3436A-3436H can be configured to perform 16-bit or 32-bit floating point operations, while a different subset of floating point units can be configured to perform 64-bit floating point operations.

In at least one embodiment, multiple instances of GPGPU 3430 can be configured to operate as a compute cluster. In at least one embodiment, compute clusters 3436A-3436H may implement any technically feasible communication techniques for synchronization and data exchange. In at least one embodiment, multiple instances of GPGPU 3430 communicate over host interface 3432. In at least one embodiment, GPGPU 3430 includes an I/O hub 3439 that couples GPGPU 3430 with a GPU link 3440 that enables a direct connection to other instances of GPGPU 3430. In at least one embodiment, GPU link 3440 is coupled to a dedicated GPU-to-GPU bridge that enables communication and synchronization between multiple instances of GPGPU 3430. In at least one embodiment GPU link 3440 couples with a high speed interconnect to transmit and receive data to other GPGPUs 3430 or parallel processors. In at least one embodiment, multiple instances of GPGPU 3430 are located in separate data processing systems and communicate via a network device that is accessible via host interface 3432. In at least one embodiment GPU link 3440 can be configured to enable a connection to a host processor in addition to or as an alternative to host interface 3432. In at least one embodiment, GPGPU 3430 can be configured to execute a CUDA program.

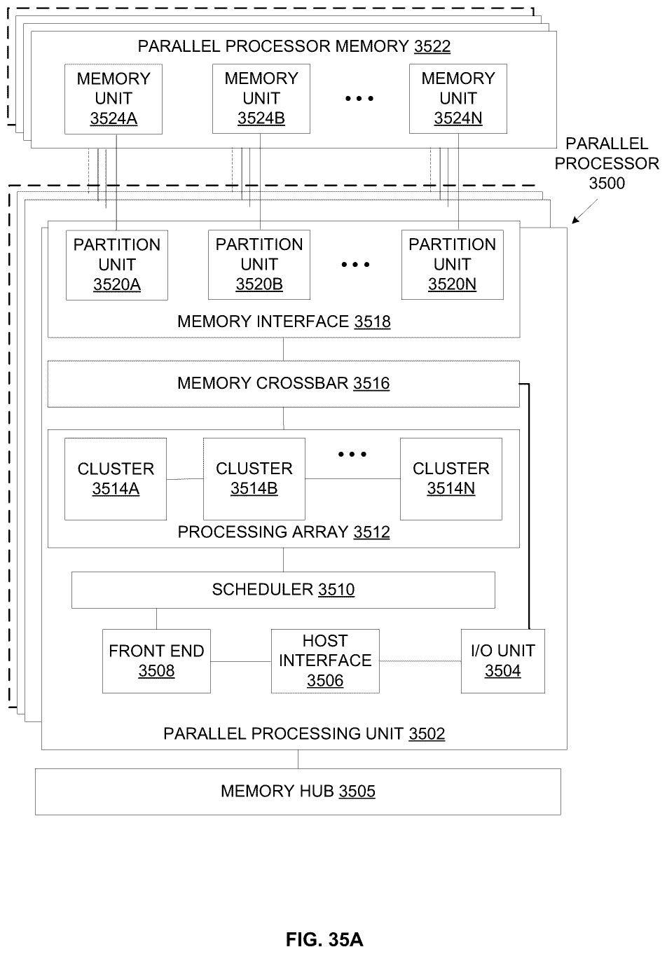

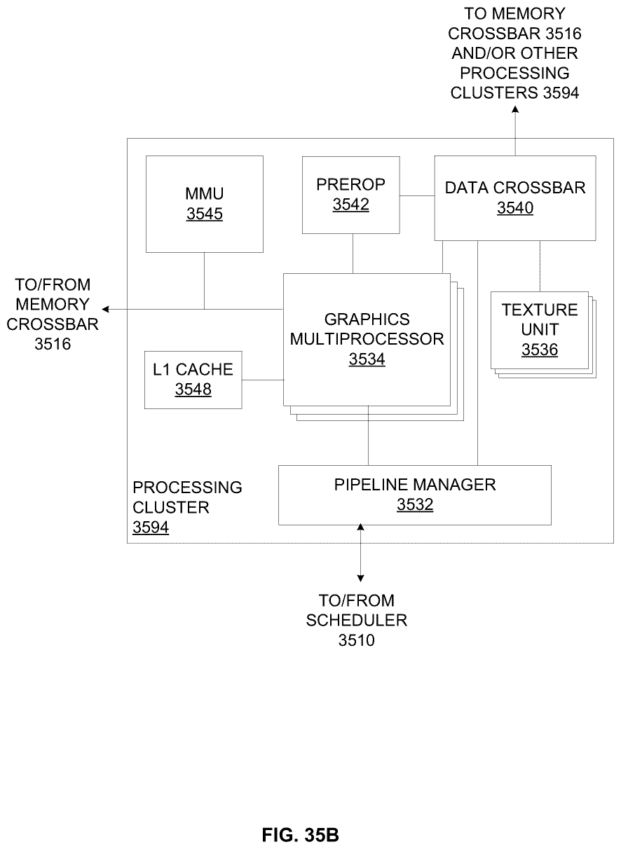

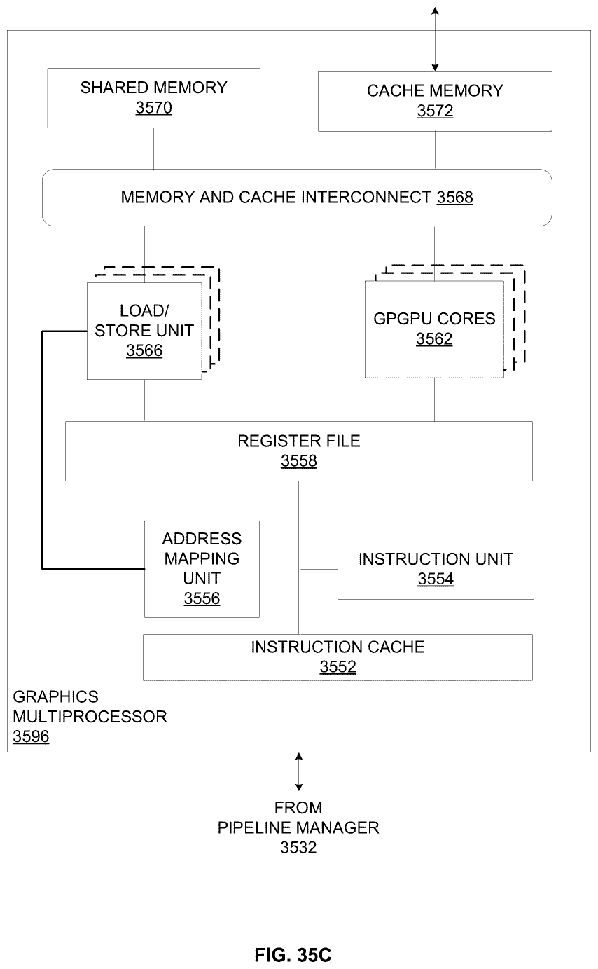

FIG. 35A illustrates a parallel processor 3500, in accordance with at least one embodiment. In at least one embodiment, various components of parallel processor 3500 may be implemented using one or more integrated circuit devices, such as programmable processors, application specific integrated circuits (“ASICs”), or FPGAs.

In at least one embodiment, parallel processor 3500 includes a parallel processing unit 3502. In at least one embodiment, parallel processing unit 3502 includes an I/O unit 3504 that enables communication with other devices, including other instances of parallel processing unit 3502. In at least one embodiment, I/O unit 3504 may be directly connected to other devices. In at least one embodiment, I/O unit 3504 connects with other devices via use of a hub or switch interface, such as memory hub 1005. In at least one embodiment, connections between memory hub 1005 and I/O unit 3504 form a communication link. In at least one embodiment, I/O unit 3504 connects with a host interface 3506 and a memory crossbar 3516, where host interface 3506 receives commands directed to performing processing operations and memory crossbar 3516 receives commands directed to performing memory operations.

In at least one embodiment, when host interface 3506 receives a command buffer via I/O unit 3504, host interface 3506 can direct work operations to perform those commands to a front end 3508. In at least one embodiment, front end 3508 couples with a scheduler 3510, which is configured to distribute commands or other work items to a processing array 3512. In at least one embodiment, scheduler 3510 ensures that processing array 3512 is properly configured and in a valid state before tasks are distributed to processing array 3512. In at least one embodiment, scheduler 3510 is implemented via firmware logic executing on a microcontroller. In at least one embodiment, microcontroller implemented scheduler 3510 is configurable to perform complex scheduling and work distribution operations at coarse and fine granularity, enabling rapid preemption and context switching of threads executing on processing array 3512. In at least one embodiment, host software can prove workloads for scheduling on processing array 3512 via one of multiple graphics processing doorbells. In at least one embodiment, workloads can then be automatically distributed across processing array 3512 by scheduler 3510 logic within a microcontroller including scheduler 3510.

In at least one embodiment, processing array 3512 can include up to “N” clusters (e.g., cluster 3514A, cluster 3514B, through cluster 3514N). In at least one embodiment, each cluster 3514A-3514N of processing array 3512 can execute a large number of concurrent threads. In at least one embodiment, scheduler 3510 can allocate work to clusters 3514A-3514N of processing array 3512 using various scheduling and/or work distribution algorithms, which may vary depending on a workload arising for each type of program or computation. In at least one embodiment, scheduling can be handled dynamically by scheduler 3510, or can be assisted in part by compiler logic during compilation of program logic configured for execution by processing array 3512. In at least one embodiment, different clusters 3514A-3514N of processing array 3512 can be allocated for processing different types of programs or for performing different types of computations.

In at least one embodiment, processing array 3512 can be configured to perform various types of parallel processing operations. In at least one embodiment, processing array 3512 is configured to perform general-purpose parallel compute operations. For example, in at least one embodiment, processing array 3512 can include logic to execute processing tasks including filtering of video and/or audio data, performing modeling operations, including physics operations, and performing data transformations.

In at least one embodiment, processing array 3512 is configured to perform parallel graphics processing operations. In at least one embodiment, processing array 3512 can include additional logic to support execution of such graphics processing operations, including, but not limited to texture sampling logic to perform texture operations, as well as tessellation logic and other vertex processing logic. In at least one embodiment, processing array 3512 can be configured to execute graphics processing related shader programs such as, but not limited to vertex shaders, tessellation shaders, geometry shaders, and pixel shaders. In at least one embodiment, parallel processing unit 3502 can transfer data from system memory via I/O unit 3504 for processing. In at least one embodiment, during processing, transferred data can be stored to on-chip memory (e.g., a parallel processor memory 3522) during processing, then written back to system memory.

In at least one embodiment, when parallel processing unit 3502 is used to perform graphics processing, scheduler 3510 can be configured to divide a processing workload into approximately equal sized tasks, to better enable distribution of graphics processing operations to multiple clusters 3514A-3514N of processing array 3512. In at least one embodiment, portions of processing array 3512 can be configured to perform different types of processing. For example, in at least one embodiment, a first portion may be configured to perform vertex shading and topology generation, a second portion may be configured to perform tessellation and geometry shading, and a third portion may be configured to perform pixel shading or other screen space operations, to produce a rendered image for display. In at least one embodiment, intermediate data produced by one or more of clusters 3514A-3514N may be stored in buffers to allow intermediate data to be transmitted between clusters 3514A-3514N for further processing.

In at least one embodiment, processing array 3512 can receive processing tasks to be executed via scheduler 3510, which receives commands defining processing tasks from front end 3508. In at least one embodiment, processing tasks can include indices of data to be processed, e.g., surface (patch) data, primitive data, vertex data, and/or pixel data, as well as state parameters and commands defining how data is to be processed (e.g., what program is to be executed). In at least one embodiment, scheduler 3510 may be configured to fetch indices corresponding to tasks or may receive indices from front end 3508. In at least one embodiment, front end 3508 can be configured to ensure processing array 3512 is configured to a valid state before a workload specified by incoming command buffers (e.g., batch-buffers, push buffers, etc.) is initiated.

In at least one embodiment, each of one or more instances of parallel processing unit 3502 can couple with parallel processor memory 3522. In at least one embodiment, parallel processor memory 3522 can be accessed via memory crossbar 3516, which can receive memory requests from processing array 3512 as well as I/O unit 3504. In at least one embodiment, memory crossbar 3516 can access parallel processor memory 3522 via a memory interface 3518. In at least one embodiment, memory interface 3518 can include multiple partition units (e.g., a partition unit 3520A, partition unit 3520B, through partition unit 3520N) that can each couple to a portion (e.g., memory unit) of parallel processor memory 3522. In at least one embodiment, a number of partition units 3520A-3520N is configured to be equal to a number of memory units, such that a first partition unit 3520A has a corresponding first memory unit 3524A, a second partition unit 3520B has a corresponding memory unit 3524B, and an Nth partition unit 3520N has a corresponding Nth memory unit 3524N. In at least one embodiment, a number of partition units 3520A-3520N may not be equal to a number of memory devices.

In at least one embodiment, memory units 3524A-3524N can include various types of memory devices, including DRAM or graphics random access memory, such as SGRAM, including GDDR memory. In at least one embodiment, memory units 3524A-3524N may also include 3D stacked memory, including but not limited to high bandwidth memory (“HBM”). In at least one embodiment, render targets, such as frame buffers or texture maps may be stored across memory units 3524A-3524N, allowing partition units 3520A-3520N to write portions of each render target in parallel to efficiently use available bandwidth of parallel processor memory 3522. In at least one embodiment, a local instance of parallel processor memory 3522 may be excluded in favor of a unified memory design that utilizes system memory in conjunction with local cache memory.

In at least one embodiment, any one of clusters 3514A-3514N of processing array 3512 can process data that will be written to any of memory units 3524A-3524N within parallel processor memory 3522. In at least one embodiment, memory crossbar 3516 can be configured to transfer an output of each cluster 3514A-3514N to any partition unit 3520A-3520N or to another cluster 3514A-3514N, which can perform additional processing operations on an output. In at least one embodiment, each cluster 3514A-3514N can communicate with memory interface 3518 through memory crossbar 3516 to read from or write to various external memory devices. In at least one embodiment, memory crossbar 3516 has a connection to memory interface 3518 to communicate with I/O unit 3504, as well as a connection to a local instance of parallel processor memory 3522, enabling processing units within different clusters 3514A-3514N to communicate with system memory or other memory that is not local to parallel processing unit 3502. In at least one embodiment, memory crossbar 3516 can use virtual channels to separate traffic streams between clusters 3514A-3514N and partition units 3520A-3520N.

In at least one embodiment, multiple instances of parallel processing unit 3502 can be provided on a single add-in card, or multiple add-in cards can be interconnected. In at least one embodiment, different instances of parallel processing unit 3502 can be configured to inter-operate even if different instances have different numbers of processing cores, different amounts of local parallel processor memory, and/or other configuration differences. For example, in at least one embodiment, some instances of parallel processing unit 3502 can include higher precision floating point units relative to other instances. In at least one embodiment, systems incorporating one or more instances of parallel processing unit 3502 or parallel processor 3500 can be implemented in a variety of configurations and form factors, including but not limited to desktop, laptop, or handheld personal computers, servers, workstations, game consoles, and/or embedded systems.

FIG. 35B illustrates a processing cluster 3594, in accordance with at least one embodiment. In at least one embodiment, processing cluster 3594 is included within a parallel processing unit. In at least one embodiment, processing cluster 3594 is one of processing clusters 3514A-3514N of FIG. 35. In at least one embodiment, processing cluster 3594 can be configured to execute many threads in parallel, where the term “thread” refers to an instance of a particular program executing on a particular set of input data. In at least one embodiment, single instruction, multiple data (“SIMD”) instruction issue techniques are used to support parallel execution of a large number of threads without providing multiple independent instruction units. In at least one embodiment, single instruction, multiple thread (“SIMT”) techniques are used to support parallel execution of a large number of generally synchronized threads, using a common instruction unit configured to issue instructions to a set of processing engines within each processing cluster 3594.

In at least one embodiment, operation of processing cluster 3594 can be controlled via a pipeline manager 3532 that distributes processing tasks to SIMT parallel processors. In at least one embodiment, pipeline manager 3532 receives instructions from scheduler 3510 of FIG. 35 and manages execution of those instructions via a graphics multiprocessor 3534 and/or a texture unit 3536. In at least one embodiment, graphics multiprocessor 3534 is an exemplary instance of a SIMT parallel processor. However, in at least one embodiment, various types of SIMT parallel processors of differing architectures may be included within processing cluster 3594. In at least one embodiment, one or more instances of graphics multiprocessor 3534 can be included within processing cluster 3594. In at least one embodiment, graphics multiprocessor 3534 can process data and a data crossbar 3540 can be used to distribute processed data to one of multiple possible destinations, including other shader units. In at least one embodiment, pipeline manager 3532 can facilitate distribution of processed data by specifying destinations for processed data to be distributed via data crossbar 3540.

In at least one embodiment, each graphics multiprocessor 3534 within processing cluster 3594 can include an identical set of functional execution logic (e.g., arithmetic logic units, load/store units (“LSUs”), etc.). In at least one embodiment, functional execution logic can be configured in a pipelined manner in which new instructions can be issued before previous instructions are complete. In at least one embodiment, functional execution logic supports a variety of operations including integer and floating point arithmetic, comparison operations, Boolean operations, bit-shifting, and computation of various algebraic functions. In at least one embodiment, same functional-unit hardware can be leveraged to perform different operations and any combination of functional units may be present.

In at least one embodiment, instructions transmitted to processing cluster 3594 constitute a thread. In at least one embodiment, a set of threads executing across a set of parallel processing engines is a thread group. In at least one embodiment, a thread group executes a program on different input data. In at least one embodiment, each thread within a thread group can be assigned to a different processing engine within graphics multiprocessor 3534. In at least one embodiment, a thread group may include fewer threads than a number of processing engines within graphics multiprocessor 3534. In at least one embodiment, when a thread group includes fewer threads than a number of processing engines, one or more of processing engines may be idle during cycles in which that thread group is being processed. In at least one embodiment, a thread group may also include more threads than a number of processing engines within graphics multiprocessor 3534. In at least one embodiment, when a thread group includes more threads than a number of processing engines within graphics multiprocessor 3534, processing can be performed over consecutive clock cycles. In at least one embodiment, multiple thread groups can be executed concurrently on graphics multiprocessor 3534.

In at least one embodiment, graphics multiprocessor 3534 includes an internal cache memory to perform load and store operations. In at least one embodiment, graphics multiprocessor 3534 can forego an internal cache and use a cache memory (e.g., L1 cache 3548) within processing cluster 3594. In at least one embodiment, each graphics multiprocessor 3534 also has access to Level 2 (“L2”) caches within partition units (e.g., partition units 3520A-3520N of FIG. 35A) that are shared among all processing clusters 3594 and may be used to transfer data between threads. In at least one embodiment, graphics multiprocessor 3534 may also access off-chip global memory, which can include one or more of local parallel processor memory and/or system memory. In at least one embodiment, any memory external to parallel processing unit 3502 may be used as global memory. In at least one embodiment, processing cluster 3594 includes multiple instances of graphics multiprocessor 3534 that can share common instructions and data, which may be stored in L1 cache 3548.

In at least one embodiment, each processing cluster 3594 may include an MMU 3545 that is configured to map virtual addresses into physical addresses. In at least one embodiment, one or more instances of MMU 3545 may reside within memory interface 3518 of FIG. 35. In at least one embodiment, MMU 3545 includes a set of page table entries (“PTEs”) used to map a virtual address to a physical address of a tile and optionally a cache line index. In at least one embodiment, MMU 3545 may include address translation lookaside buffers (“TLBs”) or caches that may reside within graphics multiprocessor 3534 or L1 cache 3548 or processing cluster 3594. In at least one embodiment, a physical address is processed to distribute surface data access locality to allow efficient request interleaving among partition units. In at least one embodiment, a cache line index may be used to determine whether a request for a cache line is a hit or miss.

In at least one embodiment, processing cluster 3594 may be configured such that each graphics multiprocessor 3534 is coupled to a texture unit 3536 for performing texture mapping operations, e.g., determining texture sample positions, reading texture data, and filtering texture data. In at least one embodiment, texture data is read from an internal texture L1 cache (not shown) or from an L1 cache within graphics multiprocessor 3534 and is fetched from an L2 cache, local parallel processor memory, or system memory, as needed. In at least one embodiment, each graphics multiprocessor 3534 outputs a processed task to data crossbar 3540 to provide a processed task to another processing cluster 3594 for further processing or to store a processed task in an L2 cache, a local parallel processor memory, or a system memory via memory crossbar 3516. In at least one embodiment, a pre-raster operations unit (“preROP”) 3542 is configured to receive data from graphics multiprocessor 3534, direct data to ROP units, which may be located with partition units as described herein (e.g., partition units 3520A-3520N of FIG. 35). In at least one embodiment, PreROP 3542 can perform optimizations for color blending, organize pixel color data, and perform address translations.

FIG. 35C illustrates a graphics multiprocessor 3596, in accordance with at least one embodiment. In at least one embodiment, graphics multiprocessor 3596 is graphics multiprocessor 3534 of FIG. 35B. In at least one embodiment, graphics multiprocessor 3596 couples with pipeline manager 3532 of processing cluster 3594. In at least one embodiment, graphics multiprocessor 3596 has an execution pipeline including but not limited to an instruction cache 3552, an instruction unit 3554, an address mapping unit 3556, a register file 3558, one or more GPGPU cores 3562, and one or more LSUs 3566. GPGPU cores 3562 and LSUs 3566 are coupled with cache memory 3572 and shared memory 3570 via a memory and cache interconnect 3568.

In at least one embodiment, instruction cache 3552 receives a stream of instructions to execute from pipeline manager 3532. In at least one embodiment, instructions are cached in instruction cache 3552 and dispatched for execution by instruction unit 3554. In at least one embodiment, instruction unit 3554 can dispatch instructions as thread groups (e.g., warps), with each thread of a thread group assigned to a different execution unit within GPGPU core 3562. In at least one embodiment, an instruction can access any of a local, shared, or global address space by specifying an address within a unified address space. In at least one embodiment, address mapping unit 3556 can be used to translate addresses in a unified address space into a distinct memory address that can be accessed by LSUs 3566.

In at least one embodiment, register file 3558 provides a set of registers for functional units of graphics multiprocessor 3596. In at least one embodiment, register file 3558 provides temporary storage for operands connected to data paths of functional units (e.g., GPGPU cores 3562, LSUs 3566) of graphics multiprocessor 3596. In at least one embodiment, register file 3558 is divided between each of functional units such that each functional unit is allocated a dedicated portion of register file 3558. In at least one embodiment, register file 3558 is divided between different thread groups being executed by graphics multiprocessor 3596.

In at least one embodiment, GPGPU cores 3562 can each include FPUs and/or integer ALUs that are used to execute instructions of graphics multiprocessor 3596. GPGPU cores 3562 can be similar in architecture or can differ in architecture. In at least one embodiment, a first portion of GPGPU cores 3562 include a single precision FPU and an integer ALU while a second portion of GPGPU cores 3562 include a double precision FPU. In at least one embodiment, FPUs can implement IEEE 754-2008 standard for floating point arithmetic or enable variable precision floating point arithmetic. In at least one embodiment, graphics multiprocessor 3596 can additionally include one or more fixed function or special function units to perform specific functions such as copy rectangle or pixel blending operations. In at least one embodiment one or more of GPGPU cores 3562 can also include fixed or special function logic.

In at least one embodiment, GPGPU cores 3562 include SIMD logic capable of performing a single instruction on multiple sets of data. In at least one embodiment GPGPU cores 3562 can physically execute SIMD4, SIMD8, and SIMD16 instructions and logically execute SIMD1, SIMD2, and SIMD32 instructions. In at least one embodiment, SIMD instructions for GPGPU cores 3562 can be generated at compile time by a shader compiler or automatically generated when executing programs written and compiled for single program multiple data (“SPMD”) or SIMT architectures. In at least one embodiment, multiple threads of a program configured for an SIMT execution model can executed via a single SIMD instruction. For example, in at least one embodiment, eight SIMT threads that perform the same or similar operations can be executed in parallel via a single SIMD8 logic unit.

In at least one embodiment, memory and cache interconnect 3568 is an interconnect network that connects each functional unit of graphics multiprocessor 3596 to register file 3558 and to shared memory 3570. In at least one embodiment, memory and cache interconnect 3568 is a crossbar interconnect that allows LSU 3566 to implement load and store operations between shared memory 3570 and register file 3558. In at least one embodiment, register file 3558 can operate at a same frequency as GPGPU cores 3562, thus data transfer between GPGPU cores 3562 and register file 3558 is very low latency. In at least one embodiment, shared memory 3570 can be used to enable communication between threads that execute on functional units within graphics multiprocessor 3596. In at least one embodiment, cache memory 3572 can be used as a data cache for example, to cache texture data communicated between functional units and texture unit 3536. In at least one embodiment, shared memory 3570 can also be used as a program managed cached. In at least one embodiment, threads executing on GPGPU cores 3562 can programmatically store data within shared memory in addition to automatically cached data that is stored within cache memory 3572.

In at least one embodiment, a parallel processor or GPGPU as described herein is communicatively coupled to host/processor cores to accelerate graphics operations, machine-learning operations, pattern analysis operations, and various general purpose GPU (GPGPU) functions. In at least one embodiment, a GPU may be communicatively coupled to host processor/cores over a bus or other interconnect (e.g., a high speed interconnect such as PCIe or NVLink). In at least one embodiment, a GPU may be integrated on a same package or chip as cores and communicatively coupled to cores over a processor bus/interconnect that is internal to a package or a chip. In at least one embodiment, regardless of a manner in which a GPU is connected, processor cores may allocate work to a GPU in a form of sequences of commands/instructions contained in a WD. In at least one embodiment, a GPU then uses dedicated circuitry/logic for efficiently processing these commands/instructions.

### General Computing

The following figures set forth, without limitation, exemplary software constructs within general computing that can be used to implement at least one embodiment.

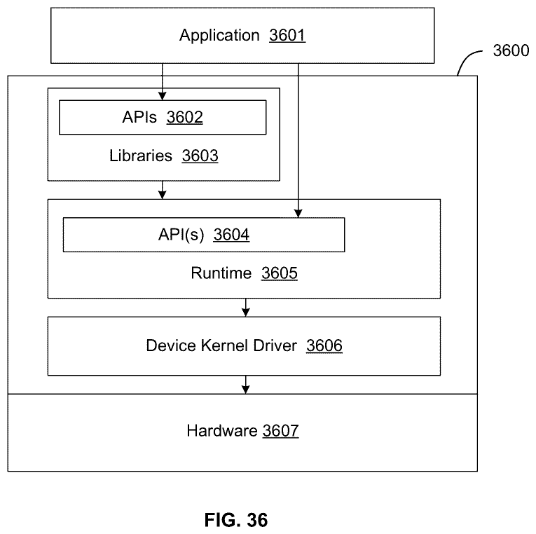

FIG. 36 illustrates a software stack of a programming platform, in accordance with at least one embodiment. In at least one embodiment, a programming platform is a platform for leveraging hardware on a computing system to accelerate computational tasks. A programming platform may be accessible to software developers through libraries, compiler directives, and/or extensions to programming languages, in at least one embodiment. In at least one embodiment, a programming platform may be, but is not limited to, CUDA, Radeon Open Compute Platform (“ROCm”), OpenCL (OpenCL™ is developed by Khronos group), SYCL, or Intel One API.

In at least one embodiment, a software stack 3600 of a programming platform provides an execution environment for an application 3601. In at least one embodiment, application 3601 may include any computer software capable of being launched on software stack 3600. In at least one embodiment, application 3601 may include, but is not limited to, an artificial intelligence (“AI”)/machine learning (“ML”) application, a high performance computing (“HPC”) application, a virtual desktop infrastructure (“VDI”), or a data center workload.

In at least one embodiment, application 3601 and software stack 3600 run on hardware 3607. Hardware 3607 may include one or more GPUs, CPUs, FPGAs, AI engines, and/or other types of compute devices that support a programming platform, in at least one embodiment. In at least one embodiment, such as with CUDA, software stack 3600 may be vendor specific and compatible with only devices from particular vendor(s). In at least one embodiment, such as in with OpenCL, software stack 3600 may be used with devices from different vendors. In at least one embodiment, hardware 3607 includes a host connected to one more devices that can be accessed to perform computational tasks via application programming interface (“API”) calls. A device within hardware 3607 may include, but is not limited to, a GPU, FPGA, AI engine, or other compute device (but may also include a CPU) and its memory, as opposed to a host within hardware 3607 that may include, but is not limited to, a CPU (but may also include a compute device) and its memory, in at least one embodiment.

In at least one embodiment, software stack 3600 of a programming platform includes, without limitation, a number of libraries 3603, a runtime 3605, and a device kernel driver 3606. Each of libraries 3603 may include data and programming code that can be used by computer programs and leveraged during software development, in at least one embodiment. In at least one embodiment, libraries 3603 may include, but are not limited to, pre-written code and subroutines, classes, values, type specifications, configuration data, documentation, help data, and/or message templates. In at least one embodiment, libraries 3603 include functions that are optimized for execution on one or more types of devices. In at least one embodiment, libraries 3603 may include, but are not limited to, functions for performing mathematical, deep learning, and/or other types of operations on devices. In at least one embodiment, libraries 3703 are associated with corresponding APIs 3702, which may include one or more APIs, that expose functions implemented in libraries 3703.

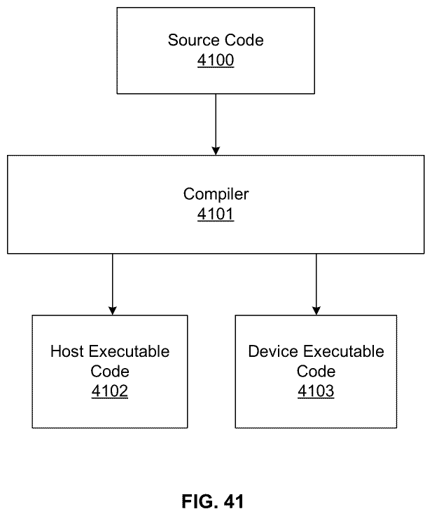

In at least one embodiment, application 3601 is written as source code that is compiled into executable code, as discussed in greater detail below in conjunction with FIG. 41. Executable code of application 3601 may run, at least in part, on an execution environment provided by software stack 3600, in at least one embodiment. In at least one embodiment, during execution of application 3601, code may be reached that needs to run on a device, as opposed to a host. In such a case, runtime 3605 may be called to load and launch requisite code on a device, in at least one embodiment. In at least one embodiment, runtime 3605 may include any technically feasible runtime system that is able to support execution of application S01.

In at least one embodiment, runtime 3605 is implemented as one or more runtime libraries associated with corresponding APIs, which are shown as API(s) 3604. One or more of such runtime libraries may include, without limitation, functions for memory management, execution control, device management, error handling, and/or synchronization, among other things, in at least one embodiment. In at least one embodiment, memory management functions may include, but are not limited to, functions to allocate, deallocate, and copy device memory, as well as transfer data between host memory and device memory. In at least one embodiment, execution control functions may include, but are not limited to, functions to launch a function (sometimes referred to as a “kernel” when a function is a global function callable from a host) on a device and set attribute values in a buffer maintained by a runtime library for a given function to be executed on a device.

Runtime libraries and corresponding API(s) 3604 may be implemented in any technically feasible manner, in at least one embodiment. In at least one embodiment, one (or any number of) API may expose a low-level set of functions for fine-grained control of a device, while another (or any number of) API may expose a higher-level set of such functions. In at least one embodiment, a high-level runtime API may be built on top of a low-level API. In at least one embodiment, one or more of runtime APIs may be language-specific APIs that are layered on top of a language-independent runtime API.

In at least one embodiment, device kernel driver 3606 is configured to facilitate communication with an underlying device. In at least one embodiment, device kernel driver 3606 may provide low-level functionalities upon which APIs, such as API(s) 3604, and/or other software relies. In at least one embodiment, device kernel driver 3606 may be configured to compile intermediate representation (“IR”) code into binary code at runtime. For CUDA, device kernel driver 3606 may compile Parallel Thread Execution (“PTX”) IR code that is not hardware specific into binary code for a specific target device at runtime (with caching of compiled binary code), which is also sometimes referred to as “finalizing” code, in at least one embodiment. Doing so may permit finalized code to run on a target device, which may not have existed when source code was originally compiled into PTX code, in at least one embodiment. Alternatively, in at least one embodiment, device source code may be compiled into binary code offline, without requiring device kernel driver 3606 to compile IR code at runtime.

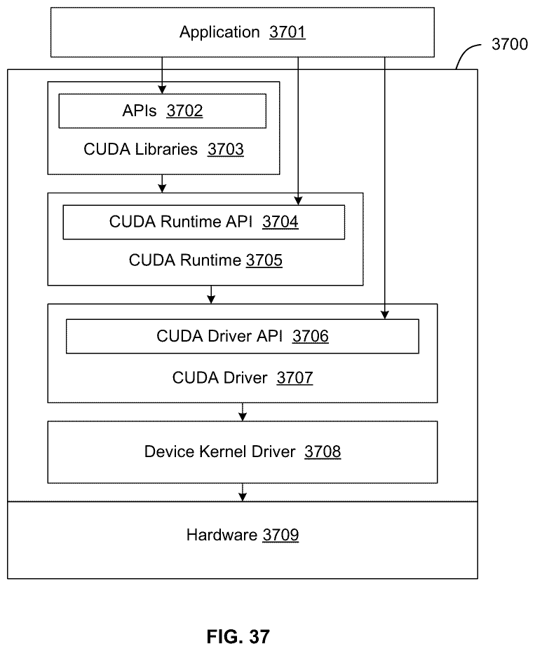

FIG. 37 illustrates a CUDA implementation of software stack 3600 of FIG. 36, in accordance with at least one embodiment. In at least one embodiment, a CUDA software stack 3700, on which an application 3701 may be launched, includes CUDA libraries 3703, a CUDA runtime 3705, a CUDA driver 3707, and a device kernel driver 3708. In at least one embodiment, CUDA software stack 3700 executes on hardware 3709, which may include a GPU that supports CUDA and is developed by NVIDIA Corporation of Santa Clara, CA.

In at least one embodiment, application 3701, CUDA runtime 3705, and device kernel driver 3708 may perform similar functionalities as application 3601, runtime 3605, and device kernel driver 3606, respectively, which are described above in conjunction with FIG. 36. In at least one embodiment, CUDA driver 3707 includes a library (libcuda.so) that implements a CUDA driver API 3706. Similar to a CUDA runtime API 3704 implemented by a CUDA runtime library (cudart), CUDA driver API 3706 may, without limitation, expose functions for memory management, execution control, device management, error handling, synchronization, and/or graphics interoperability, among other things, in at least one embodiment. In at least one embodiment, CUDA driver API 3706 differs from CUDA runtime API 3704 in that CUDA runtime API 3704 simplifies device code management by providing implicit initialization, context (analogous to a process) management, and module (analogous to dynamically loaded libraries) management. In contrast to high-level CUDA runtime API 3704, CUDA driver API 3706 is a low-level API providing more fine-grained control of a device, particularly with respect to contexts and module loading, in at least one embodiment. In at least one embodiment, CUDA driver API 3706 may expose functions for context management that are not exposed by CUDA runtime API 3704. In at least one embodiment, CUDA driver API 3706 is also language-independent and supports, e.g., OpenCL in addition to CUDA runtime API 3704. Further, in at least one embodiment, development libraries, including CUDA runtime 3705, may be considered as separate from driver components, including user-mode CUDA driver 3707 and kernel-mode device driver 3708 (also sometimes referred to as a “display” driver).

In at least one embodiment, CUDA libraries 3703 may include, but are not limited to, mathematical libraries, deep learning libraries, parallel algorithm libraries, and/or signal/image/video processing libraries, which parallel computing applications such as application 3701 may utilize. In at least one embodiment, CUDA libraries 3703 may include mathematical libraries such as a cuBLAS library that is an implementation of Basic Linear Algebra Subprograms (“BLAS”) for performing linear algebra operations, a cuFFT library for computing fast Fourier transforms (“FFTs”), and a cuRAND library for generating random numbers, among others. In at least one embodiment, CUDA libraries 3703 may include deep learning libraries such as a cuDNN library of primitives for deep neural networks and a TensorRT platform for high-performance deep learning inference, among others.

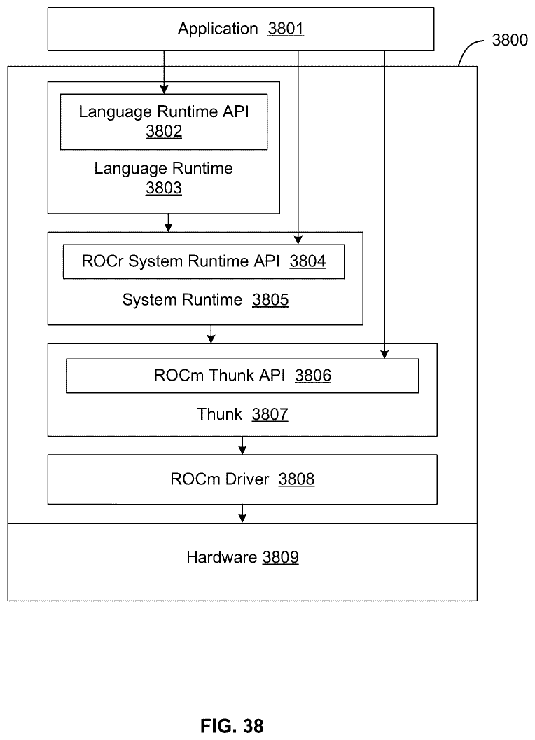

FIG. 38 illustrates a ROCm implementation of software stack 3600 of FIG. 36, in accordance with at least one embodiment. In at least one embodiment, a ROCm software stack 3800, on which an application 3801 may be launched, includes a language runtime 3803, a system runtime 3805, a thunk 3807, a ROCm kernel driver 3808, and a device kernel driver 3809. In at least one embodiment, ROCm software stack 3800 executes on hardware 3810, which may include a GPU that supports ROCm and is developed by AMD Corporation of Santa Clara, CA.

In at least one embodiment, application 3801 may perform similar functionalities as application 3601 discussed above in conjunction with FIG. 36. In addition, language runtime 3803 and system runtime 3805 may perform similar functionalities as runtime 3605 discussed above in conjunction with FIG. 36, in at least one embodiment. In at least one embodiment, language runtime 3803 and system runtime 3805 differ in that system runtime 3805 is a language-independent runtime that implements a ROCr system runtime API 3804 and makes use of a Heterogeneous System Architecture (“HAS”) Runtime API. HAS runtime API is a thin, user-mode API that exposes interfaces to access and interact with an AMD GPU, including functions for memory management, execution control via architected dispatch of kernels, error handling, system and agent information, and runtime initialization and shutdown, among other things, in at least one embodiment. In contrast to system runtime 3805, language runtime 3803 is an implementation of a language-specific runtime API 3802 layered on top of ROCr system runtime API 3804, in at least one embodiment. In at least one embodiment, language runtime API may include, but is not limited to, a Heterogeneous compute Interface for Portability (“HIP”) language runtime API, a Heterogeneous Compute Compiler (“HCC”) language runtime API, or an OpenCL API, among others. HIP language in particular is an extension of C++ programming language with functionally similar versions of CUDA mechanisms, and, in at least one embodiment, a HIP language runtime API includes functions that are similar to those of CUDA runtime API 3704 discussed above in conjunction with FIG. 37, such as functions for memory management, execution control, device management, error handling, and synchronization, among other things.

In at least one embodiment, thunk (ROCt) 3807 is an interface that can be used to interact with underlying ROCm driver 3808. In at least one embodiment, ROCm driver 3808 is a ROCk driver, which is a combination of an AMDGPU driver and a HAS kernel driver (amdkfd). In at least one embodiment, AMDGPU driver is a device kernel driver for GPUs developed by AMD that performs similar functionalities as device kernel driver 3606 discussed above in conjunction with FIG. 36. In at least one embodiment, HAS kernel driver is a driver permitting different types of processors to share system resources more effectively via hardware features.

In at least one embodiment, various libraries (not shown) may be included in ROCm software stack 3800 above language runtime 3803 and provide functionality similarity to CUDA libraries 3703, discussed above in conjunction with FIG. 37. In at least one embodiment, various libraries may include, but are not limited to, mathematical, deep learning, and/or other libraries such as a hipBLAS library that implements functions similar to those of CUDA cuBLAS, a rocFFT library for computing FFTs that is similar to CUDA cuFFT, among others.

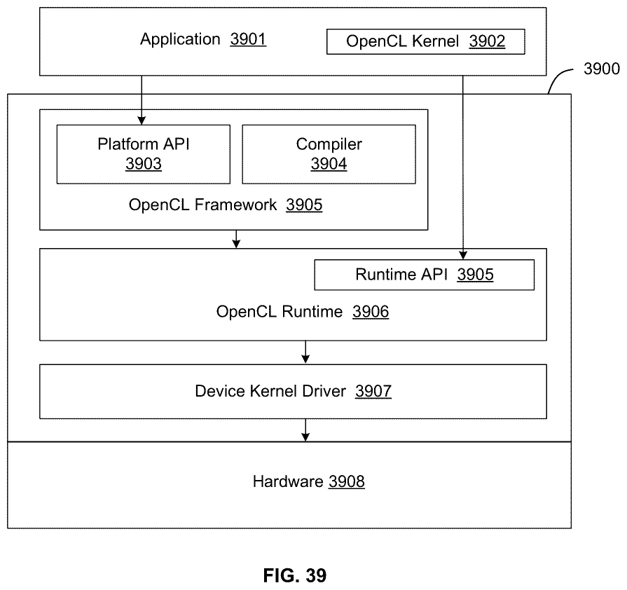

FIG. 39 illustrates an OpenCL implementation of software stack 3600 of FIG. 36, in accordance with at least one embodiment. In at least one embodiment, an OpenCL software stack 3900, on which an application 3901 may be launched, includes an OpenCL framework 3905, an OpenCL runtime 3906, and a driver 3907. In at least one embodiment, OpenCL software stack 3900 executes on hardware 3709 that is not vendor-specific. As OpenCL is supported by devices developed by different vendors, specific OpenCL drivers may be required to interoperate with hardware from such vendors, in at least one embodiment.

In at least one embodiment, application 3901, OpenCL runtime 3906, device kernel driver 3907, and hardware 3908 may perform similar functionalities as application 3601, runtime 3605, device kernel driver 3606, and hardware 3607, respectively, that are discussed above in conjunction with FIG. 36. In at least one embodiment, application 3901 further includes an OpenCL kernel 3902 with code that is to be executed on a device.

In at least one embodiment, OpenCL defines a “platform” that allows a host to control devices connected to a host. In at least one embodiment, an OpenCL framework provides a platform layer API and a runtime API, shown as platform API 3903 and runtime API 3905. In at least one embodiment, runtime API 3905 uses contexts to manage execution of kernels on devices. In at least one embodiment, each identified device may be associated with a respective context, which runtime API 3905 may use to manage command queues, program objects, and kernel objects, share memory objects, among other things, for that device. In at least one embodiment, platform API 3903 exposes functions that permit device contexts to be used to select and initialize devices, submit work to devices via command queues, and enable data transfer to and from devices, among other things. In addition, OpenCL framework provides various built-in functions (not shown), including math functions, relational functions, and image processing functions, among others, in at least one embodiment.

In at least one embodiment, a compiler 3904 is also included in OpenCL frame-work 3905. Source code may be compiled offline prior to executing an application or online during execution of an application, in at least one embodiment. In contrast to CUDA and ROCm, OpenCL applications in at least one embodiment may be compiled online by compiler 3904, which is included to be representative of any number of compilers that may be used to compile source code and/or IR code, such as Standard Portable Intermediate Representation (“SPIR-V”) code, into binary code. Alternatively, in at least one embodiment, OpenCL applications may be compiled offline, prior to execution of such applications.

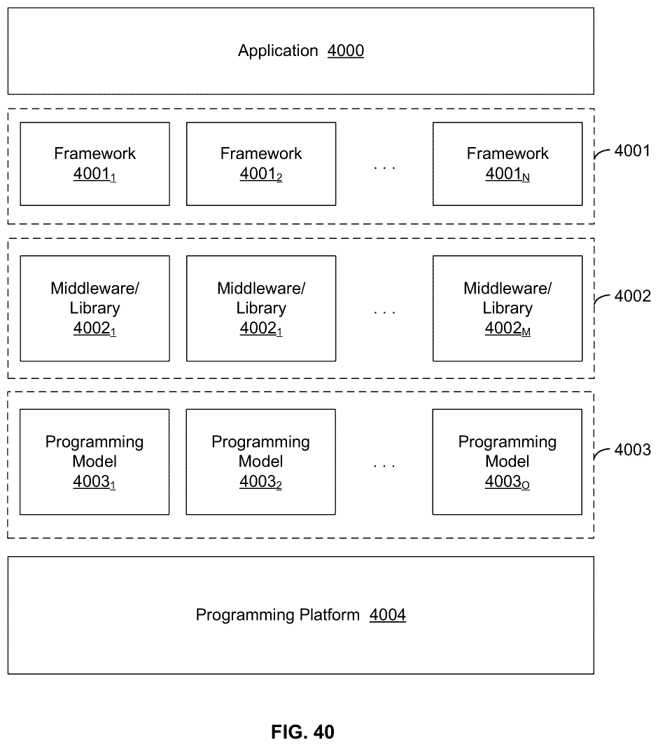

FIG. 40 illustrates software that is supported by a programming platform, in accordance with at least one embodiment. In at least one embodiment, a programming platform 4004 is configured to support various programming models 4003, middlewares and/or libraries 4002, and frameworks 4001 that an application 4000 may rely upon. In at least one embodiment, application 4000 may be an AI/ML application implemented using, for example, a deep learning framework such as MXNet, PyTorch, or TensorFlow, which may rely on libraries such as cuDNN, NVIDIA Collective Communications Library (“NCCL”), and/or NVIDA Developer Data Loading Library (“DALI”) CUDA libraries to provide accelerated computing on underlying hardware.

In at least one embodiment, programming platform 4004 may be one of a CUDA, ROCm, or OpenCL platform described above in conjunction with FIG. 37, FIG. 38, and FIG. 39, respectively. In at least one embodiment, programming platform 4004 supports multiple programming models 4003, which are abstractions of an underlying computing system permitting expressions of algorithms and data structures. Programming models 4003 may expose features of underlying hardware in order to improve performance, in at least one embodiment. In at least one embodiment, programming models 4003 may include, but are not limited to, CUDA, HIP, OpenCL, C++ Accelerated Massive Parallelism (“C++AMP”), Open Multi-Processing (“OpenMP”), Open Accelerators (“OpenACC”), and/or Vulcan Compute.

In at least one embodiment, libraries and/or middlewares 4002 provide implementations of abstractions of programming models 4004. In at least one embodiment, such libraries include data and programming code that may be used by computer programs and leveraged during software development. In at least one embodiment, such middlewares include software that provides services to applications beyond those available from programming platform 4004. In at least one embodiment, libraries and/or middlewares 4002 may include, but are not limited to, cuBLAS, cuFFT, cuRAND, and other CUDA libraries, or rocBLAS, rocFFT, rocRAND, and other ROCm libraries. In addition, in at least one embodiment, libraries and/or middlewares 4002 may include NCCL and ROCm Communication Collectives Library (“RCCL”) libraries providing communication routines for GPUs, a MIOpen library for deep learning acceleration, and/or an Eigen library for linear algebra, matrix and vector operations, geometrical transformations, numerical solvers, and related algorithms.

In at least one embodiment, application frameworks 4001 depend on libraries and/or middlewares 4002. In at least one embodiment, each of application frameworks 4001 is a software framework used to implement a standard structure of application software. An AI/ML application may be implemented using a framework such as Caffe, Caffe2, TensorFlow, Keras, PyTorch, or MxNet deep learning frameworks, in at least one embodiment.

FIG. 41 illustrates compiling code to execute on one of programming platforms of FIGS. 36-39, in accordance with at least one embodiment. In at least one embodiment, a compiler 4101 receives source code 4100 that includes both host code as well as device code. In at least one embodiment, complier 4101 is configured to convert source code 4100 into host executable code 4102 for execution on a host and device executable code 4103 for execution on a device. In at least one embodiment, source code 4100 may either be compiled offline prior to execution of an application, or online during execution of an application.

In at least one embodiment, source code 4100 may include code in any programming language supported by compiler 4101, such as C++, C, Fortran, etc. In at least one embodiment, source code 4100 may be included in a single-source file having a mixture of host code and device code, with locations of device code being indicated therein. In at least one embodiment, a single-source file may be a .cu file that includes CUDA code or a .hip.cpp file that includes HIP code. Alternatively, in at least one embodiment, source code 4100 may include multiple source code files, rather than a single-source file, into which host code and device code are separated.

In at least one embodiment, compiler 4101 is configured to compile source code 4100 into host executable code 4102 for execution on a host and device executable code 4103 for execution on a device. In at least one embodiment, compiler 4101 performs operations including parsing source code 4100 into an abstract system tree (AST), performing optimizations, and generating executable code. In at least one embodiment in which source code 4100 includes a single-source file, compiler 4101 may separate device code from host code in such a single-source file, compile device code and host code into device executable code 4103 and host executable code 4102, respectively, and link device executable code 4103 and host executable code 4102 together in a single file, as discussed in greater detail below with respect to FIG. 30.

In at least one embodiment, host executable code 4102 and device executable code 4103 may be in any suitable format, such as binary code and/or IR code. In a case of CUDA, host executable code 4102 may include native object code and device executable code 4103 may include code in PTX intermediate representation, in at least one embodiment. In a case of ROCm, both host executable code 4102 and device executable code 4103 may include target binary code, in at least one embodiment.

At least one embodiment of the disclosure can be described in view of the following clauses:
1. A processor comprising: one or more circuits to cause one or more computer system evaluation programs to be performed based, at least in part, on an application to be performed by the one or more computer systems.
2. The processor of clause 1, wherein the one or more circuits are to indicate a workload as failed based, at least in part, on a count of failures of the computer system evaluation program.
3. The processor of clauses 1 or 2, wherein the one or more computer system evaluation programs comprises one or more tests selected based, at least in part, on one or more functions of the application to be performed by the one or more computer systems.
4. The processor of any of clauses 1-3, wherein the one or more circuits are to perform a CCL test init container based, at least in part, on the computer system evaluation program passing.
5. The processor of any of clauses 1-4, wherein the computer system evaluation program comprises a redundant array of independent disks (RAID) test.
6. The processor of any of clauses 1-5, wherein the computer system evaluation program comprises a remote direct memory access (RDMA) test.
7. The processor of any of clauses 1-6, wherein the computer system evaluation program comprises a GPU memory test.
8. A system, comprising: one or more circuits to cause one or more computer system evaluation programs to be performed based, at least in part, on an application to be performed by the one or more computer systems.
9. The system of clause 8, wherein the one or more circuits are to indicate a workload as failed based, at least in part, on a count of failures of the computer system evaluation program.
10. The system of clauses 8 or 9, wherein the one or more computer system evaluation programs comprises one or more tests selected based, at least in part, on one or more functions of the application to be performed by the one or more computer systems.
11. The system of any of clauses 8-10, wherein the one or more processors are to perform a CCL test init container in response to the computer system evaluation program passing.
12. The system of any of clauses 8-11, wherein said computer system evaluation program comprises a RAID test.
13. The system of any of clauses 8-12, wherein said computer system evaluation program comprises an RDMA test.
14. The system of any of clauses 11-13, wherein the computer system evaluation program comprises a GPU memory test.
15. A machine-readable medium having stored thereon a set of instructions, which if performed by one or more processors, cause the one or more processors to at least cause one or more computer system evaluation programs to be performed based, at least in part, on an application to be performed by the one or more computer systems.
16. The machine readable medium of clause 15, wherein the set of instructions, which if performed by the one or more processors, further cause the one or more processors to indicate a workload as failed based, at least in part, on a count of failures of the computer system evaluation program.
17. The machine readable medium of clauses 15 or 16, wherein the set of instructions, which if performed by the one or more processors, further cause the one or more processors to:
respond to one or more failure indications by the computer system evaluation program by at least marking a node as unhealthy and creating a replacement workload container.
18. The machine readable medium of any of clauses 15-17, wherein the set of instructions, which if performed by the one or more processors, further cause the one or more processors to perform a CCL test init container based, at least in part, on the computer system evaluation program passing.
19. The machine readable medium of any of clauses 15-18, wherein the computer system evaluation program comprises a redundant array of independent disks (RAID) test.
20. The machine readable medium of any of clauses 15-19, wherein the computer system evaluation program comprises a remote direct memory access (RDMA) test.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, a number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium. In at least one embodiment, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—in at least one embodiment, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, in at least one embodiment, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A processor comprising: one or more circuits to cause one or more computer system evaluation programs to be performed based, at least in part, on an application to be performed by the one or more computer systems.

2. The processor of claim 1, wherein the one or more circuits are to indicate a workload as failed based, at least in part, on a count of failures of the computer system evaluation program.

3. The processor of claim 1, wherein the one or more computer system evaluation programs comprises one or more tests selected based, at least in part, on one or more functions of the application to be performed by the one or more computer systems.

4. The processor of claim 1, wherein the one or more circuits are to perform a CCL test init container based, at least in part, on the computer system evaluation program passing.

5. The processor of claim 1, wherein the computer system evaluation program comprises a redundant array of independent disks (RAID) test.

6. The processor of claim 1, wherein the computer system evaluation program comprises a remote direct memory access (RDMA) test.

7. The processor of claim 1, wherein the computer system evaluation program comprises a GPU memory test.

8. A system, comprising: one or more circuits to cause one or more computer system evaluation programs to be performed based, at least in part, on an application to be performed by the one or more computer systems.

9. The system of claim 8, wherein the one or more circuits are to indicate a workload as failed based, at least in part, on a count of failures of the computer system evaluation program.

10. The system of claim 8, wherein the one or more computer system evaluation programs comprises one or more tests selected based, at least in part, on one or more functions of the application to be performed by the one or more computer systems.

11. The system of claim 8, wherein the one or more processors are to perform a CCL test init container in response to the computer system evaluation program passing.

12. The system of claim 8, wherein said computer system evaluation program comprises a RAID test.

13. The system of claim 8, wherein said computer system evaluation program comprises an RDMA test.

14. The system of claim 11, wherein the computer system evaluation program comprises a GPU memory test.

15. A machine-readable medium having stored thereon a set of instructions, which if performed by one or more processors, cause the one or more processors to at least cause one or more computer system evaluation programs to be performed based, at least in part, on an application to be performed by the one or more computer systems.

16. The machine readable medium of claim 15, wherein the set of instructions, which if performed by the one or more processors, further cause the one or more processors to indicate a workload as failed based, at least in part, on a count of failures of the computer system evaluation program.

17. The machine readable medium of claim 15, wherein the set of instructions, which if performed by the one or more processors, further cause the one or more processors to:
respond to one or more failure indications by the computer system evaluation program by at least marking a node as unhealthy and creating a replacement workload container.

18. The machine readable medium of claim 15, wherein the set of instructions, which if performed by the one or more processors, further cause the one or more processors to perform a CCL test init container based, at least in part, on the computer system evaluation program passing.

19. The machine readable medium of claim 15, wherein the computer system evaluation program comprises a redundant array of independent disks (RAID) test.

20. The machine readable medium of claim 15, wherein the computer system evaluation program comprises a remote direct memory access (RDMA) test.
